(19) United States
(12) Patent Application Publication
(10) Pub. No.: US 2026/0052570 A1
(43) Pub. Date: Feb. 19, 2026

(54) SIGNALING DESIGNS FOR ENHANCED LONG RANGE (ELR) TRANSMISSIONS

(71) Applicant: QUALCOMM Incorporated, San Diego, CA (US)

(72) Inventors: Lin YANG, San Diego, CA (US); Tzu-Hsuan CHOU, San Diego, CA (US); Bin TIAN, San Diego, CA (US); Youhan KIM, Saratoga, CA (US)

(21) Appl. No.: 18/809,310

(22) Filed: Aug. 19, 2024

(51) Int. Cl. H04W 74/0816; H04L 1/00; H04L 27/26

(52) U.S. Cl. CPC H04W 74/0816; H04L 1/0003; H04L 1/0061; H04L 27/2603; H04L 27/2614

(57) ABSTRACT

This disclosure provides methods, components, devices and systems for tone mapping, enhanced long range (ELR)-mark sequence designs, and signal field designs for ELR transmissions. Some aspects more specifically relate to ELR-signal (ELR-SIG) field designs within a physical layer (PHY) protocol data unit (PPDU) associated with an ELR format to facilitate a parsing of ELR-data that follows an ELR-SIG field. Some further aspects more specifically relate to mechanisms according to which devices may support a set of ELR sequences associated with relatively low peak-to-average-power ratios (PAPRs) and usable to convey information that a receiving device may use to determine whether to perform an early drop of a received ELR PPDU. In some examples, various devices may support a set of ELR sequences with each ELR sequence of the set indicative of a respective basic service set (BSS) information value.

### TECHNICAL FIELD

This disclosure relates generally to wireless communication and, more specifically, to signaling designs for enhanced long range (ELR) transmissions.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in an apparatus for wireless communications at a wireless communication device. The apparatus may include a processing system that includes processor circuitry and memory circuitry that stores code. The processing system may be configured to cause the apparatus to receive, via a preamble portion of a physical layer (PHY) protocol data unit (PPDU) associated with an enhanced long range (ELR) format, an ELR-signal (ELR-SIG) field that includes two symbols, the two symbols including, a first set of multiple subfields include a modulation and coding scheme (MCS) subfield, a coding subfield associated with a data portion of the PPDU, and one or more of an uplink-downlink indicator subfield, a transmission opportunity (TxOP) identifier subfield, or a last PPDU indicator subfield, a second set of multiple subfields include an CRC subfield and a tail subfield, and receive, via the data portion of the PPDU, an ELR-data field in accordance with at least the MCS subfield and the coding subfield.

Another innovative aspect of the subject matter described in this disclosure can be implemented in a method for wireless communication by or at wireless communication device. The method may include receiving, via a preamble portion of a PPDU associated with an ELR format, an ELR-signal (ELR-SIG) field that includes two symbols, the two symbols including, a first set of multiple subfields including a modulation and coding scheme (MCS) subfield, a coding subfield associated with a data portion of the PPDU, and one or more of an uplink-downlink indicator subfield, a transmission opportunity (TxOP) identifier subfield, or a last PPDU indicator subfield, a second set of multiple subfields including a cyclic redundancy check (CRC) subfield and a tail subfield, and receiving, via the data portion of the PPDU, an ELR-data field in accordance with at least the MCS subfield and the coding subfield.

Another innovative aspect of the subject matter described in this disclosure can be implemented in an apparatus for wireless communications at a wireless communication device. The apparatus may include means for receiving, via a preamble portion of a PPDU associated with an ELR format, an ELR-signal (ELR-SIG) field that includes two symbols, the two symbols including, means for a first set of multiple subfields including a modulation and coding scheme (MCS) subfield, a coding subfield associated with a data portion of the PPDU, and one or more of an uplink-downlink indicator subfield, a transmission opportunity (TxOP) identifier subfield, or a last PPDU indicator subfield, means for a second set of multiple subfields including an CRC subfield and a tail subfield, and means for receiving, via the data portion of the PPDU, an ELR-data field in accordance with at least the MCS subfield and the coding subfield.

Another innovative aspect of the subject matter described in this disclosure can be implemented in a non-transitory computer-readable medium storing code for wireless communication by an apparatus at or of a wireless communication device. The code may include instructions executable by one or more processors to receive, via a preamble portion of a PPDU associated with an ELR format, an ELR-signal (ELR-SIG) field that includes two symbols, the two symbols including, a first set of multiple subfields include a modulation and coding scheme (MCS) subfield, a coding subfield associated with a data portion of the PPDU, and one or more of an uplink-downlink indicator subfield, a transmission opportunity (TxOP) identifier subfield, or a last PPDU indicator subfield, a second set of multiple subfields include an CRC subfield and a tail subfield, and receive, via the data portion of the PPDU, an ELR-data field in accordance with at least the MCS subfield and the coding subfield.

In some implementations of the method, apparatuses, wireless communication devices, and non-transitory computer-readable medium described herein, the two symbols of the ELR-SIG field may be separately encoded, and where each symbol includes an associated tail subfield, and at least one of the two symbols includes the CRC subfield.

In some implementations of the method, apparatuses, wireless communication devices, and non-transitory computer-readable medium described herein, the CRC subfield includes a CRC value, and where the CRC value may be based on the first set of multiple subfields which include a basic service set (BSS) color subfield, or may be based on the first set of multiple subfields and an implicit indication of a BSS color value when an indication of BSS color is not included in the first set of multiple subfields.

In some implementations of the method, apparatuses, wireless communication devices, and non-transitory computer-readable medium described herein, the first set of multiple subfields further includes a version number subfield, a station identification subfield, a length subfield that indicates a quantity of symbols in the PPDU, and a basic service set (BSS) color subfield.

In some implementations of the method, apparatuses, wireless communication devices, and non-transitory computer-readable medium described herein, each symbol of the two symbols of the ELR-SIG field includes an associated tail subfield and each symbol of the two symbols of the ELR-SIG field includes an associated CRC subfield, or a single joint CRC subfield associated with both of the two symbols of the ELR-SIG field may be included in one of the two symbols.

Another innovative aspect of the subject matter described in this disclosure can be implemented in an apparatus for wireless communications at a wireless communication device. The apparatus may include a processing system that includes processor circuitry and memory circuitry that stores code. The processing system may be configured to cause the apparatus to receive, via a pair of ELR symbols within a preamble portion of a PPDU, an ELR sequence from a set of multiple ELR sequences, the ELR sequence spanning a first ELR symbol of the pair of ELR symbols and a second ELR symbol of the pair of ELR symbols, where the ELR sequence be indicative of a basic service set (BSS) information value that may include one or more of a BSS color value, a BSS identifier, or a BSS address from a set of multiple BSS color values, BSS identifiers, or BSS addresses, based on a mapping between the set of multiple ELR sequences and associated BSS color values, BSS identifiers, or BSS addresses, where a quantity of the set of multiple ELR sequence corresponds to a quantity of the set of multiple BSS color values, BSS identifiers, or BSS addresses, and a length of each ELR sequence of the set of multiple ELR sequences is associated with a quantity of tones within the first ELR symbol and the second ELR symbol, and selectively receive at least a portion of a remainder of the PPDU after the pair of ELR symbols in accordance with the BSS information value indicated by the ELR sequence.

Another innovative aspect of the subject matter described in this disclosure can be implemented in a method for wireless communication by or at wireless communication device. The method may include receiving, via a pair of ELR symbols within a preamble portion of a PPDU, an ELR sequence from a set of multiple ELR sequences, the ELR sequence spanning a first ELR symbol of the pair of ELR symbols and a second ELR symbol of the pair of ELR symbols, where the ELR sequence is indicative of a basic service set (BSS) information value that may include one or more of a BSS color value, a BSS identifier, or a BSS address from a set of multiple BSS color values, BSS identifiers, or BSS addresses, based on a mapping between the set of multiple ELR sequences and associated BSS color values, BSS identifiers, or BSS addresses, where a quantity of the set of multiple ELR sequences corresponds to a quantity of the set of multiple BSS color values, BSS identifiers, or BSS addresses, and a length of each ELR sequence of the set of multiple ELR sequences is associated with a quantity of tones within the first ELR symbol and the second ELR symbol, and selectively receiving at least a portion of a remainder of the PPDU after the pair of ELR symbols in accordance with the BSS information value indicated by the ELR sequence.

Another innovative aspect of the subject matter described in this disclosure can be implemented in an apparatus for wireless communications at a wireless communication device. The apparatus may include means for receiving, via a pair of ELR symbols within a preamble portion of a PPDU, an ELR sequence from a set of multiple ELR sequences, the ELR sequence spanning a first ELR symbol of the pair of ELR symbols and a second ELR symbol of the pair of ELR symbols, means for where the ELR sequence is indicative of a basic service set (BSS) information value that may include one or more of a BSS color value, a BSS identifier, or a BSS address from a set of multiple BSS color values, BSS identifiers, or BSS addresses, based on a mapping between the set of multiple ELR sequences and associated BSS color values, BSS identifiers, or BSS addresses, means for where a quantity of the set of multiple ELR sequences corresponds to a quantity of the set of multiple BSS color values, BSS identifiers, or BSS addresses, and a length of each ELR sequence of the set of multiple ELR sequences is associated with a quantity of tones within the first ELR symbol and the second ELR symbol, and means for selectively receiving at least a portion of a remainder of the PPDU after the pair of ELR symbols in accordance with the BSS information value indicated by the ELR sequence.

Another innovative aspect of the subject matter described in this disclosure can be implemented in a non-transitory computer-readable medium storing code for wireless communication by an apparatus at a wireless communication device. The code may include instructions executable by one or more processors to receive, via a pair of ELR symbols within a preamble portion of a PPDU, an ELR sequence from a set of multiple ELR sequences, the ELR sequence spanning a first ELR symbol of the pair of ELR symbols and a second ELR symbol of the pair of ELR symbols, where the ELR sequence be indicative of a basic service set (BSS) information value that may include one or more of a BSS color value, a BSS identifier, or a BSS address from a set of multiple BSS color values, BSS identifiers, or BSS addresses, based on a mapping between the set of multiple ELR sequences and associated BSS color values, BSS identifiers, or BSS addresses, where a quantity of the set of multiple ELR sequence corresponds to a quantity of the set of multiple BSS color values, BSS identifiers, or BSS addresses, and a length of each ELR sequence of the set of multiple ELR sequences is associated with a quantity of tones within the first ELR symbol and the second ELR symbol, and selectively receive at least a portion of a remainder of the PPDU after the pair of ELR symbols in accordance with the BSS information value indicated by the ELR sequence.

In some implementations of the method, apparatuses, wireless communication devices, and non-transitory computer-readable medium described herein, selectively receiving at least the portion of the remainder of the PPDU after the set of multiple ELR symbols may include operations, features, means, or instructions for receiving at least the portion of the remainder of the PPDU in accordance with a BSS associated with the wireless communication device corresponding to the BSS color value indicated by the ELR sequence and refraining from receiving the remainder of the PPDU in accordance with the BSS associated with the wireless communication device corresponding to a different BSS color value than the BSS color value indicated by the ELR sequence.

In some implementations of the method, apparatuses, wireless communication devices, and non-transitory computer-readable medium described herein, the ELR sequence may be a length-96 ELR sequence, the first ELR symbol may be associated with a first half of the length-96 ELR sequence and the second ELR symbol may be associated with a second half of the length-96 ELR sequence, and the set of multiple ELR sequences may be based on values from a set of multiple rows of a Hadamard extension of a Hadamard matrix that is generated according to a Paley construction from a 48-by-48 conference matrix based on a 47-by-47 Q matrix, in which each sequence is associated with a row of the Hadamard extension and each row has a different sequence.

In some implementations of the method, apparatuses, wireless communication devices, and non-transitory computer-readable medium described herein, the set of multiple ELR sequences may be further based on a mask that is applied to the values from the set of multiple rows of the Hadamard extension, where the mask reduces a peak-to-average-power ratio (PAPR) for transmission of the set of multiple ELR sequences.

Another innovative aspect of the subject matter described in this disclosure can be implemented in an apparatus for wireless communications at a wireless communication device. The apparatus may include a processing system that includes processor circuitry and memory circuitry that stores code. The processing system may be configured to cause the apparatus to transmit, via a preamble portion of a PPDU associated with an ELR format, an ELR-signal (ELR-SIG) field that includes two symbols, the two symbols including, a first set of multiple subfields include a modulation and coding scheme (MCS) subfield, a coding subfield associated with a data portion of the PPDU, and one or more of an uplink-downlink indicator subfield, a transmission opportunity (TxOP) identifier subfield, or a last PPDU indicator subfield, a second set of multiple subfields include an CRC subfield and a tail subfield, and transmit via the data portion of the PPDU, an ELR-data field in accordance with at least the MCS subfield and the coding subfield.

Another innovative aspect of the subject matter described in this disclosure can be implemented in a method for wireless communication by or at wireless communication device. The method may include transmitting, via a preamble portion of a PPDU associated with an ELR format, an ELR-signal (ELR-SIG) field that includes two symbols, the two symbols including, a first set of multiple subfields including a modulation and coding scheme (MCS) subfield, a coding subfield associated with a data portion of the PPDU, and one or more of an uplink-downlink indicator subfield, a transmission opportunity (TxOP) identifier subfield, or a last PPDU indicator subfield, a second set of multiple subfields including an CRC subfield and a tail subfield, and transmitting via the data portion of the PPDU, an ELR-data field in accordance with at least the MCS subfield and the coding subfield.

Another innovative aspect of the subject matter described in this disclosure can be implemented in an apparatus for wireless communications at a wireless communication device. The apparatus may include means for transmitting, via a preamble portion of a PPDU associated with an ELR format, an ELR-signal (ELR-SIG) field that includes two symbols, the two symbols including, means for a first set of multiple subfields including a modulation and coding scheme (MCS) subfield, a coding subfield associated with a data portion of the PPDU, and one or more of an uplink-downlink indicator subfield, a transmission opportunity (TxOP) identifier subfield, or a last PPDU indicator subfield, means for a second set of multiple subfields including an CRC subfield and a tail subfield, and means for transmitting via the data portion of the PPDU, an ELR-data field in accordance with at least the MCS subfield and the coding subfield.

Another innovative aspect of the subject matter described in this disclosure can be implemented in a non-transitory computer-readable medium storing code for wireless communication by an apparatus for wireless communications at a wireless communication device. The code may include instructions executable by one or more processors to transmit, via a preamble portion of a PPDU associated with an ELR format, an ELR-signal (ELR-SIG) field that includes two symbols, the two symbols including, a first set of multiple subfields include a modulation and coding scheme (MCS) subfield, a coding subfield associated with a data portion of the PPDU, and one or more of an uplink-downlink indicator subfield, a transmission opportunity (TxOP) identifier subfield, or a last PPDU indicator subfield, a second set of multiple subfields include an CRC subfield and a tail subfield, and transmit via the data portion of the PPDU, an ELR-data field in accordance with at least the MCS subfield and the coding subfield.

Another innovative aspect of the subject matter described in this disclosure can be implemented in an apparatus for wireless communications at a wireless communication device. The apparatus may include a processing system that includes processor circuitry and memory circuitry that stores code. The processing system may be configured to cause the apparatus to transmit, via a pair of ELR symbols within a preamble portion of a PPDU, an ELR sequence from a set of multiple ELR sequences, the ELR sequence spanning a first ELR symbol of the pair of ELR symbols and a second ELR symbol of the pair of ELR symbols, where the ELR sequence be indicative of a basic service set (BSS) color value from a set of multiple BSS color values based on a mapping between the set of multiple ELR sequences and associated BSS color values, where a quantity of the set of multiple ELR sequence corresponds to a quantity of the set of multiple BSS color values and a length of each ELR sequence of the set of multiple ELR sequences is associated with a quantity of tones within the first ELR symbol and the second ELR symbol, and transmit, via a set of multiple ELR data symbols within a data portion of the PPDU, a data payload associated with the BSS color value.

Another innovative aspect of the subject matter described in this disclosure can be implemented in a method for wireless communication by or at wireless communication device. The method may include transmitting, via a pair of ELR symbols within a preamble portion of a PPDU, an ELR sequence from a set of multiple ELR sequences, the ELR sequence spanning a first ELR symbol of the pair of ELR symbols and a second ELR symbol of the pair of ELR symbols, where the ELR sequence is indicative of a basic service set (BSS) color value from a set of multiple BSS color values based on a mapping between the set of multiple ELR sequences and associated BSS color values, where a quantity of the set of multiple ELR sequences corresponds to a quantity of the set of multiple BSS color values and a length of each ELR sequence of the set of multiple ELR sequences is associated with a quantity of tones within the first ELR symbol and the second ELR symbol, and transmitting, via a set of multiple ELR data symbols within a data portion of the PPDU, a data payload associated with the BSS color value.

Another innovative aspect of the subject matter described in this disclosure can be implemented in an apparatus for wireless communications at a wireless communication device. The apparatus may include means for transmitting, via a pair of ELR symbols within a preamble portion of a PPDU, an ELR sequence from a set of multiple ELR sequences, the ELR sequence spanning a first ELR symbol of the pair of ELR symbols and a second ELR symbol of the pair of ELR symbols, means for where the ELR sequence is indicative of a basic service set (BSS) color value from a set of multiple BSS color values based on a mapping between the set of multiple ELR sequences and associated BSS color values, means for where a quantity of the set of multiple ELR sequences corresponds to a quantity of the set of multiple BSS color values and a length of each ELR sequence of the set of multiple ELR sequences is associated with a quantity of tones within the first ELR symbol and the second ELR symbol, and means for transmitting, via a set of multiple ELR data symbols within a data portion of the PPDU, a data payload associated with the BSS color value.

Another innovative aspect of the subject matter described in this disclosure can be implemented in a non-transitory computer-readable medium storing code for wireless communication by an apparatus for wireless communications at a wireless communication device. The code may include instructions executable by one or more processors to transmit, via a pair of ELR symbols within a preamble portion of a PPDU, an ELR sequence from a set of multiple ELR sequences, the ELR sequence spanning a first ELR symbol of the pair of ELR symbols and a second ELR symbol of the pair of ELR symbols, where the ELR sequence be indicative of a basic service set (BSS) color value from a set of multiple BSS color values based on a mapping between the set of multiple ELR sequences and associated BSS color values, where a quantity of the set of multiple ELR sequence corresponds to a quantity of the set of multiple BSS color values and a length of each ELR sequence of the set of multiple ELR sequences is associated with a quantity of tones within the first ELR symbol and the second ELR symbol, and transmit, via a set of multiple ELR data symbols within a data portion of the PPDU, a data payload associated with the BSS color value.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows example tone plans that support signaling designs for enhanced long range (ELR) transmissions.

FIG. 5 shows an example of an ELR PPDU format that supports signaling designs for ELR transmissions.

FIG. 6 shows an example of a signaling diagram that illustrates communication of an ELR PPDU between two wireless communication devices.

FIGS. 7-9 show examples of ELR-SIG field designs with separately encoded symbols that supports signaling designs for ELR transmissions.

FIG. 10 shows an example ELR-SIG field design with jointly encoded symbols that supports signaling designs for ELR transmissions.

FIG. 11 shows a block diagram of an example wireless communication device that supports signaling designs for ELR transmissions.

FIGS. 12 through 15 show flowcharts illustrating example processes performable by or at a wireless device that supports signaling designs for ELR transmissions.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

In some wireless communication networks, a wireless communication device may transmit a physical layer (PHY) protocol data unit (PPDU) to an intended receiver. The PPDU may include a preamble portion and a data portion. One or more fields of the preamble portion may indicate one or more of a format, a version, or a mode associated with the PPDU, and the data portion may carry a data payload in accordance with the indicated one or more of the format, the version, or the mode. The wireless communication device, which may be an access point (AP) or a station (STA), among other examples, may generate and transmit the PPDU in accordance with one of various formats. For example, depending on a capability of the wireless communication device, the wireless communication device may transmit the PPDU in accordance with an extremely high throughput (EHT) format or an ultra-high reliability (UHR) format, among other examples. In some networks, a wireless communication device may support enhanced long range (ELR) transmissions, which may extend a coverage associated with the wireless communication device (and which may be referred to herein as “extended” long range transmissions). The ELR transmissions may be associated with a dedicated PPDU format in some examples to facilitate a use of a relatively higher transmit power or to otherwise increase a range of the PPDU. In some networks, ELR transmissions may use tone plans in which resource units (RUs) include sets of tones that include data tones and pilot tones, and some networks may benefit from tone plans for ELR data in which pilot tones may be received in a similar manner as with other types of PPDUs (such as UHR PPDUs).

Based on the greater communication range associated with ELR transmissions, a relatively large quantity of devices within a network may “hear” or detect an ELR PPDU, including both devices relatively near to a transmitting device and devices relatively far from the transmitting device. To avoid causing unnecessary power consumption due to PPDU parsing at “overhearing” devices that are not the intended receiver of a PPDU, the transmitting device may include information relatively early within the PPDU (such as within a preamble portion) to facilitate an “early drop” of the PPDU at unintended receivers. Different fields of a preamble portion of an ELR PPDU, however, may be associated with different amounts of power boosting (such as a +3 dB power boost), such that receiving devices may acquire different information depending on the receiving devices proximity to the transmitting device. In such scenarios, various wireless communication devices may benefit from additional ELR signaling mechanisms to facilitate an “early drop” at various points throughout a preamble of an ELR PPDU. For example, the transmitting device may indicate information via a set of ELR symbols, which may include ELR-mark symbols or other symbols associated with “marking” a PPDU as an ELR PPDU, and a receiving device may use the indicated information to determine whether to continue parsing the PPDU. Some networks, however, may lack mechanisms according to which such information can be efficiently or reliably conveyed (such as while also satisfying one or more target communication metrics). Thus, some networks may benefit from additional ELR signaling mechanisms to efficiently and reliably facilitate an “early drop” of a PPDU. Further, ELR PPDUs may lack a time gap between an ELR-signal (ELR-SIG) and an ELR-data field, which may complicate receive-side preparation associated with data demodulation and decoding. For example, in accordance with some ELR PPDU formats, a receiving device may be expected to perform data demodulation and decoding within one symbol of receiving information indicative of a modulation and coding scheme (MCS) and a coding of the ELR-data. Thus, various wireless communication devices also may benefit from ELR-SIG field designs that assist or otherwise facilitate receive-side preparation associated with ELR-data demodulation and decoding.

Various aspects relate generally to ELR tone plans, power boosting for one or more symbols of a preamble of an ELR PPDU, signal field designs for ELR transmissions, and sequence designs that enable efficient and reliable communication of ELR indication information and basic service set (BSS) color via a set of ELR symbols of an ELR PPDU. Some aspects more specifically relate to ELR tone plans in which RUs are provided in sets of tones of a wireless channel that maintain pilot tone locations across different types of PPDUs and are compatible with demodulation filters at receiving devices. Some aspects also provide power-boosting mechanisms for one or more ELR PPDU fields that may facilitate acquisition of the one or more ELR PPDU fields at a receiving device.

Some further aspects relate to ELR-SIG field designs within PPDUs associated with an ELR format to facilitate a parsing of ELR-data that follows an ELR-SIG field. In some examples, the wireless communication device may format an ELR-SIG field to include or span two symbols, which the wireless communication device may encode the two symbols separately or jointly. In such examples, the two symbols may collectively include at least a first set of subfields and a second set of subfields. The second set of subfields may follow (such as be subsequent to) the first set of subfields. In some implementations, the first set of subfields may include the control information that is relatively most useful for demodulating and decoding the ELR-data that follows the ELR-SIG field (to facilitate receive-side preparation within the second set of subfields, such as while parsing the second set of subfields). For example, the first set of subfields may include at least an MCS subfield and a coding subfield. In examples in which the two symbols of the ELR-SIG field are separately encoded, a first symbol may include the first set of subfields and a second symbol may include the second set of subfields.

Some aspects also provide mechanisms according to which wireless communication devices may support a set of ELR sequences (such as ELR-mark sequences) associated with relatively low peak-to-average-power ratios (PAPRs) and usable to efficiently and unambiguously convey information that a receiving device may use to determine whether to perform an early drop of a received ELR PPDU. In some examples, various wireless communication devices may support (such as identify, select, store, maintain, determine, generate, calculate, or otherwise ascertain) a set of ELR sequences with each ELR sequence of the set indicative of a respective BSS information value (such as a BSS color, BSS identification, or BSS address, or some value specified by an AP). In such examples, a quantity of the set of ELR sequences may correspond to (such as be equal to) a quantity of available BSS color values and a length of each ELR sequence within the set may correspond to (such as be equal to) a quantity of used tones within the ELR symbols. As described herein, “used tones” may be tones that carry an ELR sequence and may include data tones, pilot tones, extra (channel estimation) tones, or any combination thereof. The quantity of used tones, which may include tones of two ELR symbols, may be 96 tones, for example. In examples in which the quantity of used tones is 96 tones, the set of ELR sequences may be associated at least in part with a Hadamard matrix with an order of (96×96) or (48×48). For example, the set of ELR sequences may be selected from a (96×96) Hadamard (H96) matrix or may be generated in accordance with a Hadamard expansion of a subset of a (48×48) Hadamard (H48) matrix. The H96 matrix or the H48 matrix may be generated directly via a software command or may be constructed in accordance with multiple Golay pairs through a Goethals-Seidel array. In examples in which an H96 matrix is used, the multiple Golay pairs may include a Golay 8 pair and a Golay 16 pair. In examples in which an H48 matrix is used, the multiple Golay pairs may include a Golay 4 pair and a Golay 8 pair.

Particular aspects of the subject matter described in this disclosure can be implemented to realize one or more of the following potential advantages. In some examples, by transmitting ELR data and long training field (LTF) according to an ELR PPDU tone plan, a receiving device may filter and parse data and LTF signals using hardware and techniques that are used for other types of PPDUs, such as UHR PPDUs. In some examples, by transmitting power-boosted fields in an ELR PDU preamble, a receiving device may more reliably detect the power-boosted fields and determine whether the associated PPDU is relevant to the receiving device or can be ignored. In some examples, by transmitting an ELR sequence that corresponds to a specific BSS (e.g., that indicates a BSS color), a receiving device may selectively parse a remainder of the PPDU after the set of ELR symbols in accordance with whether the receiving device has a matching BSS. For example, if the receiving device does not have a matching BSS with the BSS conveyed by the ELR sequence, the receiving device may select, determine, identify, or ascertain that the PPDU is likely intended for a different device and terminate a parsing procedure accordingly. In accordance with facilitating such techniques, an “early drop” may be achieved at one or more unintended receiving devices, and the unintended receiving devices may save power (which may increase battery life) or use now-available processing or RF circuitry for one or more other tasks (which may increase processing speed and enhance a user experience), or both.

Additionally, by formatting an ELR-SIG field of an ELR PPDU to provide (relatively early within the ELR-SIG field) relatively most useful information for demodulating and decoding the ELR-data that follows the ELR-SIG field, a receiving device may have more time to prepare one or more components associated with data reception processing at the receiving device. In other words, the disclosed ELR-SIG field designs may enable a receiving device to switch or configure one or more components in accordance with an indicated MCS and coding associated with the ELR-data prior to a start of an ELR-data field, which may result in a greater likelihood of successful demodulation and decoding at the receiving device. For example, the receiving device may experience or measure a greater signal quality, and accordingly an extended range, in accordance with properly preparing for ELR-data reception. In accordance with such a greater likelihood of successful demodulation and decoding, implementing networks may experience higher data rates, greater spectral efficiency, and greater system capacity, among other benefits.

Further, in accordance with the described procedures for generating ELR sequences, various wireless communication devices may efficiently use a quantity of ELR sequences equal to a quantity of possible BSS color values with lengths adapted to a quantity of tones carrying the ELR sequence. The described procedures also may provide ELR sequences having relatively low PAPRs and low false color rate. By achieving a relatively low PAPR in an ELR sequence transmission, various wireless communication devices may experience greater power amplifier efficiency and avoid or reduce both in-band and out-of-band distortion, which may result in greater communication reliability throughout a network. Such greater communication reliability may further support higher data rates, greater network throughput, greater spectral efficiency, and greater network capacity, among other benefits.

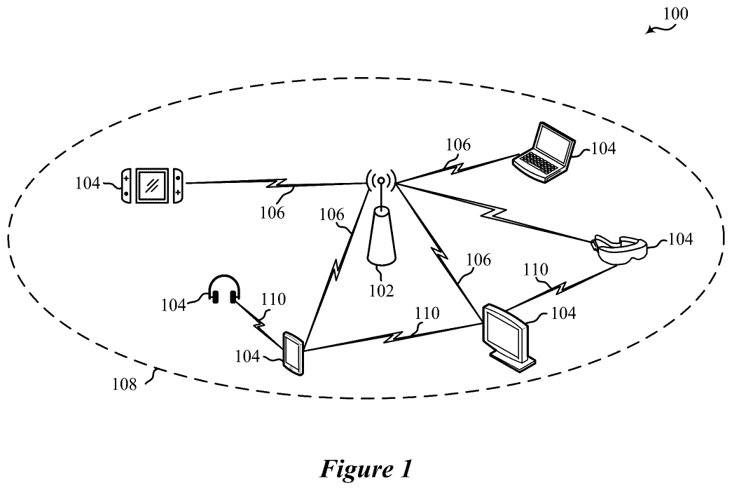

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless AP 102 and any number of wireless STAs 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (cNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

In some implementations, an AP 102 or a STA 104 may support one or more signaling- or configuration-based mechanisms according to which the AP 102 or the STA 104 may transmit or receive one or more PPDUs associated with an ELR format. An AP 102 or a STA 104 may perform an ELR transmission to increase a coverage range of the AP 102 or the STA 104. For example, the AP 102 or the STA 104 may power boost one or more portions (such as one or more fields) of a PPDU associated with an ELR format to facilitate longer range communication. Additionally, or alternatively, the AP 102 or the STA 104 may modulate or leverage a resource allocation scheme to facilitate longer range communication.

In some aspects, the AP 102 or the STA 104 may support one or more tone plans, signaling designs, power boosting of one or more fields, field/subfield interpretations, or any combination thereof, to enable or facilitate a ELR communications at one or more receiving devices. For example, in association with transmitting a PPDU in a manner that facilitates longer range communication, relatively more devices may receive or detect the PPDU. To avoid causing unnecessary power consumption (due to, for example, parsing operations) across such a relatively larger quantity of potential receiving devices, wireless communication devices (such as one or more APs 102 or one or more STAs 104, or any combination thereof) within the wireless communication network 100 may employ tone plans, signaling designs, power boosting of one or more fields, field/subfield interpretations, or any combination thereof, to facilitate mechanisms according to which a receiving device may stop (such as cease, suspend, pause, terminate, or cancel) parsing a received PPDU at a relatively early stage if the PPDU is not intended for that receiving device.

Additionally, or alternatively, the AP 102 or the STA 104 may support one or more tone plans, signaling designs, power boosting of one or more fields, field/subfield interpretations, or any combination thereof, to provide information usable to parse one or more ELR-data fields, such as information associated with an MCS, a coding, or a rate matching scheme, or any combination thereof. Further, in accordance with some example implementations, two or more wireless communication devices may exchange (such as transmit or receive) one or more of capability signaling, configuration signaling, or activation/deactivation signaling associated with one or more of the example signaling designs, formats, or field/subfield interpretations disclosed herein.

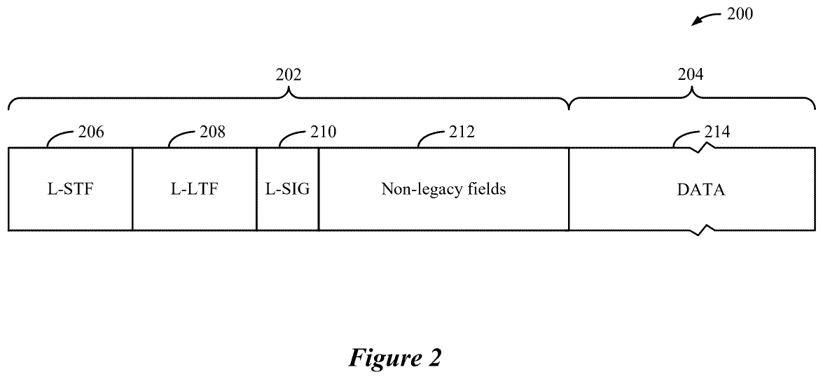

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (such as obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

In some implementations, the one or more non-legacy fields 212 may include a U-SIG field, an ELR field (such as an ELR-mark field) including one or more ELR symbols (such as one or more ELR-mark symbols), an ELR-STF (which may sometimes be referred to as an ELR-STF field), an ELR-LTF (which may sometimes be referred to as an ELR-LTF field), and an ELR-SIG field. In such implementations, the data field 214 may be an example of an ELR-data field. A transmitting wireless communication device, such as an AP 102 or a STA 104, may generate the PDU 200 to include one or more of the U-SIG field, the ELR field, the ELR-STF field, the ELR-LTF field, and the ELR-SIG field in association with formatting the PDU 200 in accordance with an ELR format, such as an ELR PPDU format.

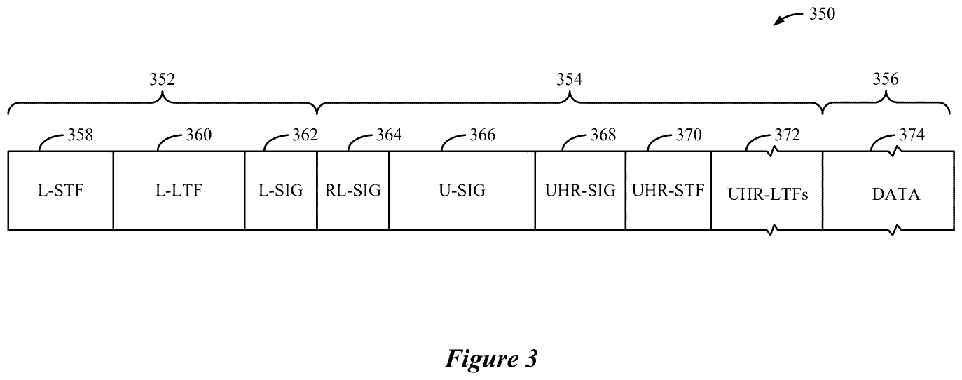

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364, a universal signal field 366 (referred to herein as “U-SIG 366”) and a UHR signal field 368 (referred to herein as “UHR-SIG 368”). The presence of RL-SIG 364 and U-SIG 366 may indicate to UHR or later version-compliant STAs 104 that the PPDU 350 is a UHR PPDU or a PPDU conforming to any later (post-UHR) version of a new wireless communication protocol conforming to a future IEEE 802.11 wireless communication protocol standard. One or both of U-SIG 366 and UHR-SIG 368 may be structured as, and carry version-dependent information for, other wireless communication protocol versions associated with amendments to the IEEE family of standards beyond UHR. For example, U-SIG 366 may be used by a receiving device (such as an AP 102 or a STA 104) to interpret bits in one or more of UHR-SIG 368 or the data field 374. U-SIG 366 may include one or more universal, version-independent fields and one or more version-dependent fields. Information in the universal fields may include, for example, a version identifier (starting from the IEEE 802.11be amendment and beyond) and channel occupancy and coexistence information (such as a punctured channel indication). The version-dependent fields may include format information fields used for interpreting other fields of U-SIG 366 and UHR-SIG 368 and additional information fields or single user (SU)-specific fields that may be useful to intended recipients. In some implementations, the version-dependent fields may include at least a PPDU format field to indicate a general PPDU format for the PPDU 350 (such as a trigger-based (TB), a single-user (SU), or a multi-user (MU) PPDU format). Like L-STF 358, L-LTF 360, and L-SIG 362, the information in U-SIG 366 and UHR-SIG 368 may be duplicated and transmitted in each of the component 20 MHz channels in instances involving the use of a bonded channel.

The non-legacy portion 354 further includes an additional short training field 370 (referred to herein as “UHR-STF 370,” although it may be structured as, and carry version-dependent information for, other wireless communication protocol versions beyond UHR) and one or more additional long training fields 372 (referred to herein as “UHR-LTFs 372,” although they may be structured as, and carry version-dependent information for, other wireless communication protocol versions beyond UHR). UHR-STF 370 may be used for timing and frequency tracking and AGC, and UHR-LTF 372 may be used for more refined channel estimation.

UHR-SIG 368 may be used by an AP 102 to identify and inform one or multiple STAs 104 that the AP 102 has scheduled uplink (UL) or downlink (DL) resources for them. UHR-SIG 368 may be decoded by each compatible STA 104 served by the AP 102. UHR-SIG 368 also may generally be used by the receiving device to interpret bits in the data field 374. For example, UHR-SIG 368 may include resource unit (RU) allocation information, spatial stream configuration information, and per-user (such as STA-specific) signaling information. Each UHR-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

In some wireless communications systems, a STA 104 or an AP 102 may transmit the PPDU 350 over bandwidths larger than the 20 MHz, 40 MHz, 80 MHz, 160 MHz, and 320 MHz bandwidths supported by previous generations of IEEE-compliant wireless communication systems. For example, the PPDU 350 may support 480 MHz or 640 MHz bandwidth communications. By increasing the channel bandwidth of the PPDU 350 to 480 MHz or 640 MHz, more data may be transmitted because more or larger RUs are available based on the larger bandwidth, and accordingly, higher peak throughput or increased capacity may be achieved. Parameters for assembling and transmitting the 480 MHz or 640 MHz PPDUs may be defined to account for the larger bandwidths. For example, parameters or designs such as the tone plans, resource unit allocation indications, spatial reuse fields, UHR-STFs 370, UHR-LTFs 372, pilot signal locations, phase shifts, and spectral masks may be optimized or otherwise selected in accordance with the 480 MHz or 640 MHz bandwidths. In some examples, the spatial reuse fields may enable multiple BSSs to operate on the same 480 MHz or 640 MHz bandwidth channels.

In some examples, UHR-capable STAs 104 and APs 102 may support unequal modulation techniques (also referred to as unequal quadrature amplitude modulation (QAM)) with joint encoding across multiple streams for MIMO communications. For example, while different data streams may be transmitted using different spatial streams, or different resource units (RUs), or both, different spatial streams or RUs may be associated with different levels of quality (such as a different signal to noise ratios (SNRs)), and it may be advantageous to use different (unequal) MCSs for different spatial streams or RUs.

To support unequal modulation, an AP 102 may transmit signaling that indicates unequal MCSs across spatial streams or RUs to multiple STAs 104. For example, the AP 102 may transmit an MCS configuration message, which may be an example of a PHY preamble included in control signaling for PHY layer configuration, to indicate the unequal MCSs. In some examples, an MCS field of the MCS configuration message may include entries for unequal QAM schemes across multiple spatial streams, where the multiple spatial streams may be encoding with the same code rate.

In some wireless communication systems, wireless communication devices may support low density parity check (LDPC) coding for forward error correcting purposes to increase the likelihood of accurate data transmission. In some examples, UHR-capable STAs 104 and APs 102 may be capable of selecting among multiple LDPC codeword lengths, including 648 bits, 1296 bits and 1944 bits (defined in legacy IEEE 802.11 wireless communications protocol standards), as well as even longer (extended) codeword lengths, which may increase as operating bandwidths increase, higher modulation orders are introduced, or more spatial streams are available. Using longer LDPC codewords may achieve lower block error rates in some channels, such as channels associated with additive white Gaussian noise. Longer LDPC codewords also may enable more reliable communications in channels with lower SNRs. To facilitate the use of multiple LDPC codeword lengths, a STA 104 and an AP 102 may each include multiple LDPC encoders and multiple LDPC decoders. In some examples, such a STA 104 or AP 102 may connect, aggregate or otherwise utilize multiple encoders to implement a larger single encoder capable of encoding a longer codeword, or similarly, utilize multiple decoders to implement a larger single decoder capable of decoding a longer codeword, which may increase performance gains associated with larger block sizes without substantially increasing the hardware cost or complexity. In some examples, to generate an extended LDPC codeword, a STA 104 or an AP 102 may implement one or more lifting operations to extend a shorter codeword, with each lifting operation extending the previously lifted codeword. A “lifting” operation enables LDPC codes to be implemented using parallel encoding or decoding implementations while also reducing the complexity typically associated with large LDPC codewords. In some examples, a STA 104 or an AP 102 may use mixed codeword lengths for a given transmission. For example, the STA 104 or the AP 102 may encode input bits into one or more codewords having a first, longer codeword length (more than 1944 bits) and one or more codewords having a second, shorter codeword length (1944 bits or less). In such examples, the STA 104 or the AP 102 may perform shortening or puncturing on the codewords having the longer codeword length, or on the codewords having the shorter codeword length, or both.

To support increased range or rate-over-range, a STA 104 and an AP 102 may support ELR PPDU formats. The use of an ELR PPDU format can enable the achievement of a target data rate while maintaining an existing coverage range, reduce an uplink/downlink power imbalance (due to, for example, one or more regulations or hardware differences at the uplink and downlink devices), or extend a coverage range while maintaining a similar, or slightly lower, data rate as compared with other PPDU formats. In some examples, an ELR PPDU may be transmitted over a narrow bandwidth, which may have a lower noise floor and thus higher SNR, thereby extending the coverage range. The reliability of the transmission of an ELR PPDU also may be increased as a result of using various optimized coding rates, coded bit repetition schemes, or duplication schemes, which may provide for improved decodability and fewer retransmissions. In some examples, the U-SIG 366 of an ELR PPDU 350 may include a first indication (such as a codepoint of a PHY version identifier subfield within a version-independent portion of the U-SIG 366 or a value of an ELR subfield within a version-dependent portion of the U-SIG 366) that the PPDU 350 is associated with an ELR format. The U-SIG 366 of an ELR PPDU 350 may include a second indication (such as a STA identifier subfield within the version-dependent portion of the U-SIG 366) of an intended receiver of the PPDU. In some examples, an ELR PPDU 350 may include an ELR-signature (ELR-SIG) field that includes an uplink/downlink indicator subfield, a length subfield, a coding indicator subfield, and a modulation and coding scheme (MCS) subfield.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (such as APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

In some aspects, the wireless communication device may indicate a format of a PPDU via a PHY version identifier subfield of a U-SIG field, such as the U-SIG 366. For example, in some implementations, a first codepoint (such as a “0” value as denoted by, for example, “000” codepoint) of the PHY version identifier subfield may indicate that the PPDU 350 is associated with the EHT format. A second codepoint (such as a “1” value as denoted by, for example, a “001” codepoint) of the PHY version identifier subfield may indicate that a PPDU is associated with a UHR format. In some aspects, the second codepoint may indicate that the PPDU is associated with a UHR format or an ELR format. Alternatively, a third codepoint (such as a “2” value as denoted by, for example, a “010” codepoint, or such as a “7” value as denoted by, for example, a “111” codepoint) of the PHY version identifier subfield may indicate that the PPDU is associated with an ELR format.

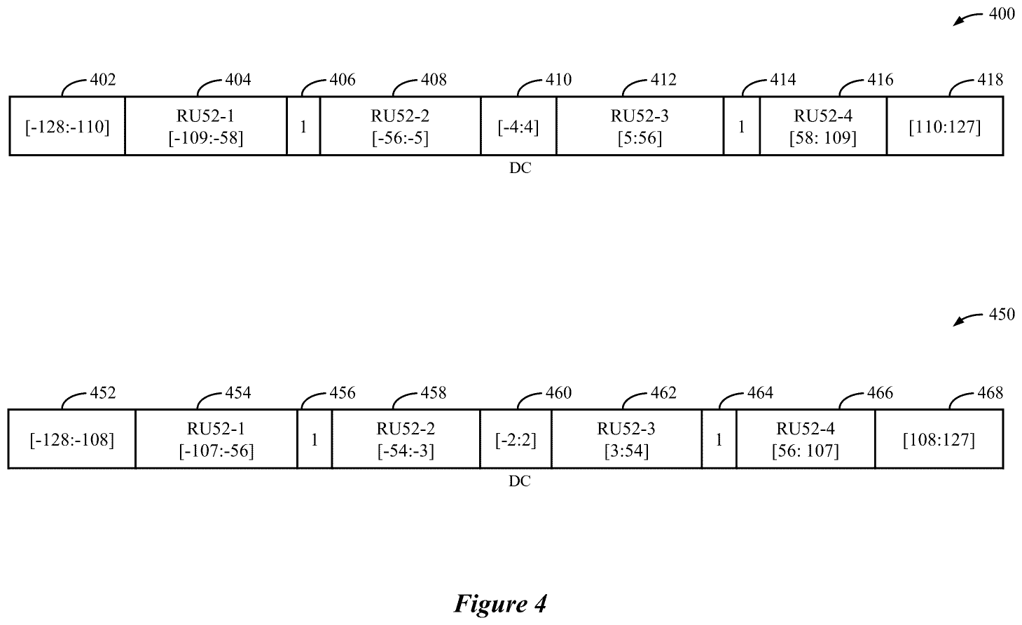

FIG. 4 shows example tone plans 400 and 450 that support signaling designs for ELR transmissions. For example, the tone plans 400 and 450 may be associated with ELR-data and LTF in an ELR PPDU format and a wireless communication device (such as a STA 104 or an AP 102) may communicate ELR PPDUs in accordance with the tone plans 400 or 450. A wireless communication device may generate ELR PPDUs in accordance with the tone plans 400 or 450 for an MU PPDU. A wireless communication device may generate ELR PPDUs in accordance with the tone plans 400 or 450 for a trigger-based (TB) PPDU.

The tone plans 400 or 450 may be associated with (such as include) ELR-data and LTF portions of an ELR PPDU. In a first example tone plan 400, ELR data and LTF may be transmitted in resource units (RUS) that span 52 tones, referred to as RU52 allocations. The first example tone plan 400 includes a first set of guard band tones 402, a first set of RU52 tones 404, a first gap tone 406, a second set of RU52 tones 408, a set of DC tones 410, a third set of RU52 tones 412, a second gap tone 414, a fourth set of RU52 tones 416, and a second set of guard band tones 418. In some examples, each of RU52 may transmit an instance of a same set of data to provide four repetitions of the data, which may provide a +6 dB link budget gain. In this example, tones for each RU52 allocation are shifted by 12 tones toward a center tone relative to a traditional 4× RU52 tone plan (such as 4× RU52 tone plans for OFDMA as provided in IEEE 802.11ax that also includes a RU26 allocation in a center portion of the tone plan). Shifting by even number of tones may provide that pilots in the first example tone plan 400 have even tone indices as are included in such traditional 4× RU52 tone plans, which may allow at least some portions of software and hardware components associated with the pilots to be reused for ELR communications. In the first example tone plan 400, the set of DC tones 410 include nine tones, which may provide for the use of a notch filter for demodulation and decoding of ELR PPDUs that are transmitted in accordance with the first example tone plan 400.

The second example tone plan 450 includes a first set of guard band tones 452, a first set of RU52 tones 454, a first gap tone 456, a second set of RU52 tones 458, a set of DC tones 460, a third set of RU52 tones 462, a second gap tone 464, a fourth set of RU52 tones 466, and a second set of guard band tones 468. Compared to the first example tone plan 450, the second example tone plan 450 includes two additional tones in the first set of guard band tones 452 and the second set of guard band tones 468, and four fewer tones in the set of DC tones 460. Thus, in this example, tones for each RU52 allocation are shifted by 14 tones toward a center tone relative to a traditional 4× RU52 tone plan (such as 4× RU52 tone plans for OFDMA as provided in IEEE 802.11ax that also includes a RU26 allocation in a center portion of the tone plan). As discussed with respect to the first example tone plan 400, the second example tone plan 450 provides for shifting by even number of tones that may provide pilots in the second example tone plan 450 have even tone indices as are included in such traditional 4× RU52 tone plans, which may allow at least some portions of software and hardware components associated with the pilots to be reused for ELR communications. In the second example tone plan 450, the set of DC tones 460 include five tones, which may provide for the use of a notch filter for demodulation and decoding of ELR PPDUs that are transmitted in accordance with the second example tone plan 450.

In some aspects, ELR-LTF sequence may be shifted by same number of tones as the ELR data tones plan toward a center tone relative to ELT-LTF or UHR-LTF on a traditional 4× RU52 tone plan.

In some aspects, an ELR-LTF sequence may be provided for the tone plan. For example, in two instances of an LTF transmission are provided, populated on even tone indices, every RU52 only has 26 tones with power on. In some examples, a Golay 26 complementary pair (G26a,G26b) may be used to fill in the remaining LTF tones for ELR-LTF, such as shown below which may provide a peak-to-average-power (PAPR) of 2.92 dB:

$$, ELR - LTF ( - 106 : 2 : - 4 , 4 : 2 , 106 ) = [ G 26 a , - G 26 b , G 26 a , G 26 b ] ;$$

$$, G 26 a = [ 1 , 1 , 1 , 1 , - 1 , 1 , 1 , - 1 , - 1 , 1 , - 1 , 1 , 1 , 1 , 1 , 1 , - 1 , 1 , - 1 , - 1 , - 1 , 1 , 1 , - 1 , - 1 , - 1 ] ;$$

$$, G 26 b = [ 1 , 1 , 1 , 1 , - 1 , 1 , 1 , - 1 , - 1 , 1 , - 1 , 1 , - 1 , 1 , - 1 , - 1 , 1 , - 1 , 1 , 1 , 1 , - 1 , - 1 , 1 , 1 , 1 ] .$$

Note: The LTF sequence is zero at the tone locations not listed above.

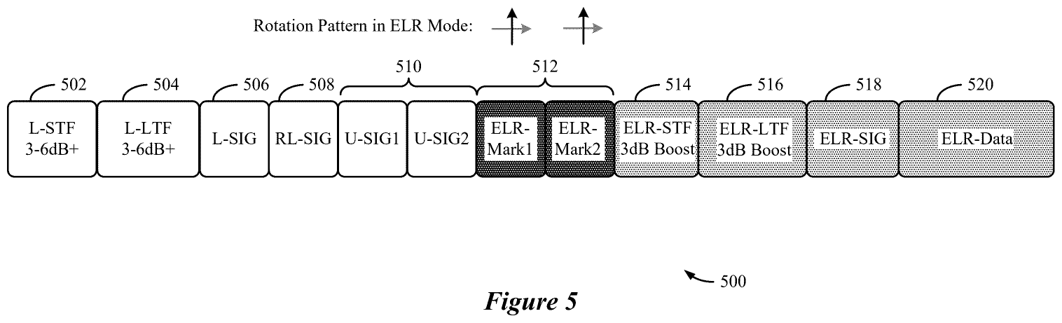

FIG. 5 shows an example of an ELR PPDU format 500 that supports signaling designs for ELR transmissions. The ELR PPDU format 500 may be an example PPDU format that supports or is otherwise associated with ELR communication. For example, a wireless communication device participating in ELR communication may generate and transmit, or receive and parse, a PPDU in accordance with the ELR PPDU format 500.

In accordance with the ELR PPDU format 500, a PPDU may include an L-STF 502 (which may be power boosted by approximately +3 decibels (dB), and may be power boosted by up to approximately +6 dB depending upon implementation), an L-LTF 504 (which may be power boosted by approximately +3 dB, and may be power boosted by up to approximately +6 dB depending upon implementation), an L-SIG field 506, an RL-SIG field 508, a U-SIG field 510 (which may include multiple symbols, such as two symbols including a first symbol U-SIG1 and a second symbol U-SIG2), an ELR field 512 (such as an ELR-mark field) including a set of ELR symbols (such as ELR-mark symbols, such as two ELR-mark symbols), an ELR-STF field 514 that may be power boosted by 3 dB, an ELR-LTF field 516 that may be power boosted by 3 dB, an ELR-SIG field 518, and an ELR-data field 520. The ELR-STF field 514 may include one or multiple ELR-STF symbols. The ELR-LTF field 516 may include one or multiple ELR-LTF symbols. The set of ELR symbols of the ELR field 512 may be associated with a rotation pattern in an ELR mode.

In some implementations, the ELR-STF may have same length as UHR DL OFDMA with four RU52 (such as a total length or duration of 4 microseconds (μs) long in accordance with a periodicity of 0.8 μs with 5 periods), plus further +3 dB boosting. In some implementations, the ELR-LTF may have a total length or duration of 12.8 μs plus guard intervals (GIs) with 3 dB boosting, or may have a total length or duration of 25.6 μs plus GIs with or without 3 dB power boosting. In some implementations, an ELR PPDU may have a fixed/single mode of LTF+GI, such as one of 2×-LTF+1.6 μs GI, 4×-LTF+0.8 μs GI, or 4×-LTF+1.6 μs GI. Without counting one or more GIs, 2×-LTF may have a length or duration of 6.4 μs and 4×-LTF may have a length or duration of 12.8 μs. Thus, a 12.8 μs ELR-LTF may be one 4×-LTF or two 2×-LTFs. A 25.6 μs ELR-LTF may be two 4×-LTFs or four 2×-LTFs.

In some implementations, a transmitting device may include one or more indications within one or more fields or subfields a PPDU associated with the ELR PPDU format 500 to reduce false alarms (such as to enable the receiving device to accurately ascertain whether the PPDU is an ELR PPDU or a non-ELR PPDU) or enable an “early drop” of the PPDU at one or more unintended receivers of the PPDU. As used herein, a “false alarm” herein may be understood as a scenario in which a receiving device parses a PPDU in accordance with incorrectly determining that the received PPDU is an ELR PPDU, or vice versa. Additionally, or alternatively, the transmitting device may structure, design, organize, or format the ELR-SIG field 518 to provide information in accordance with which a receiving device may parse (such as demodulate and decode) the ELR-data field 520 with low latency, which may provide higher quality wireless communication and greater likelihoods of successful communication, which may in turn support higher data rates and greater network capacity.

In some implementations, a transmitting device may perform carrier frequency offset (CFO) pre-compensation, and an ELR receiver may perform packet detection (PD) in one of two modes depending on whether CFO pre-compensation is used or not. For example, a first transmit mode may not user CFO pre-compensation and a second transmit mode may include CFO pre-compensation, and an ELR receiver may accommodate both modes in accordance with an autocorrelation or cross-correlation receive mode. In some examples, a PD algorithm may be selected at the ELR receiver in accordance with the transmit mode. In some examples, CFO pre-correction for uplink communications may be used, and for downlink communications a client side device may not need pre-correction at its receiver.

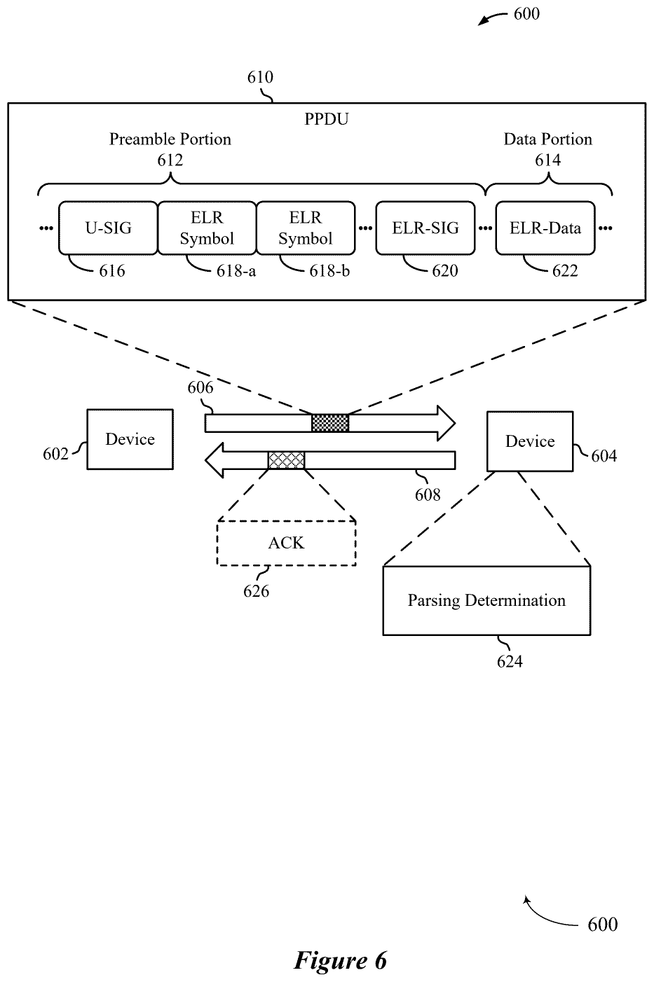

FIG. 6 shows an example of a signaling diagram 600 that illustrates communication of an ELR PPDU between two wireless communication devices that supports signaling designs for ELR transmissions. For example, the signaling diagram 600 illustrates communication between a wireless communication device 602 and a wireless communication device 604 via a communication link 606 and a communication link 608. The wireless communication device 602 may be an example of a STA 104 or an AP 102, such as a STA 104 or an AP 102 as illustrated by and described with reference to FIG. 1. The wireless communication device 604 may be an example of a STA 104 or an AP 102, such as a STA 104 or an AP 102 as illustrated by and described with reference to FIG. 1. Generally, the wireless communication device 602 may be understood or function as a transmitting device and the wireless communication device 604 may be understood or function as a receiving device.

For example, the wireless communication device 602 may transmit, via the communication link 606, a PPDU 610 and the wireless communication device 604 may receive, via the communication link 606, the PPDU 610. In some aspects, the PPDU 610 may be associated with an ELR format, such as the ELR PPDU format 500 as illustrated by and described with reference to FIG. 5. In examples in which the PPDU 610 is associated with the ELR PPDU format 500, a preamble portion 612 of the PPDU 610 may include a U-SIG field 616, an ELR field (such as an ELR-mark field) including an ELR symbol 618-a and an ELR symbol 618-b, and an ELR-SIG field 620, among other fields (as illustrated by and described with reference to FIG. 5). The preamble portion 612 may be understood or referred to herein as an ELR preamble. A data portion 614 of the PPDU 610 may include an ELR-data field 622, among other potential data fields.

The U-SIG field 616 may include a version independent portion and a version dependent portion and, in some aspects, the reserved bits within the version dependent portion of the U-SIG field 616 may be any combination of one or more disregard bits, one or more validate bits, or one or more information bits. In some implementations, the U-SIG field 616 may include an implicit or an explicit indication that the PPDU 610 is associated with an ELR format. The ELR-SIG field 620 may span or include one or two symbols and, in some aspects, the wireless communication device 602 may transmit the ELR-SIG field 620 using MCS 0 (such as BPSK with a ½ coding rate)+binary convolution code (BCC). The wireless communication device 602 may duplicate the ELR-SIG field 620 across, via, or over four regular RU52.

In some implementations, the wireless communication device 604 may receive and parse at least a portion of the PPDU 610 and, in accordance with parsing the portion of the PPDU 610, may perform a parsing determination 624. In accordance with the parsing determination 624, the wireless communication device 604 may select, determine, calculate, identify, or otherwise ascertain whether to continue parsing the PPDU 610 or to drop (and not parse) a remainder of the PPDU 610. Thus, the parsing determination 624 performed by the wireless communication device 604 may be equivalently referred to as a mode classification, a mode detection, a parsing decision, a parsing selection, a parsing calculation, or a parsing identification, among other examples. In examples in which the wireless communication device 604 drops a remainder of the PPDU 610 in accordance with the parsing determination 624, the wireless communication device 604 may be understood as performing an “early drop” of the PPDU 610, which may save power and processing resources at the wireless communication device 604.

The wireless communication device 604 may drop a remainder of the PPDU 610 in association with selecting, determining, identifying, calculating, or otherwise ascertaining that the wireless communication device 604 is not an intended receiver of the PPDU 610, that the wireless communication device 604 is not associated with a same BSS as an intended receiver of the PPDU 610, or that the wireless communication device 604 is a non-ELR-capable device (and therefore not capable of parsing the PPDU 610, if the PPDU 610 is associated with an ELR format). Alternatively, the wireless communication device 604 may continue parsing (at least a portion of) the PPDU 610 in association with selecting, determining, identifying, calculating, or otherwise ascertaining that the wireless communication device 604 is an intended receiver of the PPDU 610, that the wireless communication device 604 is associated with a same BSS as an intended receiver of the PPDU 610, or that the wireless communication device 604 is an ELR-capable device (and therefore is capable of parsing the PPDU 610, if the PPDU 610 is associated with an ELR format). If the wireless communication device 604 is the intended receiver and successfully parses the PPDU 610, the wireless communication device 604 may transmit, to the wireless communication device 602 via the communication link 608, an acknowledgment (ACK) 626. The ACK 626 may be a block ACK (BA) frame, among other example feedback frames.

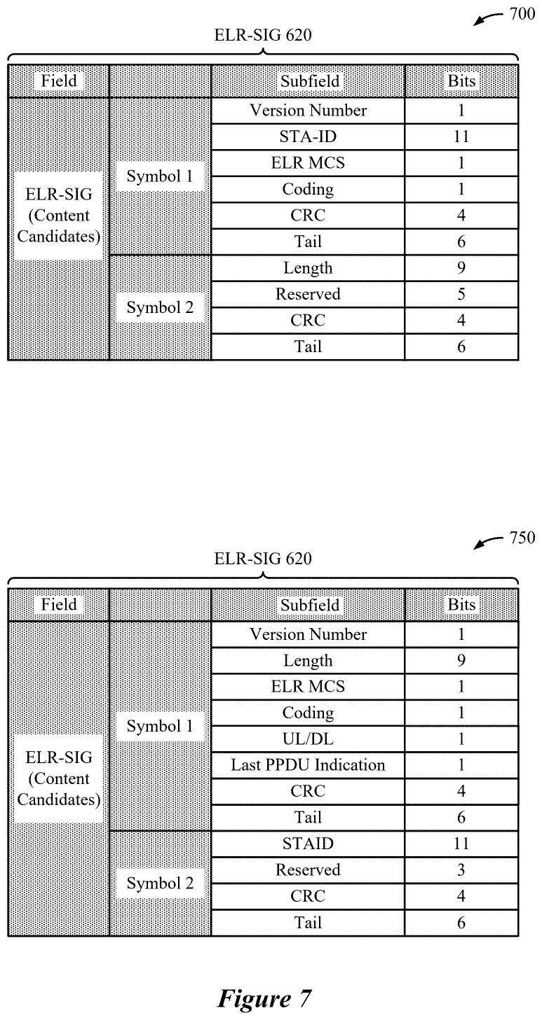

The wireless communication device 602 and the wireless communication device 604 may use any one or more of the U-SIG field 616, the ELR symbol 618-a and the ELR symbol 618-b, and the ELR-SIG field 620 to facilitate or enable the parsing determination 624 at the wireless communication device 604. In some implementations, for example, the wireless communication device 602 and the wireless communication device 604 may use one or more subfields or subfield interpretations of the U-SIG field 616 to facilitate or enable the parsing determination 624 at the wireless communication device 604. Additionally, or alternatively, the wireless communication device 602 and the wireless communication device 604 may use one or more subfields or subfield interpretations of the ELR-SIG field 620 to facilitate or enable the parsing determination 624 at the wireless communication device 604. Additional details relating to such subfields or subfield interpretations are illustrated and described herein, including by and with reference to FIGS. 7-10.

Further, in some aspects, there may be an absence of additional symbols/cushion between the ELR-SIG field 620 and an ELR-data field 622. In such aspects, the wireless communication device 602 and the wireless communication device 604 may use one or more subfields, subfield interpretations, or formats of the ELR-SIG field 620 to reduce a decoding delay for the ELR-SIG field 620 (such as to provide sufficient time for the wireless communication device 604 to prepare one or more components, such as one or more receivers, to receive the ELR-data field 622). In some implementations, the wireless communication device 602 and the wireless communication device 604 may support a two-symbol design for the ELR-SIG field 620, with the first symbol or relatively earlier subfields of the ELR-SIG field 620 carrying the control information (such as the relatively most useful control information) that the wireless communication device 604 may use for demodulation of the ELR-data field 622. The two symbols may be separately encoded or jointly encoded.

In implementations in which the ELR-SIG field 620 includes or spans two symbols, the wireless communication device 602 and the wireless communication device 604 may format the ELR-SIG field 620 in a manner that provides sufficient time for the wireless communication device 604 to configure a data reception processing (for receiving an ELR-data field 622). In some aspects, the two ELR-SIG symbols may be separately encoded (and separately decoded). In such aspects, each ELR-SIG symbol may include or carry 14 information bits with tail bits. Further, in such aspects, the wireless communication device 602 may place an MCS subfield and a coding (such as LDPC/BCC coding) subfield within a first set of relatively earlier subfields (such as subfields within the first symbol) and may place other subfields, including a CRC subfield and a tail subfield, within a second set of relatively later subfields (such as subfields within the second symbol). In accordance with such aspects, the wireless communication device 604 may prepare the switch in MCS and coding during the second set of subfields (such as during the second symbol).

In examples in which the two ELR-SIG symbols are separately encoded, the ELR-SIG field 620 may include subfields that provide information related to the PPDU 610, such as one or more of a version number subfield (1 or 2 bits, sometimes located within the first symbol), a STA-ID subfield (11 bits for a full ID or of 3, 4, or 8 bits, among other examples, for a partial ID, located within the first symbol, the second symbol, or both), a coding subfield (1 or 2 bits, sometimes located within the first symbol), an MCS subfield (1 bit, sometimes located within the first symbol), a length subfield (7, 8, or 9 bits, located in the first symbol or the second symbol), a BSS color subfield (6 bits, located in the first symbol or the second symbol), a uplink/downlink indication subfield (1 bit, located in the first symbol or the second symbol), a last PPDU indication subfield (1 bit, located in the first symbol or the second symbol to indicate a final PPDU in a TxOP), a CRC subfield (4 bits, located in one or both of the first symbol and the second symbol), or a tail subfield (6 bits, located in one or both of the first symbol and the second symbol). In such examples, the first and second symbols may have separated tail bits and may have separated or joint CRC bits. Additional details relating to such two separately encoded ELR-SIG symbols are illustrated and described herein, including by and with reference to FIGS. 7-9.

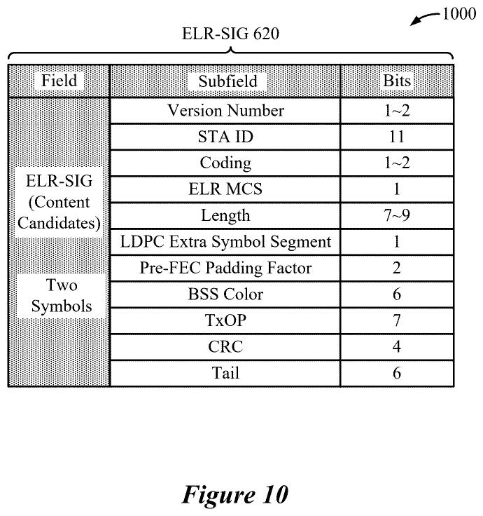

In some other aspects, the two ELR-SIG symbols may be jointly encoded (and jointly decoded). In examples in which the two ELR-SIG symbols are jointly encoded, the ELR-SIG field 620 may include one or more of a version number subfield (1 or 2 bits), a STA-ID subfield (11 bits), a coding (such as LDPC/BCC coding) subfield (1 or 2 bits), an MCS subfield (1 bit), a length subfield (7, 8, or 9 bits), an LDPC extra symbol segment subfield (1 bit), a pre-FEC padding factor subfield (2 bits), a BSS color subfield (6 bits), a TXOP subfield (7 bits), a CRC subfield (4 bits), or a tail subfield (of 6 bits). Additional details relating to such jointly encoded ELR-SIG symbols are illustrated and described herein, including by and with reference to FIG. 10.

In examples in which the length subfield of the ELR-SIG field 620 includes 7 bits, and if a packet duration is less than a threshold duration (such as less than 128 OFDM symbols), the wireless communication device 602 and the wireless communication device 604 may use one symbol as a resolution/unit of the length indicated by the length subfield. Otherwise, if the packet duration is greater than or equal to the threshold duration (such as greater than or equal to 128 OFDM symbols), the wireless communication device 602 and the wireless communication device 604 may use two symbols as the resolution/unit of the length indicated by the length subfield. In examples in which the length subfield of the ELR-SIG field 620 includes 9 bits, the wireless communication device 602 and the wireless communication device 604 may use one symbol as a resolution/unit of the length indicated by the length subfield.

In examples in which the length subfield of the ELR-SIG field 620 includes 8 bits, for a value “L” of the length subfield in a range of 0-63, the wireless communication device 602 and the wireless communication device 604 may calculate, select, or otherwise determine a (total) quantity of ELR data symbols as in accordance with a first equation. Such a first equation may be, for example, # of ELR data symbols=L+1. Alternatively, for a value “L” of the length subfield in a range of 64-255, the wireless communication device 602 and the wireless communication device 604 may calculate, select, or otherwise determine a (total) quantity of ELR data symbols as in accordance with a second equation. Such a second equation may be, for example, # of ELR data symbols=(L−64)*2+66=2L−62. In examples in which the length subfield of the ELR-SIG field 620 includes 9 bits, a value of 0 may indicate one OFDM symbol, a value of 1 may indicate two OFDM symbols, and so on, up to a maximum of a value of 372 that may indicate 373 OFDM symbols (or 5.5 ms in duration).

Additionally, or alternatively, the ELR-SIG field 620 may include a BSS color subfield (of 6 bits). The ELR-SIG field 620 may conditionally include a BSS color subfield in accordance with whether the ELR-mark (such as the ELR symbol 618-a and the ELR symbol 618-b) indicates a BSS color. For example, if the wireless communication device 602 transmits an ELR-mark sequence via the ELR symbol 618-a and the ELR symbol 618-b indicative of BSS information, such as BSS color, a BSS ID, a BSS address, or AP specified BSS information number (such as a BSS color associated with an intended/addressed receiver or a transmitter of the PPDU 610), the ELR-SIG field 620 may exclude a BSS color subfield. Alternatively, if the wireless communication device 602 uses the ELR symbol 618-a and the ELR symbol 618-b for another purpose (outside of a BSS color indication), the ELR-SIG field 620 may include a BSS color subfield. In some examples, the wireless communication device 602 may transmit an ELR-mark sequence via the ELR symbol 618-a and the ELR symbol 618-b indicative of BSS information such as BSS color and may additionally include a BSS color subfield within the ELR-SIG field 620 to reinforce (such as with redundancy) the BSS color indication provided by the PPDU 610.

Additionally, or alternatively, the ELR-SIG field 620 may include a TXOP subfield (of 7 bits). In some aspects, the wireless communication device 602 may exclude a TXOP subfield from the ELR-SIG field 620 in accordance with the PPDU 610 being associated with an ELR format. For example, in accordance with the wireless communication device 602 being potentially relatively distant from the wireless communication device 604 (which may be (implicitly) indicated to the wireless communication device 604 in accordance with the wireless communication device 604 being unable to decode the U-SIG field 616 of the PPDU 610), the wireless communication device 604 may not be expected to defer to a TXOP of the wireless communication device 602. In other words, if a receiving device is unable to decode the U-SIG field 616, the receiving device (such as an ELR-capable bystander) may not be expected to honor or respect a TXOP of the transmitting device as potentially indicated by the ELR-SIG field 620). In some other aspects, the ELR-SIG field 620 may include a TXOP subfield and the wireless communication device 604 may honor or respect (such as not transmit within) the TXOP indicated by the TXOP subfield.

In some implementations, the ELR-SIG field 620 may include one or more subfields associated with rate matching, such as rate matching associated with the data portion 614 or the ELR-data field 622. In some examples, such one or more subfields may include an LDPC extra symbol segment subfield (of 1 bit). The LDPC extra symbol segment subfield may be conditionally present, such as in accordance with a type of the LDPC used for the data portion 614 or the ELR-data field 622 or in accordance with whether an extra symbol segment is fixed to a static value. For example, the LDPC extra symbol segment subfield may be absent if the extra symbol segment is fixed (in accordance with a network specification or one or more network/operator rules) to be equal to, for example, 1 or 4.

Additionally, or alternatively, such one or more subfields may include a (common) pre-FEC padding factor subfield (of 2 bits). The pre-FEC padding factor subfield may indicate a value of “0,” “1,” “2,” or “3,” which may correspond to or indicate a pre-FEC padding factor (which may be denoted as a) of “4,” “1,” “2,” or “3,” respectively. In some aspects, the pre-FEC padding factor subfield may be conditionally present in accordance with a coding type or a simplified LDPC rate matching or in accordance with whether the pre-FEC padding factor is fixed to a static value. For example, if the pre-FEC padding factor is fixed such that a=4, the pre-FEC padding factor subfield may be absent. The wireless communication device 602 may set a=4 in examples in which an LDPC extra symbol segment is equal to 1, 0, or 4. Packet extension can be fixed for ELR PPDU, which can be set to 4 μs or 8 μs.

In some implementations, at ELR-SIG decoding and content parsing, when the BSS color information matches with the receiver but STA-ID does not, the receiver may maintain a ‘busy’ indication, such as a PHY-CCA indication (BUSY, channellist) primitive, for the predicted duration of the transmitted ELR PPDU which may be derived from the length subfield in the ELR-SIG field 620.

As discussed, in some implementations, the U-SIG field 616 may include an implicit or an explicit indication that the PPDU 610 is associated with an ELR format, and the wireless communications device 604 may identify the PPDU 610 as an ELR PPDU based on the implicit or explicit indication and a CRC from decoded subfields of the U-SIG field 616 that matches a CRC provided with the U-SIG 616. However, in some cases there may be a false positive from such a CRC check. In some implementations, when a SNR of the received U-SIG exceeds a threshold (such as a threshold associated with a medium to high SNR), the wireless communications device 604 may trust the U-SIG CRC and proceed with operations in accordance with the implicit or an explicit indication that the PPDU 610 is associated with an ELR format. If the SNR of the received U-SIG is below the threshold (such as for a low to medium SNR), the wireless communications device 604 may further perform content checking if the CRC passes, to confirm that the PPDU 610 is associated with the ELR format. In some examples, a first check may be that an ELR indication in provided in a 20 MHz bandwidth with a PHY version ID=1. In some examples, a second check may be that the version dependent portion of the U-SIG field 616 has a special pattern for ELR. In some implementations, each bit of a set of validate or disregard bits for an ELR U-SIG may be set to be the opposite to the default value for such bits as defined for a UHR U-SIG. For example, if the reserved bit is “1” by default in a UHR U-SIG, it can be set to “0” in a ELR U-SIG as additional check for ELR indication. Additionally, or alternatively, one or more version dependent subfield may be set to a value that is unused for UHR. For example, a punctured channel information subfield in U-SIG may have one or more unused values, which may be used for an additional ELR indication (if not repurposed in ELR U-SIG).

Additionally, or alternatively, in some implementations the ELR-SIG subfield 620 may include a CRC subfield. In some examples, the CRC in the ELR-SIG subfield 620 may use a same CRC calculation as used for PPDUs according to IEEE 802.11ax, based on whatever subfields are defined for the ELR-SIG subfield 620. In other examples, the BSS color may be added in the CRC computation when BSS color is not included in ELR-SIG but carried over from the ELR-field (such as the ELR-Mark) in ELR symbols 618-a and 618-b. Thus, the ELR-SIG subfield 620 may carry the BSS color either explicitly as a subfield in ELR-SIG content, or implicitly in which BSS color is used for CRC computation but not transmitted.

Additional details relating to schemes or options associated with the ELR-SIG subfield 620 are illustrated and described herein, including by and with reference to FIGS. 7-10.

FIG. 7 shows an example of ELR-SIG field designs 700 and 750 with separately encoded symbols that support signaling designs for ELR transmissions. In some implementations, the wireless communication device 602 and the wireless communication device 604 may leverage the ELR-SIG field design 700 or the ELR-SIG field design 750 to accommodate an early drop at an unintended receiving wireless communication device. Additionally, or alternatively, the wireless communication device 602 and the wireless communication device 604 may leverage the ELR-SIG field design 700 or the ELR-SIG field design 750 to provide an intended receiving wireless communication device with information that the intended receiving wireless communication device may use to parse or decode an ELR-data field 622, which may increase a likelihood of successful communication of the PPDU 610, which may in turn increase data rates and network capacity.

The wireless communication device 602 may format the ELR-SIG field 620 of the PPDU 610 in accordance with the ELR-SIG field design 700 or the ELR-SIG field design 750, with the ELR-SIG field design 700 and the ELR-SIG field design 750 corresponding to two symbol ELR-SIG designs. In other words, in accordance with the ELR-SIG field design 700 or the ELR-SIG field design 750, the ELR-SIG field 620 of the PPDU 610 may span or include two symbols that are separately encoded.

The wireless communication device 602 may format the ELR-SIG field 620 of the PPDU 610 in accordance with the ELR-SIG field design 700 or the ELR-SIG field design 750, with the ELR-SIG field design 700 and the ELR-SIG field design 750 corresponding to two symbol ELR-SIG designs. For example, in accordance with the ELR-SIG field design 700 or the ELR-SIG field design 750, the ELR-SIG field 620 of the PPDU 610 may span or include two separately encoded (and separately decoded) symbols. In such examples, the ELR-SIG field 620 may include a first symbol and a second symbol.

In accordance with the ELR-SIG field design 700, the first symbol may include a version number subfield of 1 bit, a STA-ID subfield of 11 bits, an ELR MCS subfield of 1 bit, a coding subfield (such as an LDPC/BCC subfield) of 1 bit, a CRC subfield of 4 bits, and a tail subfield of 6 bits. The second symbol may include a length subfield of 9 bits, a reserved bit subfield of 5 bits, a CRC subfield of 4 bits, and a tail subfield of 6 bits. Thus, in some aspects, the ELR-SIG field design 700 may be associated with examples in which the ELR-SIG field 620 excludes a BSS color subfield and includes, within the second ELR-SIG field symbol, a 1-bit version number subfield.

In accordance with the ELR-SIG field design 750, the first symbol may include a version number subfield of 1 bit, a length subfield of 9 bits, an ELR MCS subfield of 1 bit, a coding subfield of 1 bit, an uplink/downlink indication subfield of 1 bit to indicate the PPDU is an uplink or downlink PPDU, a last PPDU indication subfield of 1 bit to indicate whether the PPDU is a final PPDU in a TxOP, a CRC subfield of 4 bits, and a tail subfield of 6 bits. The second symbol may include a STA-ID subfield of 11 bits, a reserved bit subfield of 3 bits, a CRC subfield of 4 bits, and a tail subfield of 6 bits. Thus, in some aspects, the ELR-SIG field design 750 may be associated with examples in which the ELR-SIG field 620 excludes a BSS color subfield and includes, within the first ELR-SIG field symbol, a 1-bit version number subfield. In some aspects, the version number subfield may start a field change or interpretation from the first symbol of the two symbols.

In some aspects, and for the ELR-SIG field design 700 or the ELR-SIG field design 750, a resolution of the length subfield may be in units of symbol. For example, a value of “0” of the length subfield may indicate that the data portion 614 or of the ELR-data field 622 spans 1 OFDM symbol, a value of “1” of the length subfield may indicate that the data portion 614 or of the ELR-data field 622 spans 2 OFDM symbols, and so on. In such examples, an upper limit length of the data portion 614 or of the ELR-data field 622 may be 373 OFDM symbols (corresponding to a value of “372” of the length subfield) or approximately 5.5 milliseconds in duration. The coding subfield of the ELR-SIG field 620 may indicate that a coding associated with the data portion 614 or of the ELR-data field 622 is BCC (such as via a value of “0”), 1×LDPC (648, 1296, 1944) (such as via a value of “1”). The MCS subfield of the ELR-SIG field 620 may indicate that the data portion 614 or of the ELR-data field 622 is associated with BPSK with a ½ coding rate (such as via a value of “0”) or QPSK with a ½ coding rate (such as via a value of “1”). In accordance with the ELR-SIG field design 700 and the ELR-SIG field design 750, the bits of the tail subfields (in both symbols) may be set to “0” values. In some implementations, the uplink/downlink indication subfield and the last PPDU indication subfield may be optional subfields.

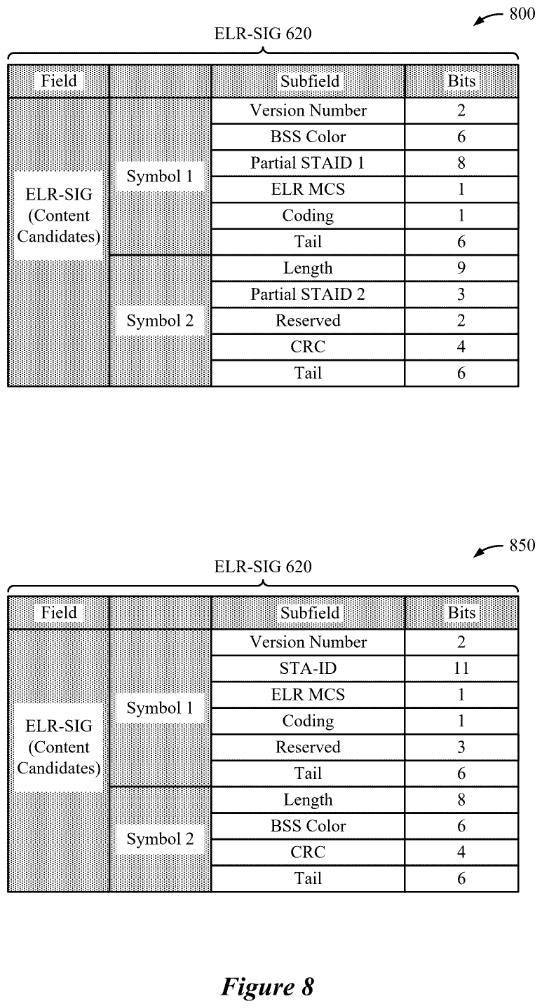

FIG. 8 shows an example of a ELR-SIG field designs 800 and 850 with separately encoded symbols that support signaling designs for ELR transmissions. In some implementations, the wireless communication device 602 and the wireless communication device 604 may leverage the ELR-SIG field design 800 or the ELR-SIG field design 850 to accommodate an early drop at an unintended receiving wireless communication device. Additionally, or alternatively, the wireless communication device 602 and the wireless communication device 604 may leverage the ELR-SIG field design 800 or the ELR-SIG field design 850 to provide an intended receiving wireless communication device with information that the intended receiving wireless communication device may use to parse or decode an ELR-data field 622, which may increase a likelihood of successful communication of the PPDU 610, which may in turn increase data rates and network capacity.

The wireless communication device 602 may format the ELR-SIG field 620 of the PPDU 610 in accordance with the ELR-SIG field design 800 or the ELR-SIG field design 850, with the ELR-SIG field design 800 and the ELR-SIG field design 850 corresponding to two symbol ELR-SIG designs. In other words, in accordance with the ELR-SIG field design 800 or the ELR-SIG field design 850, the ELR-SIG field 620 of the PPDU 610 may span or include two symbols that are separately encoded.

The wireless communication device 602 may format the ELR-SIG field 620 of the PPDU 610 in accordance with the ELR-SIG field design 800 or the ELR-SIG field design 850, with the ELR-SIG field design 800 and the ELR-SIG field design 850 corresponding to two symbol ELR-SIG designs. For example, in accordance with the ELR-SIG field design 800 or the ELR-SIG field design 850, the ELR-SIG field 620 of the PPDU 610 may span or include two separately encoded (and separately decoded) symbols. In such examples, the ELR-SIG field 620 may include a first symbol and a second symbol.

In accordance with the ELR-SIG field design 800, the first symbol may include a version number subfield of 2 bits, a BSS color subfield of 6 bits, a first partial STA-ID subfield of 8 bits, an ELR MCS subfield of 1 bit, a coding subfield (such as an LDPC/BCC subfield) of 1 bit, and a tail subfield of 6 bits. The second symbol may include a length subfield of 9 bits, second partial STA-ID subfield of 3 bits, a reserved subfield of 2 bits, a CRC subfield of 4 bits, and a tail subfield of 6 bits. Thus, in some aspects, the ELR-SIG field design 800 may be associated with examples in which the ELR-SIG field 620 includes a BSS color subfield, and has separate encoding with a joint CRC with one CRC for the first and second symbols. In some aspects, the second symbol includes the CRC bits, and both the first and second symbol have tail bits for BCC. In the example of ELR-SIG field design 800 the STA-ID is indicated partially in the first symbol and partially in the symbol. The partial STA-ID of the first symbol may include, for example, the last 8 LSB bits in STA-ID (or AID), and the partial STA-ID of the second symbol may include the first 3 MSB bits in the STA-ID (or AID).

In accordance with the ELR-SIG field design 850, the first symbol may include a version number subfield of 2 bits, a STA-ID subfield of 11 bits, an ELR MCS subfield of 1 bit, a coding subfield (such as an LDPC/BCC subfield) of 1 bit, a reserved subfield of 3 bits, and a tail subfield of 6 bits. The second symbol may include a length subfield of 8 bits, a BSS color subfield of 6 bits, a CRC subfield of 4 bits, and a tail subfield of 6 bits. Thus, in some aspects, the ELR-SIG field design 850 may be associated with examples in which the ELR-SIG field 620 includes a BSS color subfield and has separate encoding with a joint CRC, with one CRC for the first and second symbols.

In some aspects, and for the ELR-SIG field design 850, a resolution of the length subfield may be 8 bits, which may have variable resolution. In some examples, a number of OFDM data symbols may have a length value, L, where if the length of the PPDU is from 0 to 63, total number of ELR data symbols is L+1 and indicated by the 8-bit value of the length subfield. For L in the range of 64 to 255, the total number of ELR data symbols is (L-64)*2+66=2L-62 with 2-symbol as resolution and indicated by the 8-bit value of the length subfield.

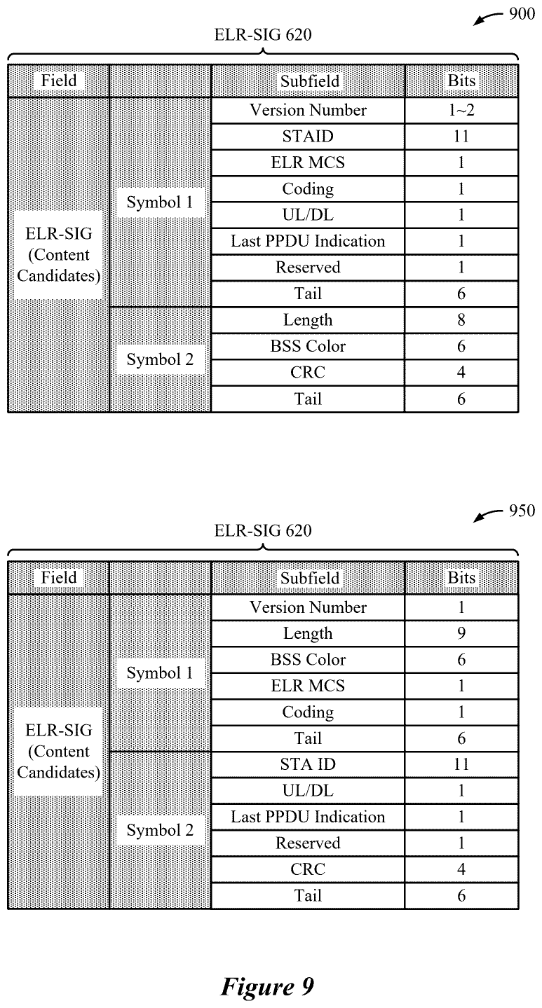

FIG. 9 shows an example of a ELR-SIG field designs 900 and 950 with separately encoded symbols that supports signaling designs for ELR transmissions. In some implementations, the wireless communication device 602 and the wireless communication device 604 may leverage the ELR-SIG field designs 900 and 950 to accommodate an early drop at an unintended receiving wireless communication device. Additionally, or alternatively, the wireless communication device 602 and the wireless communication device 604 may leverage the ELR-SIG field designs 900 and 950 to provide an intended receiving wireless communication device with information that the intended receiving wireless communication device may use to parse or decode an ELR-data field 622, which may increase a likelihood of successful communication of the PPDU 610, which may in turn increase data rates and network capacity.

The wireless communication device 602 may format the ELR-SIG field 620 of the PPDU 610 in accordance with the ELR-SIG field designs 900 and 950, with the ELR-SIG field designs 900 and 950 corresponding to a two symbol ELR-SIG designs. For example, in accordance with the ELR-SIG field designs 900 and 950, the ELR-SIG field 620 of the PPDU 610 may span or include two separately encoded (and separately decoded) symbols. In such examples, the ELR-SIG field 620 may include a first symbol and a second symbol.

In accordance with the ELR-SIG field design 900, the first symbol may include a version number subfield of 1 or 2 bits, a STA-ID subfield of 11 bits, an ELR MCS subfield of 1 bit, a coding subfield of 1 bit, an uplink/downlink indication subfield of 1 bit, a last PPDU indication subfield of 1 bit to indicate a final PPDU in a TxOP, a reserved subfield of 1 bit, and a tail subfield of 6 bits. The second symbol may include a length subfield of 8 bits, a BSS color subfield of 6 bits, a CRC subfield of 4 bits, and a tail subfield of 6 bits.

In some aspects, the ELR-SIG field design 900 may be associated with examples in which the ELR-SIG field 620 includes a single CRC subfield for the first and second symbols located within the second symbol (such that the first symbol may exclude a CRC subfield and include tail bits for BCC), with the STA-ID of the intended/addressed receiver being indicated in the first symbol. In such aspects, the ELR-SIG field 620 may be associated with separate encoding across the two symbols with a joint CRC. In other words, a device may use the CRC bits within the CRC subfield that is located within the second symbol of the ELR-SIG field 620 to encode/decode both the first symbol and the second symbol. In some aspects, and for the ELR-SIG field design 900, a resolution of the length subfield may be variable, in units of one symbol or two symbols, similarly as discussed with reference to the ELR-SIG field design 850 of FIG. 8.

In accordance with the ELR-SIG field design 950, the first symbol may include a version number subfield of 1 bit, a length subfield of 9 bits, a BSS color subfield of 6 bits, an ELR MCS subfield of 1 bit, a coding subfield of 1 bit, and a tail subfield of 6 bits. The second symbol may include a STA-ID subfield of 11 bits, an uplink/downlink indication subfield of 1 bit, a last PPDU indication subfield of 1 bit, a reserved subfield of 1 bit, a CRC subfield of 4 bits, and a tail subfield of 6 bits.

In some aspects, the ELR-SIG field design 950 may be associated with examples in which the ELR-SIG field 620 includes a single CRC subfield for the first and second symbols located within the second symbol (such that the first symbol may exclude a CRC subfield and include tail bits for BCC), with the STA-ID of the intended/addressed receiver being indicated in the second symbol. In such aspects, the ELR-SIG field 620 may be associated with separate encoding across the two symbols with a joint CRC. In other words, a device may use the CRC bits within the CRC subfield that is located within the second symbol of the ELR-SIG field 620 to encode/decode both the first symbol and the second symbol. In some aspects, and for the ELR-SIG field design 950, a resolution of the length subfield a one-symbol resolution similarly as discussed with reference to the ELR-SIG field designs 700 and 750 of FIG. 7.

FIG. 10 shows an example of a ELR-SIG field design 1000 with jointly encoded symbols that supports signaling designs for ELR transmissions. In some implementations, the wireless communication device 602 and the wireless communication device 604 may leverage the ELR-SIG field design 1000 to accommodate an early drop at an unintended receiving wireless communication device. Additionally, or alternatively, the wireless communication device 602 and the wireless communication device 604 may leverage the ELR-SIG field design 1000 to provide an intended receiving wireless communication device with information that the intended receiving wireless communication device may use to parse or decode an ELR-data field 622, which may increase a likelihood of successful communication of the PPDU 610, which may in turn increase data rates and network capacity.

The wireless communication device 602 may format the ELR-SIG field 620 of the PPDU 610 in accordance with the ELR-SIG field design 1000, with the ELR-SIG field design 1000 corresponding to two symbol ELR-SIG designs. For example, in accordance with the ELR-SIG field design 1000, the ELR-SIG field 620 of the PPDU 610 may span or include two jointly encoded (and jointly decoded) symbols.

In accordance with the ELR-SIG field design 1000, the ELR-SIG field 620 may include a version number subfield of 1 or 2 bits, a STA-ID subfield of 11 bits, a coding subfield of 1 or 2 bits, an ELR MCS subfield of 1 bit, a length subfield of 7, 8, or 9 bits, an LDPC extra symbol segment subfield of 1 bit, a pre-forward error correction (FEC) padding factor subfield of 2 bits, a BSS color subfield of 6 bits, a TxOP subfield of 7 bits, a CRC subfield of 4 bits, and a tail subfield of 6 bits. Accordingly, in such aspects, the ELR-SIG field 620 may include a BSS color subfield.

In some aspects, and for the ELR-SIG field design 1000, a resolution of the length subfield may be in accordance with the quantity of bits in the length subfield, as discussed herein for length subfields with 7, 8, or 9 bits. The coding subfield of the ELR-SIG field 620 may indicate that a coding associated with the data portion 614 or of the ELR-data field 622 is BCC (such as via a value of “0”), 1×LDPC (648, 1296, 1944) (such as via a value of “1”), or 2×LDPC (3888) (such as via a value of “2” when a 2-bit coding indication is provided). The ELR MCS subfield of the ELR-SIG field 620 may indicate that the data portion 614 or of the ELR-data field 622 is associated with BPSK with a ½ coding rate (such as via a value of “0”) or QPSK with a ½ coding rate (such as via a value of “1”). In accordance with the ELR-SIG field design 1000, the bits of the tail subfield may be set to “0” values. Pre-FEC padding factor subfield values of “0/1/2/3” may correspond or be equal to a pre-FEC padding factor of “4/1/2/3,” respectively. LDPC extra symbol segment subfield may indicate LDPC extra symbol segments (such as, for example, 0 or 1). In some implementations, some subfields may be shortened or skipped, the length field may use variable resolution, and the ELR-SIG 620 may optionally provide one or more of an uplink/downlink indication subfield (1 bit), a TxOP identification subfield (7 bits), or last PPDU indication subfield (1 bit to indicate a final PPDU in a TxOP).

### BSS Color

As discussed herein, an ELR PPDU 610 may include an ELR field (such as an ELR-mark field) including an ELR symbol 618-a and an ELR symbol 618-b. In some implementations, a ELR communications may use the BSS color=AP's BSS color, and not a color 0, and thus in such implementations ELR PPDU may not be broadcast PPDUs. In some examples, MAC pre-scanning and association mechanisms may be used without an ELR probe request, where a probe request may be sent in non-HT PPDU format and, if a response is not received, the device waits for an associated beacon.

In some implementations, if a STA serves as both a soft AP and another AP's client, the ELR-Mark sequence to use may be indicates in a special sequence ID in a beacon. For example, such a STA may have different BSS colors in MAC when it serves as a soft AP or another AP's client, but in PHY it will have a single special sequence ID for ELR PPDU in both roles. In some examples, the ELR-Mark field may indicate BSS ID information, which can be the same as BSS color, or anything else derived by BSS ID, BSS address, or specified by APs.

In some aspects, the ELR field may provide an indication of a BSS color or ID in accordance with a sequence provided in the ELR-mark field. For example, the wireless communication device 602 and the wireless communication device 604 may support and leverage a mapping between BSSs (such as BSS color or ID values) and ELR sequences. In accordance with the mapping, each BSS (such as each BSS color or ID value) may correspond to a respective ELR sequence. Accordingly, the wireless communication device 602 may select an ELR sequence that corresponds to a BSS associated with the wireless communication device 602 and may transmit the selected ELR sequence via the ELR symbol 618-a and the ELR symbol 618-b. The wireless communication device 604 may receive the ELR sequence via the ELR symbol 618-a and the ELR symbol 618-b and may perform a correlation between the received ELR sequence and an ELR sequence that corresponds to a BSS associated with the wireless communication device 604.

If the correlation satisfies a threshold correlation level, the wireless communication device 604 may measure, determine, identify, select, or ascertain that the two ELR sequences are the same and, accordingly, that a transmitter of the PPDU 610 (the wireless communication device 602) is within or associated with a same BSS as the wireless communication device 604. In such examples, the wireless communication device 604 may continue parsing at least another portion of the PPDU 610 (such as the ELR-SIG field 620). Alternatively, if the correlation fails to satisfy a threshold correlation level, the wireless communication device 604 may measure, determine, identify, select, or ascertain that the two ELR-mark sequences are different and, accordingly, that a transmitter of the PPDU 610 (the wireless communication device 602) is within or associated with a different BSS as compared to the wireless communication device 604. In such examples, the wireless communication device 604 may drop the remainder of the PPDU 610.

For example, the wireless communication device 602 may employ a sequence selection scheme to select a sequence, such as an ELR sequence, to apply across (and transmit via) the ELR symbol 618-a and the ELR symbol 618-b of the PPDU 610. In some implementations, to facilitate a mutual understanding of the sequence selection scheme, the wireless communication device 602 and the wireless communication device 604 may use a mapping between a set of BSSs (such as a set of BSS color or ID values) and a set of sequences (such as a set of ELR sequences). The wireless communication device 602 and the wireless communication device 604 may exchange (such as transmit or receive) signaling indicative of the mapping, may retrieve the mapping from one or more respective memories (such as in accordance with a standards specification or a network specification), or may receive the mapping from another network node or entity (such as a central controller).

A sequence that the wireless communication device 602 applies to the ELR symbol 618-a and the ELR symbol 618-b, which may be referred to as an ELR-mark, may identify an ELR packet. In some aspects, the wireless communication device 602 may use a sequence for the ELR symbol 618-a and the ELR symbol 618-b that is known to the wireless communication device 604 (to facilitate use of the sequence to identify the ELR packet). Additionally, in some aspects, the wireless communication device 604 may use the known sequence to boost channel estimation or time/frequency/phase tracking, among other examples. In some aspects, the set of ELR symbols across which the wireless communication device 602 transmits a sequence (such as an ELR-mark sequence) may include two signature symbols (to facilitate a target channel gain, such as an approximately +6 dB gain).

In some implementations, the sequence that the wireless communication device 602 uses for the ELR-mark may carry additional information, such as BSS information indicative of a BSS color, identifier, or address, or AP specified value, which is known at both the wireless communication device 602 and the wireless communication device 604 to accommodate an early drop of the PPDU 610. For example, an ELR AP/STA with a relatively low PD sensitivity may detect (potentially many) false alarm packets, even potentially from far away OBSS STAs. Thus, using a sequence that corresponds to a BSS color may enable receiving devices to correlate with a received ELR sequence, which may enable a receiving device to select, identify, decide, or otherwise determine whether the received packet is an ELR packet and whether the received packet is associated with a same BSS as the receiving device (both of which may enable or facilitate a receiving device to drop off and save power if the packet is an unintended packet).

In some examples, the ELR symbol 618-a and the ELR symbol 618-b (the two signature symbols) may be present within a legacy preamble portion and a tone plan of the ELR symbol 618-a and the ELR symbol 618-b may follow a one-times (1×) tone plan for 20 MHz, which may have 48 data tones and 4 pilot tones plus 4 extra tones in each symbol. In other words, the ELR symbol 618-a and the ELR symbol 618-b may each be associated with (such as include) 48 data tones and 4 pilot tones. In some aspects, the 4 pilot tones in each of the ELR symbol 618-a and the ELR symbol 618-b may be associated with pilot tone values corresponding to the preamble, may be associated with LTF values at pilot tones, or may carry additional information. In examples in which the ELR symbols include dedicated pilot tones, the ELR symbols may use same pilot locations and pilot values as in an EHT-SIG field or a UHR-SIG field and an ELR sequence may have a length of 96 to fill in 96 tones (48 data tones*2 symbols). In such examples, the dedicated pilot tones may be located at tone indices of [−21, −7, 7, 21] and may have values equal to (−1)*[1, 1, 1, −1] in each ELR symbol.

To enable an ELR sequence to carry BSS-identifying information (such as an indication of a BSS color value) via the ELR symbol 618-a and the ELR symbol 618-b, the wireless communication device 602 and the wireless communication device 604 may employ the mapping between the set of BSSs and the set of sequences. For example, in accordance with the mapping, each device having its own BSS color knows, determines, identifies, selects, or otherwise ascertains what its ELR sequence is. Accordingly, each device may use a known, determined, identified, selected, or ascertained ELR sequence for determining a sequence match in ELR detection (as part of, for example, a parsing determination).

In some implementations, the wireless communication device 602 and the wireless communication device 604 may use the mapping to map 6-bit BSS color values to 64 different sequences on the tones that are used to carry the ELR sequence. In other words, the 64 possible or available values from the 6-bit BSS color may be mapped one-on-one to 64 orthogonal sequences. In accordance with the mapping, each BSS of the set of BSSs may map to a respective sequence from the set of 64 ELR sequences. For example, a first BSS may correspond to a first sequence, a second BSS may correspond to a second sequence, a third BSS may correspond to a third sequence, and so on.

The mapping between BSS colors and sequences may take one or more of various forms. In some examples, each BSS color value may be directly mapped to a row or column sequence index of the set of sequences. In such examples, the wireless communication device 602 and the wireless communication device 604 may avoid maintaining or updating a mapping table between BSS color values and sequences, as each BSS color value directly and statically corresponds to a respective sequence of the set of sequences.

In some implementations, the set of sequences may have zero or a relatively low amount of cross-correlation between sequences corresponding different BSSs of the set of BSSs (such as between sequences corresponding to different BSS color values), which may reduce a false alarm from OBSS packets. In some examples, the wireless communication device 602 and the wireless communication device 604 may select low/zero correlation sequences or orthogonal sequences with an order of 48/96. In other words, the wireless communication device 602 and the wireless communication device 604 may select low/zero correlation sequences or orthogonal sequences with an order (such as a length) of 48 or 96 for ELR sequences. For example, the wireless communication device 602 and the wireless communication device 604 may select, generate, determine, calculate, or identify the set of sequences as columns or rows from a Hadamard matrix, as orthogonal sequences constructed in accordance with (such as using) Golay complementary sequences/pairs, or as orthogonal sequences generated by LTF sequence with different cyclic shift delays, among other examples.

The wireless communication device 602 and the wireless communication device 604 may identify, calculate, generate, select, determine, or otherwise ascertain the set of sequences in accordance with a quantity of possible BSS color values (such as a quantity of BSSs within the set of BSSs) and in accordance with a quantity of used tones within the ELR symbol 618-a and the ELR symbol 618-b. For example, a quantity of ELR sequences within the set of sequences may be associated with the quantity of possible BSS color values and a length of each ELR sequence may be associated with the quantity of used tones within the ELR symbol 618-a and the ELR symbol 618-b.

In some implementations, the wireless communication device 602 may select to transmit the first sequence via the ELR symbol 618-a and the ELR symbol 618-b in association with the wireless communication device 602 being associated with the first BSS. For example, because the wireless communication device 602 belongs to the first BSS, the wireless communication device 602 may transmit the first sequence via the ELR symbol 618-a and the ELR symbol 618-b to convey, to the wireless communication device 604, that the PPDU 610 is associated with the first BSS (via an indirectly indicated BSS color value, such as a BSS color value indicated by the first sequence via the mapping). The wireless communication device 602 may include a first portion (such as a first half, such as a first/initial set of values) of the first sequence in the ELR symbol 618-a and may include a second portion (such as a second half, such as a second/final set of values) of the first sequence in the ELR symbol 618-b.

The wireless communication device 604 may selectively parse a remainder of the PPDU 610 in accordance with a correlation level with the first sequence. For example, if the wireless communication device 604 is also associated with the first BSS, the wireless communication device 604 may perform a correlation between the sequence received via the ELR symbols and the first sequence that corresponds to the first BSS. In examples in which the received sequence is also the first sequence, the wireless communication device 604 may determine that the two sequences satisfy a threshold correlation level and the wireless communication device 604 may continue parsing the PPDU 610. Alternatively, if the wireless communication device 604 is associated with the second BSS, the wireless communication device 604 may attempt to correlate the received sequence (the first sequence) with the second sequence. In such examples, the wireless communication device 604 may determine that the two sequences fail to satisfy a threshold correlation level and the wireless communication device 604 may drop a remainder of the PPDU 610 accordingly.

In some implementations, the wireless communication device 602 and the wireless communication device 604 may apply the first sequence to a set of used tones. As described herein, used tones may be understood as tones that carry or are otherwise occupied by an ELR sequence, such as the first sequence. The used tones may include any tones that carry an ELR sequence, such as data tones, pilot tones, extra tones, or any combination thereof. In some aspects, each of the ELR symbol 618-a and the ELR symbol 618-b may include 48 data tones and 4 pilot tones.

In some implementations, the set of sequences from which the wireless communication device 602 selects the first sequence may be associated with a quantity of the used tones and a quantity of available or possible BSS color values. For example, the set of sequences may include length-96 sequences in implementations in which the used tones include data tones, and exclude pilot tones and any extra tones. The wireless communication device 602 and the wireless communication device 604 may identify, calculate, generate, select, determine, or otherwise ascertain the set of sequences in one or more of various manners, each of which is at least partially associated with the quantity of the used tones and the quantity of available or possible BSS color values.

In some implementations, the set of sequences may be used in a 64×96 ELR-mark sequence design. In some examples, Goethals-Seidel Array (GSA) based approaches may be implemented, where a H48 (48×48 matrix) is generated based on GSA using Golay 4 pair and Golay 8 pair. In some implementations, a device may select 32 out of 48 row vectors or column vectors in the H48 matrix (such as those with a lowest PAPR) and form subset of H48 as H48s, and use H48s with Hadamard extension to generate the final 64×96 matrix H, where each row is a length 96 ELR-Mark sequence. In one example, the Hadamard extension may be obtained using:

$$, H = [ \begin{matrix}H 4 {8}_{s} & H 4 {8}_{s} \\ H 4 {8}_{s} & - H 4 {8}_{s}\end{matrix} ] .$$

In another example, the Hadamard extension may be obtained using:

$$, H = [ \begin{matrix}H {48}_{s} & H {48}_{s} ( : , 48 : - 1 : 1 ) \\ H {48}_{s} & - H {48}_{s} ( : , 48 : - 1 : 1 )\end{matrix} ] or$$

$$H = [ \begin{matrix}H 4 {8}_{s} ( : , 48 : - 1 : 1 ) & H {48}_{s} \\ H {48}_{s} ( : , 48 : - 1 : 1 ) & - H {48}_{s}\end{matrix} ] ,$$

that is, having bit reverse on the first symbol or second symbol. In another example, a device may first use H48 (48×48) to form H96 (96×96) through Hadamard extension, then select 64 out of 96 row vectors or column vectors in H96 matrix (such as those with a lowest PAPR), to form the final 64×96 matrix as:

, H=[selected 64 rows in H96] or H=[selected 64 columns in H96] T. In some examples, the Hadamard extension may be obtained using:

$$, H 96 = [ \begin{matrix}H 48 & H 48 \\ H 48 & - H 48\end{matrix} ] .$$

In other examples, the Hadamard extension may be obtained using:

$$, H 96 = [ \begin{matrix}H 48 & H 48 ( : , 48 : - 1 : 1 ) \\ H 48 & - H 48 ( : , 48 : - 1 : 1 )\end{matrix} ] or$$

$$, H 96 = [ \begin{matrix}H 48 ( : , 48 : - 1 : 1 ) & H 48 \\ H 48 ( : , 48 : - 1 : 1 ) & - H 48\end{matrix} ] ,$$

that is, having bit reverse on the first symbol or second symbol.

In some implementations, Paley Construction (PC) based approaches may be used, where initial H48 (48×48 matrix) is generated based on PC, and further cyclic shift applied on the columns of H48 can help reduce PAPR while keeping the orthogonality of the rows. After H48 is generated, it can go through similar enhancement options as GSA based approaches as discussed above.

In some implementations, a length 96 ELR-Mark sequence is applied to each tone in 96 tones=48 data tones*2 symbols, with optimized sequences as rows of a 64×96 matrix. In each row, first 48 elements are applied to the 48 data tones in the first ELR-Mark symbol and the second 48 elements are used to fill in the 48 tones in the second symbol. Note that each ELR-Mark symbol also has 4 pilots with same pilot locations and pilot values as in EHT-SIG. Tables 1 and 2 show examples of sequences based on PC, where Table 1 shows sequences based on PC with Hadamard extension using

$$H = [ \begin{matrix}H {48}_{s} & H {48}_{s} ( : , 48 : - 1 : 1 ) \\ {H48}_{s} & - {H48}_{s} ( : , 48 : - 1 : 1 )\end{matrix} ] or$$

$$H 96 = [ \begin{matrix}H {48}_{s} ( : , 48 : - 1 : 1 ) & H {48}_{s} \\ H 48 ( : , 48 : - 1 : 1 ) & - H {48}_{s}\end{matrix} ] ,$$

having bit reverse on the 1^{st} symbol or 2^{nd} symbol. Table 2 shows sequences based on PC with Hadamard extension using

$$H 96 = [ \begin{matrix}H 48 & H 48 ( : , 48 : - 1 : 1 ) \\ H 48 & - H 48 ( : , 48 : - 1 : 1 )\end{matrix} ] or$$

$$H 96 = [ \begin{matrix}H 48 ( : , 48 : - 1 : 1 ) & H 48 \\ H 48 ( : , 48 : - 1 : 1 ) & - H 48\end{matrix} ] ,$$

having bit reverse on the 1^{st} symbol or 2^{nd} symbol.

TABLE 1
ELR-mark Sequences of Length 64 based on PC with Hadamard extension

| Index | ELR Sequence |
|---|---|
| 1 | −1, 1, −1, −1, −1, −1, 1, 1, −1, 1, −1, 1, −1, −1, −1, 1, 1, −1, 1, 1, −1, −1, 1, −1, −1, 1, 1, 1, −1, 1, −1, 1, −1, −1, |
| | 1, 1, 1, 1, −1, 1, 1, 1, 1, 1, −1, −1, −1, −1, −1, −1, −1, −1, 1, 1, 1, 1, 1, −1, 1, 1, 1, 1, −1, −1, 1, −1, 1, −1, 1, 1, 1, −1, −1, |
| | 1, −1, −1, 1, 1, −1, 1, 1, −1, −1, −1, 1, −1, 1, −1, 1, 1, −1, −1, −1, −1, 1, −1 |
| 2 | 1, −1, −1, −1, −1, 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, 1, −1, −1, −1, −1, −1, −1, −1, −1, −1, −1, 1, 1, 1, 1, 1, −1, 1, 1, 1, 1, −1, −1, 1, −1, 1, −1, 1, 1, 1, −1, −1, |
| | 1, −1, −1, 1, 1, −1, 1, 1, −1, −1, −1, 1, −1, 1, −1, 1, 1, −1, −1, −1, −1, 1 |
| 3 | −1, −1, −1, −1, 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, 1, −1, −1, −1, −1, 1, −1, −1, 1, −1, −1, −1, −1, 1, 1, 1, 1, 1, −1, 1, 1, 1, 1, −1, −1, 1, −1, 1, −1, 1, 1, 1, −1, −1, |
| | 1, −1, −1, 1, 1, −1, 1, 1, −1, −1, −1, 1, −1, 1, −1, 1, 1, −1, −1, −1, −1 |
| 4 | −1, −1, −1, 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, 1, −1, −1, −1, −1, 1, −1, −1, −1, −1, 1, −1, −1, −1, −1, 1, 1, 1, 1, 1, −1, 1, 1, 1, 1, −1, −1, 1, −1, 1, −1, |
| | 1, 1, 1, −1, −1, 1, −1, −1, 1, 1, −1, 1, 1, −1, −1, −1, 1, −1, 1, −1, 1, 1, −1, −1, −1 |
| 5 | −1, 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, 1, −1, −1, −1, −1, 1, −1, −1, −1, −1, −1, −1, −1, −1, 1, −1, −1, −1, −1, 1, 1, 1, 1, 1, −1, 1, 1, 1, 1, −1, −1, 1, −1, |
| | 1, −1, 1, 1, 1, −1, −1, 1, −1, −1, 1, 1, −1, 1, 1, −1, −1, −1, 1, −1, 1, −1, 1, 1, −1 |
| 6 | 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, |
| | 1, −1, −1, −1, −1, 1, −1, −1, −1, −1, −1, −1, −1, −1, −1, −1, 1, −1, −1, −1, −1, 1, 1, 1, 1, 1, −1, 1, 1, 1, 1, −1, −1, 1, −1, |
| | 1, −1, 1, 1, 1, −1, −1, 1, −1, −1, 1, 1, −1, 1, 1, −1, −1, −1, 1, −1, 1, −1, 1, 1 |
| 7 | 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, |
| | 1, −1, −1, −1, −1, 1, −1, −1, −1, −1, 1, −1, −1, 1, −1, −1, −1, −1, 1, −1, −1, −1, −1, 1, 1, 1, 1, 1, −1, 1, 1, 1, 1, −1, −1, 1, −1, |
| | 1, −1, 1, 1, 1, −1, −1, 1, −1, −1, 1, 1, −1, 1, 1, −1, −1, −1, 1, −1, 1, −1, 1 |
| 8 | 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, −1, −1, −1, 1, 1, −1, −1, −1, −1, 1, −1, −1, −1, −1, 1, 1, 1, 1, 1, −1, 1, 1, 1, 1, −1, −1, |
| | 1, −1, 1, −1, 1, 1, 1, −1, −1, 1, −1, −1, 1, 1, −1, 1, 1, −1, −1, −1, 1, −1, 1 |
| 9 | −1, 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, −1, 1, −1, 1, 1, −1, −1, −1, −1, 1, −1, −1, −1, −1, 1, 1, 1, 1, 1, −1, 1, 1, 1, 1, −1, −1, |
| | 1, −1, 1, −1, 1, 1, 1, −1, −1, 1, −1, −1, 1, 1, −1, 1, 1, −1, −1, −1, 1, −1 |
| 10 | 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, −1, −1, −1, 1, −1, 1, 1, −1, −1, −1, −1, 1, −1, −1, −1, −1, 1, 1, 1, 1, 1, −1, 1, 1, 1, 1, −1, −1, |
| | 1, −1, 1, −1, 1, 1, 1, −1, −1, 1, −1, −1, 1, 1, −1, 1, 1, −1, −1, −1, 1 |
| 11 | −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, 1, −1, −1, −1, −1, 1, −1, 1, −1, 1, 1, −1, −1, −1, −1, 1, −1, −1, −1, −1, 1, 1, 1, 1, |
| | 1, −1, 1, 1, 1, 1, −1, −1, 1, −1, 1, −1, 1, 1, 1, −1, −1, 1, −1, −1, 1, 1, −1, 1, 1, −1, −1 |
| 12 | −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, −1, −1, −1, −1, −1, 1, −1, 1, −1, 1, 1, −1, −1, −1, −1, 1, −1, −1, −1, −1, 1, 1, 1, 1, |
| | 1, −1, 1, 1, 1, 1, −1, −1, 1, −1, 1, −1, 1, 1, 1, −1, −1, 1, −1, −1, 1, 1, −1, 1, 1, −1 |
| 13 | 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, |
| | 1, 1, −1, 1, −1, 1, −1, −1, −1, −1, −1, −1, −1, −1, 1, −1, 1, −1, 1, 1, −1, −1, −1, −1, 1, −1, −1, −1, −1, 1, 1, 1, 1, |
| | 1, −1, 1, 1, 1, 1, −1, −1, 1, −1, 1, −1, 1, 1, 1, −1, −1, 1, −1, −1, 1, 1, −1, 1, 1 |
| 14 | −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, |
| | 1, 1, −1, 1, −1, 1, −1, −1, −1, 1, 1, −1, −1, 1, 1, −1, −1, −1, 1, −1, 1, −1, 1, 1, −1, −1, −1, −1, 1, −1, −1, −1, −1, |
| | 1, 1, 1, 1, 1, −1, 1, 1, 1, 1, −1, −1, 1, −1, 1, 1, 1, −1, −1, 1, −1, −1, 1, 1, −1 |
| 15 | 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, |
| | 1, −1, 1, −1, −1, −1, 1, 1, −1, −1, −1, −1, 1, 1, −1, −1, −1, 1, −1, 1, −1, 1, 1, −1, −1, −1, −1, 1, −1, −1, −1, −1, |
| | 1, 1, 1, 1, 1, −1, 1, 1, 1, 1, −1, −1, 1, −1, 1, −1, 1, 1, 1, −1, −1, 1, −1, −1, 1, 1 |
| 16 | −1, −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, |
| | 1, −1, −1, −1, 1, 1, −1, 1, 1, −1, −1, 1, 1, −1, 1, 1, −1, −1, −1, 1, −1, 1, −1, 1, 1, −1, −1, −1, −1, 1, −1, −1, −1, −1, |
| | 1, 1, 1, 1, 1, −1, 1, 1, 1, 1, −1, −1, 1, −1, 1, −1, 1, 1, 1, −1, −1, 1, −1, −1 |
| 17 | −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, |
| | 1, −1, −1, −1, 1, 1, 1, −1, 1, 1, −1, −1, −1, −1, 1, 1, −1, 1, 1, −1, −1, −1, 1, −1, 1, −1, 1, 1, −1, −1, −1, −1, 1, −1, −1, −1, −1, |
| | 1, 1, 1, 1, 1, −1, 1, 1, 1, 1, −1, −1, 1, −1, 1, −1, 1, 1, 1, −1, −1, 1, −1 |
| 18 | 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, |
| | 1, −1, −1, −1, 1, 1, −1, 1, 1, −1, −1, −1, −1, −1, −1, 1, 1, −1, 1, 1, −1, −1, −1, 1, −1, 1, −1, 1, 1, −1, −1, −1, −1, 1, −1, −1, −1, −1, |
| | 1, 1, 1, 1, 1, −1, 1, 1, 1, 1, −1, −1, 1, −1, 1, −1, 1, 1, 1, −1, −1, 1 |
| 19 | −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, |
| | 1, 1, −1, 1, 1, −1, −1, 1, −1, −1, 1, −1, −1, 1, 1, −1, 1, 1, −1, −1, −1, 1, −1, 1, −1, 1, 1, −1, −1, −1, −1, 1, −1, −1, −1, −1, |
| | 1, 1, 1, 1, 1, −1, 1, 1, 1, 1, −1, −1, 1, −1, 1, −1, 1, 1, 1, −1, −1 |
| 20 | −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, |
| | 1, 1, −1, 1, 1, −1, −1, 1, −1, −1, −1, −1, 1, −1, −1, 1, 1, −1, 1, 1, −1, −1, −1, 1, −1, 1, −1, 1, 1, −1, −1, −1, −1, |
| | 1, −1, −1, −1, −1, 1, 1, 1, 1, 1, −1, 1, 1, 1, 1, −1, −1, 1, −1, 1, −1, 1, 1, 1, −1 |
| 21 | 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, |
| | 1, 1, −1, 1, 1, −1, −1, 1, −1, −1, −1, −1, −1, −1, 1, −1, −1, 1, 1, −1, 1, 1, −1, −1, −1, 1, −1, 1, −1, 1, 1, −1, −1, −1, −1, |
| | 1, −1, −1, −1, −1, 1, 1, 1, 1, 1, −1, 1, 1, 1, 1, −1, −1, 1, −1, 1, −1, 1, 1, 1 |
| 22 | 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, |
| | 1, 1, −1, 1, 1, −1, −1, 1, −1, −1, 1, −1, −1, 1, −1, −1, 1, −1, −1, 1, 1, −1, 1, 1, −1, −1, −1, 1, −1, 1, −1, 1, 1, −1, −1, −1, −1, |
| | 1, −1, −1, −1, −1, 1, 1, 1, 1, 1, −1, 1, 1, 1, 1, −1, −1, 1, −1, 1, −1, 1, 1 |
| 23 | 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, |
| | 1, 1, −1, −1, 1, −1, −1, 1, 1, −1, −1, 1, 1, −1, −1, 1, −1, −1, 1, 1, −1, 1, 1, −1, −1, −1, 1, −1, 1, −1, 1, 1, −1, −1, −1, −1, |
| | 1, −1, −1, −1, −1, 1, 1, 1, 1, 1, −1, 1, 1, 1, 1, −1, −1, 1, −1, 1, −1, 1 |
| 24 | −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, |
| | 1, 1, −1, −1, 1, −1, −1, 1, 1, 1, −1, −1, 1, 1, 1, −1, −1, 1, −1, −1, 1, 1, −1, 1, 1, −1, −1, −1, 1, −1, 1, −1, 1, 1, −1, −1, −1, −1, |
| | 1, −1, −1, −1, −1, 1, 1, 1, 1, 1, −1, 1, 1, 1, 1, −1, −1, 1, −1, 1, −1 |
| 25 | 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, |
| | 1, 1, −1, −1, 1, −1, −1, 1, 1, 1, −1, −1, −1, −1, 1, 1, 1, −1, −1, 1, −1, −1, 1, 1, −1, 1, 1, −1, −1, −1, 1, −1, 1, −1, 1, |
| | 1, −1, −1, −1, −1, 1, −1, −1, −1, −1, 1, 1, 1, 1, 1, −1, 1, 1, 1, 1, −1, −1, 1, −1, 1 |
| 26 | −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, |
| | 1, −1, −1, 1, −1, −1, 1, 1, 1, −1, 1, −1, −1, 1, −1, 1, 1, 1, −1, −1, 1, −1, −1, 1, 1, −1, 1, 1, −1, −1, −1, 1, −1, 1, −1, 1, |
| | 1, −1, −1, −1, −1, 1, −1, −1, −1, −1, 1, 1, 1, 1, 1, −1, 1, 1, 1, 1, −1, −1, 1, −1 |
| 27 | −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, |
| | 1, −1, −1, 1, 1, 1, −1, 1, −1, 1, −1, −1, 1, −1, 1, −1, 1, 1, 1, −1, −1, 1, −1, −1, 1, 1, −1, 1, 1, −1, −1, −1, 1, −1, 1, −1, |
| | 1, 1, −1, −1, −1, −1, 1, −1, −1, −1, −1, 1, 1, 1, 1, 1, −1, 1, 1, 1, 1, −1, −1 |
| 28 | −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, |
| | 1, −1, −1, 1, 1, 1, −1, 1, −1, 1, −1, −1, −1, −1, 1, −1, 1, −1, 1, 1, 1, −1, −1, 1, −1, −1, 1, 1, −1, 1, 1, −1, −1, −1, 1, −1, 1, −1, |
| | 1, 1, −1, −1, −1, −1, 1, −1, −1, −1, −1, 1, 1, 1, 1, 1, −1, 1, 1, 1, 1, −1 |
| 29 | 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, 1, −1, −1, |
| | 1, 1, 1, −1, 1, −1, 1, −1, −1, −1, −1, −1, −1, 1, −1, 1, −1, 1, 1, 1, −1, −1, 1, −1, −1, 1, 1, −1, 1, 1, −1, −1, −1, 1, −1, 1, −1, |
| | 1, 1, −1, −1, −1, −1, 1, −1, −1, −1, −1, 1, 1, 1, 1, 1, −1, 1, 1, 1, 1 |
| 30 | 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, 1, −1, −1, |
| | 1, 1, 1, −1, 1, −1, 1, −1, −1, 1, −1, −1, 1, −1, −1, 1, −1, 1, −1, 1, 1, 1, −1, −1, 1, −1, −1, 1, 1, −1, 1, 1, −1, −1, −1, 1, −1, |
| | 1, −1, 1, 1, −1, −1, −1, −1, 1, −1, −1, −1, −1, 1, 1, 1, 1, 1, −1, 1, 1, 1 |
| 31 | 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, 1, −1, −1, |
| | 1, 1, 1, −1, 1, −1, 1, −1, −1, 1, 1, 1, −1, −1, 1, 1, 1, −1, −1, 1, −1, 1, −1, 1, 1, 1, −1, −1, 1, −1, −1, 1, 1, −1, 1, |
| | 1, −1, −1, −1, 1, −1, 1, −1, 1, 1, −1, −1, −1, −1, 1, −1, −1, −1, −1, 1, 1, 1, 1, 1, −1, 1 |
| 32 | 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, 1, −1, −1, 1, 1, 1, −1, |
| | 1, −1, 1, −1, −1, 1, 1, 1, 1, −1, −1, −1, −1, 1, 1, 1, 1, −1, −1, 1, −1, 1, −1, 1, 1, 1, −1, −1, 1, −1, −1, 1, 1, −1, 1, |
| | 1, −1, −1, −1, 1, −1, 1, −1, 1, 1, −1, −1, −1, −1, 1, −1, −1, −1, −1, 1, 1, 1, 1, 1 |
| 33 | −1, 1, −1, −1, −1, −1, 1, 1, −1, 1, −1, 1, −1, −1, −1, 1, 1, −1, 1, 1, −1, −1, 1, −1, −1, 1, 1, 1, −1, 1, −1, 1, −1, −1, |
| | 1, 1, 1, 1, −1, 1, 1, 1, 1, 1, −1, −1, −1, −1, 1, 1, 1, 1, −1, −1, −1, −1, −1, 1, −1, −1, −1, −1, 1, 1, −1, 1, −1, 1, −1, −1, −1, |
| | 1, 1, −1, 1, 1, −1, −1, 1, −1, −1, 1, 1, 1, −1, 1, −1, 1, −1, −1, 1, 1, 1, 1, −1, 1 |
| 34 | 1, −1, −1, −1, −1, 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, 1, −1, −1, −1, −1, −1, 1, 1, 1, 1, 1, −1, −1, −1, −1, −1, 1, −1, −1, −1, −1, 1, 1, −1, 1, −1, 1, −1, −1, −1, 1, 1, −1, |
| | 1, 1, −1, −1, 1, −1, −1, 1, 1, 1, −1, 1, −1, 1, −1, −1, 1, 1, 1, 1, −1 |
| 35 | −1, −1, −1, −1, 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, 1, −1, −1, −1, −1, 1, −1, 1, −1, 1, 1, 1, 1, −1, −1, −1, −1, −1, 1, −1, −1, −1, −1, 1, 1, −1, 1, −1, 1, −1, −1, −1, |
| | 1, 1, −1, 1, 1, −1, −1, 1, −1, −1, 1, 1, 1, −1, 1, −1, 1, −1, −1, 1, 1, 1, 1 |
| 36 | −1, −1, −1, 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, 1, −1, −1, −1, −1, 1, −1, −1, 1, 1, −1, 1, 1, 1, 1, −1, −1, −1, −1, −1, 1, −1, −1, −1, −1, 1, 1, −1, 1, −1, |
| | 1, −1, −1, −1, 1, 1, −1, 1, 1, −1, −1, 1, −1, −1, 1, 1, 1, −1, 1, −1, 1, −1, −1, 1, 1, 1 |
| 37 | −1, 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, 1, −1, −1, −1, −1, 1, −1, −1, −1, −1, 1, 1, 1, 1, −1, 1, 1, 1, 1, −1, −1, −1, −1, −1, 1, −1, −1, −1, −1, 1, 1, −1, |
| | 1, −1, 1, −1, −1, −1, 1, 1, −1, 1, 1, −1, −1, 1, −1, −1, 1, 1, 1, −1, 1, −1, 1, −1, −1, 1 |
| 38 | 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, |
| | 1, −1, −1, −1, −1, 1, −1, −1, −1, −1, −1, 1, 1, 1, 1, 1, −1, 1, 1, 1, 1, −1, −1, −1, −1, −1, 1, −1, −1, −1, −1, 1, 1, −1, 1, −1, |
| | 1, −1, −1, −1, 1, 1, −1, 1, 1, −1, −1, 1, −1, −1, 1, 1, 1, −1, 1, −1, 1, −1, −1 |
| 39 | 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, |
| | 1, −1, −1, −1, −1, 1, −1, −1, −1, −1, 1, −1, 1, 1, 1, 1, −1, 1, 1, 1, 1, −1, −1, −1, −1, −1, 1, −1, −1, −1, −1, 1, 1, −1, 1, −1, |
| | 1, −1, −1, −1, 1, 1, −1, 1, 1, −1, −1, 1, −1, −1, 1, 1, 1, −1, 1, −1, 1, −1 |
| 40 | 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, −1, 1, 1, −1, −1, 1, 1, 1, 1, −1, 1, 1, 1, 1, −1, −1, −1, −1, −1, 1, −1, −1, −1, −1, 1, 1, −1, 1, −1, |
| | 1, −1, −1, −1, 1, 1, −1, 1, 1, −1, −1, 1, −1, −1, 1, 1, 1, −1, 1, −1 |
| 41 | −1, 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, 1, −1, 1, −1, −1, 1, 1, 1, 1, −1, 1, 1, 1, 1, −1, −1, −1, −1, −1, 1, −1, −1, −1, −1, 1, 1, −1, |
| | 1, −1, 1, −1, −1, −1, 1, 1, −1, 1, 1, −1, −1, 1, −1, −1, 1, 1, 1, −1, 1 |
| 42 | 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, −1, 1, 1, −1, 1, −1, −1, 1, 1, 1, 1, −1, 1, 1, 1, 1, −1, −1, −1, −1, −1, 1, −1, −1, −1, −1, 1, 1, −1, |
| | 1, 1, −1, 1, −1, −1, −1, 1, 1, −1, 1, 1, −1, −1, 1, −1, −1, 1, 1, 1, −1 |
| 43 | −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, 1, −1, −1, 1, 1, −1, 1, −1, 1, −1, −1, 1, 1, 1, 1, −1, 1, 1, 1, 1, −1, −1, −1, −1, −1, 1, −1, −1, −1, −1, |
| | 1, 1, −1, 1, −1, 1, −1, −1, −1, 1, 1, −1, 1, 1, −1, −1, 1, −1, −1, 1, 1 |
| 44 | −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, |
| | 1, 1, −1, 1, −1, 1, −1, −1, −1, 1, 1, 1, −1, 1, −1, 1, −1, −1, 1, 1, 1, 1, −1, 1, 1, 1, 1, −1, −1, −1, −1, −1, 1, −1, −1, −1, −1, |
| | 1, 1, −1, 1, −1, 1, −1, −1, −1, 1, 1, −1, 1, 1, −1, −1, 1, −1, −1, 1 |
| 45 | 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, |
| | 1, 1, −1, 1, −1, 1, −1, −1, −1, −1, 1, 1, 1, 1, −1, 1, −1, 1, −1, −1, 1, 1, 1, 1, −1, 1, 1, 1, 1, −1, −1, −1, −1, −1, |
| | 1, −1, −1, −1, −1, 1, 1, −1, 1, −1, 1, −1, −1, −1, 1, 1, −1, 1, 1, −1, −1, 1, −1, −1 |
| 46 | −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, |
| | 1, 1, −1, 1, −1, 1, −1, −1, −1, 1, 1, −1, 1, −1, −1, 1, 1, 1, −1, 1, −1, 1, −1, −1, 1, 1, 1, 1, −1, 1, 1, 1, 1, −1, −1, −1, −1, −1, |
| | 1, −1, −1, −1, −1, 1, 1, −1, 1, −1, 1, −1, −1, −1, 1, 1, −1, 1, 1, −1, −1, 1 |
| 47 | 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, |
| | 1, −1, 1, −1, −1, −1, 1, 1, −1, −1, 1, 1, −1, −1, 1, 1, 1, −1, 1, −1, 1, −1, −1, 1, 1, 1, 1, −1, 1, 1, 1, 1, −1, −1, −1, −1, −1, |
| | 1, −1, −1, −1, −1, 1, 1, −1, 1, −1, 1, −1, −1, −1, 1, 1, −1, 1, 1, −1, −1 |
| 48 | −1, −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, |
| | 1, −1, −1, −1, 1, 1, −1, 1, 1, −1, 1, −1, −1, 1, −1, −1, 1, 1, 1, −1, 1, −1, 1, −1, −1, 1, 1, 1, 1, −1, 1, 1, 1, 1, −1, −1, −1, −1, −1, |
| | 1, −1, −1, −1, −1, 1, 1, −1, 1, −1, 1, −1, −1, −1, 1, 1, −1, 1, 1 |
| 49 | −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, |
| | 1, −1, −1, −1, 1, 1, −1, 1, 1, −1, −1, 1, 1, −1, −1, 1, −1, −1, 1, 1, 1, −1, 1, −1, 1, −1, −1, 1, 1, 1, 1, −1, 1, 1, 1, |
| | 1, −1, −1, −1, −1, −1, 1, −1, −1, −1, −1, 1, 1, −1, 1, −1, 1, −1, −1, −1, 1, 1, −1, 1 |
| 50 | 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, |
| | 1, −1, −1, −1, 1, 1, −1, 1, 1, −1, −1, −1, 1, 1, 1, −1, −1, 1, −1, −1, 1, 1, 1, −1, 1, −1, 1, −1, −1, 1, 1, 1, 1, −1, 1, 1, 1, |
| | 1, −1, −1, −1, −1, −1, 1, −1, −1, −1, −1, 1, 1, −1, 1, −1, 1, −1, −1, −1, 1, 1, −1 |
| 51 | −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, |
| | 1, −1, −1, −1, 1, 1, −1, 1, 1, −1, −1, 1, −1, 1, −1, 1, 1, −1, −1, 1, −1, −1, 1, 1, 1, −1, 1, −1, 1, −1, −1, 1, 1, 1, 1, −1, 1, 1, 1, |
| | 1, −1, −1, −1, −1, −1, 1, −1, −1, −1, −1, 1, 1, −1, 1, −1, 1, −1, −1, −1, 1, 1 |
| 52 | −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, |
| | 1, 1, −1, 1, 1, −1, −1, 1, −1, −1, 1, 1, −1, 1, 1, −1, −1, 1, −1, −1, 1, 1, 1, −1, 1, −1, 1, −1, −1, 1, 1, 1, 1, −1, 1, 1, 1, |
| | 1, −1, −1, −1, −1, −1, 1, −1, −1, −1, −1, 1, 1, −1, 1, −1, 1, −1, −1, −1, 1 |
| 53 | 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, |
| | 1, 1, −1, 1, 1, −1, −1, 1, −1, −1, −1, 1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, −1, −1, −1, −1, −1, 1, −1, −1, −1, −1, 1, 1, −1, 1, −1, 1, −1, −1, −1 |
| 54 | 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, |
| | 1, 1, −1, 1, 1, −1, −1, 1, −1, −1, 1, −1, 1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, −1, −1, −1, −1, −1, 1, −1, −1, −1, −1, 1, 1, −1, 1, −1, 1, −1, −1 |
| 55 | 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, |
| | 1, 1, −1, −1, 1, −1, −1, 1, 1, −1, 1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, −1, −1, −1, −1, −1, 1, −1, −1, −1, −1, 1, 1, −1, 1, −1, 1, −1 |
| 56 | −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, |
| | 1, 1, −1, −1, 1, −1, −1, 1, 1, 1, −1, 1, −1, −1, −1, 1, 1, 1, −1, 1, 1, −1, −1, 1, −1, −1, 1, 1, 1, −1, 1, −1, 1, −1, −1, |
| | 1, 1, 1, 1, −1, 1, 1, 1, 1, −1, −1, −1, −1, −1, 1, −1, −1, −1, −1, 1, 1, −1, 1, −1, 1 |
| 57 | 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, |
| | 1, 1, −1, −1, 1, −1, −1, 1, 1, 1, −1, −1, 1, 1, −1, −1, −1, 1, 1, −1, 1, 1, −1, −1, 1, −1, −1, 1, 1, 1, −1, 1, −1, 1, −1, −1, |
| | 1, 1, 1, 1, −1, 1, 1, 1, 1, −1, −1, −1, −1, −1, 1, −1, −1, −1, −1, 1, 1, −1, 1, −1 |
| 58 | −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, |
| | 1, −1, −1, 1, −1, −1, 1, 1, 1, −1, 1, −1, 1, −1, 1, −1, −1, −1, 1, 1, −1, 1, 1, −1, −1, 1, −1, −1, 1, 1, 1, −1, 1, −1, 1, −1, −1, |
| | 1, 1, 1, 1, −1, 1, 1, 1, 1, −1, −1, −1, −1, −1, 1, −1, −1, −1, −1, 1, 1, −1, 1 |
| 59 | −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, |
| | 1, −1, −1, 1, 1, 1, −1, 1, −1, 1, −1, 1, −1, 1, −1, 1, −1, −1, −1, 1, 1, −1, 1, 1, −1, −1, 1, −1, −1, 1, 1, 1, −1, 1, −1, |
| | 1, −1, −1, 1, 1, 1, 1, −1, 1, 1, 1, 1, −1, −1, −1, −1, −1, 1, −1, −1, −1, −1, 1, 1 |
| 60 | −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, |
| | 1, −1, −1, 1, 1, 1, −1, 1, −1, 1, −1, −1, 1, 1, 1, −1, 1, −1, 1, −1, −1, −1, 1, 1, −1, 1, 1, −1, −1, 1, −1, −1, 1, 1, 1, −1, 1, −1, |
| | 1, −1, −1, 1, 1, 1, 1, −1, 1, 1, 1, 1, −1, −1, −1, −1, −1, 1, −1, −1, −1, −1, 1 |
| 61 | 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, 1, −1, −1, |
| | 1, 1, 1, −1, 1, −1, 1, −1, −1, −1, 1, 1, 1, −1, 1, −1, 1, −1, −1, −1, 1, 1, −1, 1, 1, −1, −1, 1, −1, −1, 1, 1, 1, −1, 1, −1, |
| | 1, −1, −1, 1, 1, 1, 1, −1, 1, 1, 1, 1, −1, −1, −1, −1, −1, 1, −1, −1, −1, −1 |
| 62 | 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, 1, −1, −1, |
| | 1, 1, 1, −1, 1, −1, 1, −1, −1, 1, −1, 1, −1, 1, 1, −1, 1, −1, 1, −1, −1, −1, 1, 1, −1, 1, 1, −1, −1, 1, −1, −1, 1, 1, 1, −1, 1, −1, |
| | 1, −1, −1, 1, 1, 1, 1, −1, 1, 1, 1, 1, −1, −1, −1, −1, −1, 1, −1, −1, −1 |
| 63 | 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, 1, −1, −1, |
| | 1, 1, 1, −1, 1, −1, 1, −1, −1, 1, 1, 1, −1, 1, −1, −1, −1, 1, 1, −1, 1, −1, 1, −1, −1, −1, 1, 1, −1, 1, 1, −1, −1, 1, −1, −1, |
| | 1, 1, 1, −1, 1, −1, 1, −1, −1, 1, 1, 1, 1, −1, 1, 1, 1, 1, −1, −1, −1, −1, −1, 1, −1 |
| 64 | 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, 1, −1, −1, 1, 1, 1, −1, |
| | 1, −1, 1, −1, −1, 1, 1, 1, 1, −1, −1, 1, 1, −1, −1, −1, −1, 1, 1, −1, 1, −1, 1, −1, −1, −1, 1, 1, −1, 1, 1, −1, −1, 1, −1, −1, |
| | 1, 1, 1, −1, 1, −1, 1, −1, −1, 1, 1, 1, 1, −1, 1, 1, 1, 1, −1, −1, −1, −1, −1 |

TABLE 2
ELR-mark Sequences of Length 64 based on PC with Hadamard extension

| Index | ELR Sequence |
|---|---|
| 1 | 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, 1, −1, −1, 1, 1, 1, −1, |
| | 1, −1, 1, −1, −1, 1, 1, 1, 1, −1, −1, −1, −1, 1, 1, 1, 1, −1, −1, 1, −1, 1, −1, 1, 1, 1, −1, −1, 1, −1, −1, 1, 1, −1, 1, |
| | 1, −1, −1, −1, 1, −1, 1, −1, 1, 1, −1, −1, −1, −1, 1, −1, −1, −1, −1, 1, 1, 1, 1, 1 |
| 2 | 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, 1, −1, −1, |
| | 1, 1, 1, −1, 1, −1, 1, −1, −1, 1, 1, 1, −1, −1, 1, 1, 1, −1, −1, 1, −1, 1, −1, 1, 1, 1, −1, −1, 1, −1, −1, 1, 1, −1, 1, |
| | 1, −1, −1, −1, 1, −1, 1, −1, 1, 1, −1, −1, −1, −1, 1, −1, −1, −1, −1, 1, 1, 1, 1, 1, −1, 1 |
| 3 | 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, 1, −1, −1, |
| | 1, 1, 1, −1, 1, −1, 1, −1, −1, 1, −1, −1, 1, −1, −1, 1, −1, 1, −1, 1, 1, 1, −1, −1, 1, −1, −1, 1, 1, −1, 1, 1, −1, −1, −1, 1, −1, |
| | 1, −1, 1, 1, −1, −1, −1, −1, 1, −1, −1, −1, −1, 1, 1, 1, 1, 1, −1, 1, 1, 1 |
| 4 | 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, 1, −1, −1, |
| | 1, 1, 1, −1, 1, −1, 1, −1, −1, −1, −1, −1, −1, 1, −1, 1, −1, 1, 1, 1, −1, −1, 1, −1, −1, 1, 1, −1, 1, 1, −1, −1, −1, 1, −1, 1, −1, |
| | 1, 1, −1, −1, −1, −1, 1, −1, −1, −1, −1, 1, 1, 1, 1, 1, −1, 1, 1, 1, 1 |
| 5 | −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, |
| | 1, −1, −1, 1, 1, 1, −1, 1, −1, 1, −1, −1, −1, −1, 1, −1, 1, −1, 1, 1, 1, −1, −1, 1, −1, −1, 1, 1, −1, 1, 1, −1, −1, −1, 1, −1, |
| | 1, −1, 1, 1, −1, −1, −1, −1, 1, −1, −1, −1, −1, 1, 1, 1, 1, 1, −1, 1, 1, 1, 1, −1 |
| 6 | −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, |
| | 1, −1, −1, 1, 1, 1, −1, 1, −1, 1, −1, −1, 1, −1, 1, −1, 1, 1, 1, −1, −1, 1, −1, −1, 1, 1, −1, 1, 1, −1, −1, −1, 1, −1, 1, −1, |
| | 1, 1, −1, −1, −1, −1, 1, −1, −1, −1, −1, 1, 1, 1, 1, 1, −1, 1, 1, 1, 1, −1, −1 |
| 7 | −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, |
| | 1, −1, −1, 1, −1, −1, 1, 1, 1, −1, 1, −1, −1, 1, −1, 1, 1, 1, −1, −1, 1, −1, −1, 1, 1, −1, 1, 1, −1, −1, −1, 1, −1, 1, −1, 1, |
| | 1, −1, −1, −1, −1, 1, −1, −1, −1, −1, 1, 1, 1, 1, 1, −1, 1, 1, 1, 1, −1, −1, 1, −1 |
| 8 | 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, |
| | 1, 1, −1, −1, 1, −1, −1, 1, 1, 1, −1, −1, −1, −1, 1, 1, 1, −1, −1, 1, −1, −1, 1, 1, −1, 1, 1, −1, −1, −1, 1, −1, 1, −1, 1, |
| | 1, −1, −1, −1, −1, 1, −1, −1, −1, −1, 1, 1, 1, 1, 1, −1, 1, 1, 1, 1, −1, −1, 1, −1, 1 |
| 9 | −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, |
| | 1, 1, −1, −1, 1, −1, −1, 1, 1, 1, −1, −1, 1, 1, 1, −1, −1, 1, −1, −1, 1, 1, −1, 1, 1, −1, −1, −1, 1, −1, 1, −1, 1, |
| | 1, −1, −1, −1, −1, 1, −1, −1, −1, −1, 1, 1, 1, 1, 1, −1, 1, 1, 1, 1, −1, −1, 1, −1, 1, −1 |
| 10 | 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, |
| | 1, 1, −1, −1, 1, −1, −1, 1, 1, −1, −1, 1, 1, −1, −1, 1, −1, −1, 1, 1, −1, 1, 1, −1, −1, −1, 1, −1, 1, −1, 1, 1, −1, −1, −1, −1, |
| | 1, −1, −1, −1, −1, 1, 1, 1, 1, 1, −1, 1, 1, 1, 1, −1, −1, 1, −1, 1, −1, 1 |
| 11 | 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, |
| | 1, 1, −1, 1, 1, −1, −1, 1, −1, −1, 1, −1, −1, 1, −1, −1, 1, −1, −1, 1, 1, −1, 1, 1, −1, −1, −1, 1, −1, 1, −1, 1, 1, −1, −1, −1, −1, |
| | 1, −1, −1, −1, −1, 1, 1, 1, 1, 1, −1, 1, 1, 1, 1, −1, −1, 1, −1, 1, −1, 1, 1 |
| 12 | 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, |
| | 1, 1, −1, 1, 1, −1, −1, 1, −1, −1, −1, −1, −1, −1, 1, −1, −1, 1, 1, −1, 1, 1, −1, −1, −1, 1, −1, 1, −1, 1, 1, −1, −1, −1, −1, |
| | 1, −1, −1, −1, −1, 1, 1, 1, 1, 1, −1, 1, 1, 1, 1, −1, −1, 1, −1, 1, −1, 1, 1, 1 |
| 13 | −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, |
| | 1, 1, −1, 1, 1, −1, −1, 1, −1, −1, −1, −1, 1, −1, −1, 1, 1, −1, 1, 1, −1, −1, −1, 1, −1, 1, −1, 1, 1, −1, −1, −1, −1, |
| | 1, −1, −1, −1, −1, 1, 1, 1, 1, 1, −1, 1, 1, 1, 1, −1, −1, 1, −1, 1, −1, 1, 1, 1, −1 |
| 14 | −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, |
| | 1, −1, −1, −1, 1, 1, −1, 1, 1, −1, −1, 1, −1, −1, 1, −1, −1, 1, 1, −1, 1, 1, −1, −1, −1, 1, −1, 1, −1, 1, 1, −1, −1, −1, −1, |
| | 1, −1, −1, −1, −1, 1, 1, 1, 1, 1, −1, 1, 1, 1, 1, −1, −1, 1, −1, 1, −1, 1, 1, 1, −1, −1 |
| 15 | 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, |
| | 1, −1, −1, −1, 1, 1, −1, 1, 1, −1, −1, −1, −1, −1, −1, 1, 1, −1, 1, 1, −1, −1, −1, 1, −1, 1, −1, 1, 1, −1, −1, −1, −1, 1, −1, −1, −1, −1, |
| | 1, 1, 1, 1, 1, −1, 1, 1, 1, 1, −1, −1, 1, −1, 1, −1, 1, 1, 1, −1, −1, 1 |
| 16 | −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, |
| | 1, 1, −1, 1, −1, 1, −1, −1, −1, 1, 1, −1, −1, 1, 1, −1, −1, −1, 1, −1, 1, −1, 1, 1, −1, −1, −1, −1, 1, −1, −1, −1, −1, |
| | 1, 1, 1, 1, 1, −1, 1, 1, 1, 1, −1, −1, 1, −1, 1, −1, 1, 1, 1, −1, −1, 1, −1, −1, 1, 1, −1 |
| 17 | 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, |
| | 1, 1, −1, 1, −1, 1, −1, −1, −1, −1, −1, −1, −1, −1, 1, −1, 1, −1, 1, 1, −1, −1, −1, −1, 1, −1, −1, −1, −1, 1, 1, 1, 1, 1, −1, |
| | 1, 1, 1, 1, −1, −1, 1, −1, 1, −1, 1, 1, 1, −1, −1, 1, −1, −1, 1, 1, −1, 1, 1 |
| 18 | −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, |
| | 1, 1, −1, 1, −1, 1, −1, −1, −1, −1, −1, −1, 1, −1, 1, −1, 1, 1, −1, −1, −1, −1, 1, −1, −1, −1, −1, 1, 1, 1, 1, 1, −1, |
| | 1, 1, 1, 1, −1, −1, 1, −1, 1, −1, 1, 1, 1, −1, −1, 1, −1, −1, 1, 1, −1, 1, 1, −1 |
| 19 | −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, 1, −1, −1, −1, −1, 1, −1, 1, −1, 1, 1, −1, −1, −1, −1, 1, −1, −1, −1, −1, 1, 1, 1, 1, |
| | 1, −1, 1, 1, 1, 1, −1, −1, 1, −1, 1, −1, 1, 1, 1, −1, −1, 1, −1, −1, 1, 1, −1, 1, 1, −1, −1 |
| 20 | 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, −1, −1, −1, 1, −1, 1, 1, −1, −1, −1, −1, 1, −1, −1, −1, −1, 1, 1, 1, 1, 1, −1, 1, 1, 1, 1, −1, −1, |
| | 1, −1, 1, −1, 1, 1, 1, −1, −1, 1, −1, −1, 1, 1, −1, 1, 1, −1, −1, −1, 1 |
| 21 | −1, 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, −1, 1, −1, 1, 1, −1, −1, −1, −1, 1, −1, −1, −1, −1, 1, 1, 1, 1, 1, −1, 1, 1, 1, 1, −1, −1, |
| | 1, −1, 1, −1, 1, 1, 1, −1, −1, 1, −1, −1, 1, 1, −1, 1, 1, −1, −1, −1, 1, −1 |
| 22 | 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, −1, 1, 1, 1, 1, 1, −1, −1, −1, −1, |
| | 1, −1, −1, −1, −1, 1, 1, −1, −1, −1, −1, 1, 1, −1, −1, −1, −1, 1, −1, −1, −1, −1, 1, 1, 1, 1, 1, −1, 1, 1, 1, 1, −1, −1, 1, −1, |
| | 1, −1, 1, 1, 1, −1, −1, 1, −1, −1, 1, 1, −1, 1, 1, −1, −1, −1, 1, −1, 1 |
| 23 | 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, |
| | 1, −1, −1, −1, −1, 1, −1, −1, −1, −1, 1, −1, −1, 1, −1, −1, −1, −1, 1, −1, −1, −1, −1, 1, 1, 1, 1, 1, −1, 1, 1, 1, 1, −1, −1, 1, −1, |
| | 1, −1, 1, 1, 1, −1, −1, 1, −1, −1, 1, 1, −1, 1, 1, −1, −1, −1, 1, −1, 1, −1, 1 |
| 24 | 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, |
| | 1, −1, −1, −1, −1, 1, −1, −1, −1, −1, −1, −1, −1, −1, −1, −1, 1, −1, −1, −1, −1, 1, 1, 1, 1, 1, −1, 1, 1, 1, 1, −1, −1, 1, −1, |
| | 1, −1, 1, 1, 1, −1, −1, 1, −1, −1, 1, 1, −1, 1, 1, −1, −1, −1, 1, −1, 1, −1, 1, 1 |
| 25 | −1, 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, 1, −1, −1, −1, −1, 1, −1, −1, −1, −1, −1, −1, −1, −1, 1, −1, −1, −1, −1, 1, 1, 1, 1, 1, −1, 1, 1, 1, 1, −1, −1, 1, −1, |
| | 1, −1, 1, 1, 1, −1, −1, 1, −1, −1, 1, 1, −1, 1, 1, −1, −1, −1, 1, −1, 1, −1, 1, 1, −1 |
| 26 | −1, −1, 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, 1, −1, −1, −1, −1, 1, −1, −1, −1, −1, −1, −1, 1, −1, −1, −1, −1, 1, 1, 1, 1, 1, −1, 1, 1, 1, 1, −1, −1, 1, −1, |
| | 1, −1, 1, 1, 1, −1, −1, 1, −1, −1, 1, 1, −1, 1, 1, −1, −1, −1, 1, −1, 1, −1, 1, 1, −1, −1 |
| 27 | −1, −1, −1, 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, 1, −1, −1, −1, −1, 1, −1, −1, −1, −1, 1, −1, −1, −1, −1, 1, 1, 1, 1, 1, −1, 1, 1, 1, 1, −1, −1, 1, −1, 1, −1, |
| | 1, 1, 1, −1, −1, 1, −1, −1, 1, 1, −1, 1, 1, −1, −1, −1, 1, −1, 1, −1, 1, 1, −1, −1, −1 |
| 28 | −1, −1, −1, −1, 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, 1, −1, −1, −1, −1, 1, −1, −1, 1, −1, −1, −1, −1, 1, 1, 1, 1, 1, −1, 1, 1, 1, 1, −1, −1, 1, −1, 1, −1, 1, 1, 1, −1, −1, |
| | 1, −1, −1, 1, 1, −1, 1, 1, −1, −1, −1, 1, −1, 1, −1, 1, 1, −1, −1, −1, −1 |
| 29 | −1, 1, −1, −1, −1, −1, 1, 1, −1, 1, −1, 1, −1, −1, −1, 1, 1, −1, 1, 1, −1, −1, 1, −1, −1, 1, 1, 1, −1, 1, −1, 1, −1, −1, |
| | 1, 1, 1, 1, −1, 1, 1, 1, 1, 1, −1, −1, −1, −1, −1, −1, −1, −1, 1, 1, 1, 1, 1, −1, 1, 1, 1, 1, −1, −1, 1, −1, 1, −1, 1, 1, 1, −1, −1, |
| | 1, −1, −1, 1, 1, −1, 1, 1, −1, −1, −1, 1, −1, 1, −1, 1, 1, −1, −1, −1, −1, 1, −1 |
| 30 | 1, 1, −1, −1, −1, −1, 1, −1, −1, −1, −1, 1, 1, −1, 1, −1, 1, −1, −1, −1, 1, 1, −1, 1, 1, −1, −1, 1, −1, −1, 1, 1, 1, −1, 1, −1, |
| | 1, −1, −1, 1, 1, 1, 1, −1, 1, 1, 1, −1, 1, −1, −1, −1, 1, −1, −1, −1, −1, 1, 1, −1, 1, −1, 1, −1, −1, −1, 1, 1, −1, 1, 1, −1, −1, |
| | 1, −1, −1, 1, 1, 1, −1, 1, −1, 1, −1, −1, 1, 1, 1, 1, −1, 1, 1, 1, 1, −1, −1 |
| 31 | 1, 1, 1, −1, −1, −1, −1, 1, −1, −1, −1, −1, 1, 1, −1, 1, −1, 1, −1, −1, −1, 1, 1, −1, 1, 1, −1, −1, 1, −1, −1, 1, 1, 1, −1, 1, −1, |
| | 1, −1, −1, 1, 1, 1, 1, −1, 1, 1, −1, 1, −1, −1, 1, −1, −1, −1, −1, 1, 1, −1, 1, −1, 1, −1, −1, −1, 1, 1, −1, 1, 1, −1, −1, |
| | 1, −1, −1, −1, 1, 1, 1, −1, 1, −1, 1, −1, −1, 1, 1, 1, 1, −1, 1, 1, 1, 1, −1, −1, −1 |
| 32 | 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, 1, −1, −1, 1, 1, 1, −1, |
| | 1, −1, 1, −1, −1, 1, 1, 1, 1, −1, −1, 1, 1, −1, −1, −1, −1, 1, 1, −1, 1, −1, 1, −1, −1, −1, 1, 1, −1, 1, 1, −1, −1, 1, −1, −1, |
| | 1, 1, 1, −1, 1, −1, 1, −1, −1, 1, 1, 1, 1, −1, 1, 1, 1, 1, −1, −1, −1, −1, −1 |
| 33 | 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, 1, −1, −1, |
| | 1, 1, 1, −1, 1, −1, 1, −1, −1, 1, 1, 1, −1, 1, −1, −1, −1, 1, 1, −1, 1, −1, 1, −1, −1, −1, 1, 1, −1, 1, 1, −1, −1, 1, −1, −1, |
| | 1, 1, 1, −1, 1, −1, 1, −1, −1, 1, 1, 1, 1, −1, 1, 1, 1, 1, −1, −1, −1, −1, −1, 1, −1 |
| 34 | 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, 1, −1, −1, |
| | 1, 1, 1, −1, 1, −1, 1, −1, −1, 1, −1, 1, −1, 1, 1, −1, 1, −1, 1, −1, −1, −1, 1, 1, −1, 1, 1, −1, −1, 1, −1, −1, 1, 1, 1, −1, 1, −1, |
| | 1, −1, −1, 1, 1, 1, 1, −1, 1, 1, 1, 1, −1, −1, −1, −1, −1, 1, −1, −1, −1 |
| 35 | 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, 1, −1, −1, |
| | 1, 1, 1, −1, 1, −1, 1, −1, −1, −1, 1, 1, 1, −1, 1, −1, 1, −1, −1, −1, 1, 1, −1, 1, 1, −1, −1, 1, −1, −1, 1, 1, 1, −1, 1, −1, |
| | 1, −1, −1, 1, 1, 1, 1, −1, 1, 1, 1, 1, −1, −1, −1, −1, −1, 1, −1, −1, −1, −1 |
| 36 | −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, |
| | 1, −1, −1, 1, 1, 1, −1, 1, −1, 1, −1, −1, 1, 1, −1, 1, −1, 1, −1, −1, −1, 1, 1, −1, 1, 1, −1, −1, 1, −1, −1, 1, 1, 1, −1, 1, −1, |
| | 1, −1, −1, 1, 1, 1, 1, −1, 1, 1, 1, 1, −1, −1, −1, −1, −1, 1, −1, −1, −1, −1, 1 |
| 37 | −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, |
| | 1, −1, −1, 1, 1, 1, −1, 1, −1, 1, −1, 1, −1, 1, −1, 1, −1, −1, −1, 1, 1, −1, 1, 1, −1, −1, 1, −1, −1, 1, 1, 1, −1, 1, −1, |
| | 1, −1, −1, 1, 1, 1, 1, −1, 1, 1, 1, 1, −1, −1, −1, −1, −1, 1, −1, −1, −1, −1, 1, 1 |
| 38 | −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, |
| | 1, −1, −1, 1, −1, −1, 1, 1, 1, −1, 1, −1, 1, −1, 1, −1, −1, −1, 1, 1, −1, 1, 1, −1, −1, 1, −1, −1, 1, 1, 1, −1, 1, −1, 1, −1, −1, |
| | 1, 1, 1, 1, −1, 1, 1, 1, 1, −1, −1, −1, −1, −1, 1, −1, −1, −1, −1, 1, 1, −1, 1 |
| 39 | 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, |
| | 1, 1, −1, −1, 1, −1, −1, 1, 1, 1, −1, −1, 1, 1, −1, −1, −1, 1, 1, −1, 1, 1, −1, −1, 1, −1, −1, 1, 1, 1, −1, 1, −1, 1, −1, −1, |
| | 1, 1, 1, 1, −1, 1, 1, 1, 1, −1, −1, −1, −1, −1, 1, −1, −1, −1, −1, 1, 1, −1, 1, −1 |
| 40 | −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, |
| | 1, 1, −1, −1, 1, −1, −1, 1, 1, 1, −1, 1, −1, −1, −1, 1, 1, −1, 1, 1, −1, −1, 1, −1, −1, 1, 1, 1, −1, 1, −1, 1, −1, −1, |
| | 1, 1, 1, 1, −1, 1, 1, 1, 1, −1, −1, −1, −1, −1, 1, −1, −1, −1, −1, 1, 1, −1, 1, −1, 1 |
| 41 | 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, |
| | 1, 1, −1, −1, 1, −1, −1, 1, 1, −1, 1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, −1, −1, −1, −1, −1, 1, −1, −1, −1, −1, 1, 1, −1, 1, −1, 1, −1 |
| 42 | 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, |
| | 1, 1, −1, 1, 1, −1, −1, 1, −1, −1, 1, −1, 1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, −1, −1, −1, −1, −1, 1, −1, −1, −1, −1, 1, 1, −1, 1, −1, 1, −1, −1 |
| 43 | 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, |
| | 1, 1, −1, 1, 1, −1, −1, 1, −1, −1, −1, 1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, −1, −1, −1, −1, −1, 1, −1, −1, −1, −1, 1, 1, −1, 1, −1, 1, −1, −1, −1 |
| 44 | −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, |
| | 1, 1, −1, 1, 1, −1, −1, 1, −1, −1, 1, 1, −1, 1, 1, −1, −1, 1, −1, −1, 1, 1, 1, −1, 1, −1, 1, −1, −1, 1, 1, 1, 1, −1, 1, 1, 1, |
| | 1, −1, −1, −1, −1, −1, 1, −1, −1, −1, −1, 1, 1, −1, 1, −1, 1, −1, −1, −1, 1 |
| 45 | −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, |
| | 1, −1, −1, −1, 1, 1, −1, 1, 1, −1, −1, 1, −1, 1, −1, 1, 1, −1, −1, 1, −1, −1, 1, 1, 1, −1, 1, −1, 1, −1, −1, 1, 1, 1, 1, −1, 1, 1, 1, |
| | 1, −1, −1, −1, −1, −1, 1, −1, −1, −1, −1, 1, 1, −1, 1, −1, 1, −1, −1, −1, 1, 1 |
| 46 | 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, |
| | 1, −1, −1, −1, 1, 1, −1, 1, 1, −1, −1, −1, 1, 1, 1, −1, −1, 1, −1, −1, 1, 1, 1, −1, 1, −1, 1, −1, −1, 1, 1, 1, 1, −1, 1, 1, 1, |
| | 1, −1, −1, −1, −1, −1, 1, −1, −1, −1, −1, 1, 1, −1, 1, −1, 1, −1, −1, −1, 1, 1, −1 |
| 47 | −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, |
| | 1, −1, −1, −1, 1, 1, −1, 1, 1, −1, −1, 1, 1, −1, −1, 1, −1, −1, 1, 1, 1, −1, 1, −1, 1, −1, −1, 1, 1, 1, 1, −1, 1, 1, 1, |
| | 1, −1, −1, −1, −1, −1, 1, −1, −1, −1, −1, 1, 1, −1, 1, −1, 1, −1, −1, −1, 1, 1, −1, 1 |
| 48 | −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, |
| | 1, 1, −1, 1, −1, 1, −1, −1, −1, 1, 1, −1, 1, −1, −1, 1, 1, 1, −1, 1, −1, 1, −1, −1, 1, 1, 1, 1, −1, 1, 1, 1, 1, −1, −1, −1, −1, −1, |
| | 1, −1, −1, −1, −1, 1, 1, −1, 1, −1, 1, −1, −1, −1, 1, 1, −1, 1, 1, −1, −1, 1 |
| 49 | 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, |
| | 1, 1, −1, 1, −1, 1, −1, −1, −1, 1, −1, 1, −1, 1, 1, 1, −1, 1, −1, 1, −1, −1, 1, 1, 1, 1, −1, 1, 1, 1, 1, −1, −1, −1, −1, −1, |
| | 1, −1, −1, −1, −1, 1, 1, −1, 1, −1, 1, −1, −1, −1, 1, 1, −1, 1, 1, −1, −1, 1, −1 |
| 50 | 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, |
| | 1, 1, −1, 1, −1, 1, −1, −1, −1, −1, 1, 1, 1, 1, −1, 1, −1, 1, −1, −1, 1, 1, 1, 1, −1, 1, 1, 1, 1, −1, −1, −1, −1, −1, |
| | 1, −1, −1, −1, −1, 1, 1, −1, 1, −1, 1, −1, −1, −1, 1, 1, −1, 1, 1, −1, −1, 1, −1, −1 |
| 51 | −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, |
| | 1, 1, −1, 1, −1, 1, −1, −1, −1, 1, 1, 1, −1, 1, −1, 1, −1, −1, 1, 1, 1, 1, −1, 1, 1, 1, 1, −1, −1, −1, −1, −1, 1, −1, −1, −1, −1, |
| | 1, 1, −1, 1, −1, 1, −1, −1, −1, 1, 1, −1, 1, 1, −1, −1, 1, −1, −1, 1 |
| 52 | −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, 1, −1, −1, 1, 1, −1, 1, −1, 1, −1, −1, 1, 1, 1, 1, −1, 1, 1, 1, 1, −1, −1, −1, −1, −1, 1, −1, −1, −1, −1, |
| | 1, 1, −1, 1, −1, 1, −1, −1, −1, 1, 1, −1, 1, 1, −1, −1, 1, −1, −1, 1, 1 |
| 53 | −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, 1, −1, 1, −1, 1, −1, 1, −1, −1, 1, 1, 1, 1, −1, 1, 1, 1, 1, −1, −1, −1, −1, −1, 1, −1, −1, −1, −1, |
| | 1, 1, −1, 1, −1, 1, −1, −1, −1, 1, 1, −1, 1, 1, −1, −1, 1, −1, −1, 1, 1, 1 |
| 54 | 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, −1, 1, 1, −1, 1, −1, −1, 1, 1, 1, 1, −1, 1, 1, 1, 1, −1, −1, −1, −1, −1, 1, −1, −1, −1, −1, 1, |
| | 1, −1, 1, −1, 1, −1, −1, −1, 1, 1, −1, 1, 1, −1, −1, 1, −1, −1, 1, 1, 1, −1 |
| 55 | −1, 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, 1, −1, 1, −1, −1, 1, 1, 1, 1, −1, 1, 1, 1, 1, −1, −1, −1, −1, −1, 1, −1, −1, −1, −1, 1, |
| | 1, −1, 1, −1, 1, −1, −1, −1, 1, 1, −1, 1, 1, −1, −1, 1, −1, −1, 1, 1, 1, −1, 1 |
| 56 | 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, −1, 1, 1, −1, −1, 1, 1, 1, 1, −1, 1, 1, 1, 1, −1, −1, −1, −1, −1, 1, −1, −1, −1, −1, 1, 1, −1, 1, −1, |
| | 1, −1, −1, −1, 1, 1, −1, 1, 1, −1, −1, 1, −1, −1, 1, 1, 1, −1, 1, −1 |
| 57 | 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, |
| | 1, −1, −1, −1, −1, 1, −1, −1, −1, −1, 1, −1, 1, −1, 1, 1, 1, 1, −1, 1, 1, 1, 1, −1, −1, −1, −1, −1, 1, −1, −1, −1, −1, 1, 1, −1, 1, −1, |
| | 1, −1, −1, −1, 1, 1, −1, 1, 1, −1, −1, 1, −1, −1, 1, 1, 1, −1, 1, −1, 1, 1 |
| 58 | 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, |
| | 1, −1, −1, −1, −1, 1, −1, −1, −1, −1, −1, 1, 1, 1, 1, 1, −1, 1, 1, 1, 1, −1, −1, −1, −1, −1, 1, −1, −1, −1, −1, 1, 1, −1, 1, −1, |
| | 1, −1, −1, −1, 1, 1, −1, 1, 1, −1, −1, 1, −1, −1, 1, 1, 1, −1, 1, −1, 1, −1, −1 |
| 59 | −1, 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, 1, −1, −1, −1, −1, 1, −1, −1, −1, −1, 1, 1, 1, 1, −1, 1, 1, 1, 1, −1, −1, −1, −1, −1, 1, −1, −1, −1, −1, 1, |
| | 1, −1, 1, −1, 1, −1, −1, −1, 1, 1, −1, 1, 1, −1, −1, 1, −1, −1, 1, 1, 1, −1, 1, −1, 1, −1, −1, 1 |
| 60 | −1, −1, −1, 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, 1, −1, −1, −1, −1, 1, −1, −1, 1, 1, −1, 1, 1, 1, 1, −1, −1, −1, −1, −1, 1, −1, −1, −1, −1, 1, 1, −1, 1, −1, |
| | 1, −1, −1, −1, 1, 1, −1, 1, 1, −1, −1, 1, −1, −1, 1, 1, 1, −1, 1, −1, 1, −1, −1, 1, 1, 1 |
| 61 | −1, −1, −1, −1, 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, 1, −1, −1, −1, −1, 1, −1, 1, −1, 1, 1, 1, 1, −1, −1, −1, −1, −1, 1, −1, −1, −1, −1, 1, 1, −1, 1, −1, 1, −1, −1, −1, |
| | 1, 1, −1, 1, 1, −1, −1, 1, −1, −1, 1, 1, 1, −1, 1, −1, 1, −1, −1, 1, 1, 1, 1 |
| 62 | −1, 1, −1, −1, −1, −1, 1, 1, −1, 1, −1, 1, −1, −1, −1, 1, 1, −1, 1, 1, −1, −1, 1, −1, −1, 1, 1, 1, −1, 1, −1, 1, −1, −1, |
| | 1, 1, 1, 1, −1, 1, 1, 1, 1, 1, −1, −1, −1, −1, 1, 1, 1, 1, −1, −1, −1, −1, −1, 1, −1, −1, −1, −1, 1, 1, −1, 1, −1, 1, −1, −1, −1, |
| | 1, 1, −1, 1, 1, −1, −1, 1, −1, −1, 1, 1, 1, −1, 1, −1, 1, −1, −1, 1, 1, 1, 1, −1, 1 |
| 63 | −1, −1, −1, 1, −1, −1, −1, −1, 1, 1, −1, 1, −1, 1, −1, −1, −1, 1, 1, −1, 1, 1, −1, −1, 1, −1, −1, 1, 1, 1, −1, 1, −1, 1, −1, −1, |
| | 1, 1, 1, 1, −1, 1, 1, 1, 1, 1, −1, −1, 1, 1, −1, −1, −1, −1, −1, 1, −1, −1, −1, −1, 1, 1, −1, 1, −1, 1, −1, −1, −1, 1, 1, −1, |
| | 1, 1, −1, −1, 1, −1, −1, 1, 1, 1, −1, 1, −1, 1, −1, −1, 1, 1, 1, 1, −1, 1, 1, 1 |
| 64 | −1, −1, −1, −1, 1, −1, −1, −1, −1, 1, 1, −1, 1, −1, 1, −1, −1, −1, 1, 1, −1, 1, 1, −1, −1, 1, −1, −1, 1, 1, 1, −1, 1, −1, 1, −1, −1, |
| | 1, 1, 1, 1, −1, 1, 1, 1, 1, 1, −1, 1, −1, −1, −1, −1, −1, 1, −1, −1, −1, −1, 1, 1, −1, 1, −1, 1, −1, −1, −1, 1, 1, −1, 1, |
| | 1, −1, −1, 1, −1, −1, 1, 1, 1, −1, 1, −1, 1, −1, −1, 1, 1, 1, 1, −1, 1, 1, 1, 1 |

In some further implementations, ELR-mask sequence enhancements may be provided for QBPSK Modulated ELR-Mark Sequences. In some examples, QBPSK+QBPSK modulation may be provided for the two symbols ELR-Mark1 and ELR-Mark2 to reduce false alarm likelihood, where QBPSK=BPSK+90 degree rotation. In such examples, QBPSK rotation may change PAPR of each ELR-Mark symbol, and this additional rotation may change the selected sequence set when selecting the sequence is based on lowest PAPR. In some examples, the optimized sequences based on based on PC with Hadamard extension with QBPSK modulation are rows of the matrix shown in Table 3. In some examples, the PAPRs of ELR-mark symbols when using the optimized sequences with QBPSK modulation and transmitted with dedicated pilots are 5.25˜6.4552 dB. In further examples, the optimized sequences based on PC and with H48 (48×48) to form H96 (96×96) through Hadamard extension, then select 64 out of 96 row vectors or column vectors in H96 matrix (such as with lowest PAPR), to form the final 64×96 matrix, with QBPSK modulation, are rows of the matrix shown in Table 4. In some examples, the PAPRs of ELR-mark symbols when using the optimized sequences with QBPSK modulation and transmitted with dedicated pilots are 4.92˜6.2025 dB.

TABLE 3
ELR-mark Sequences of Length 64 sequences based on PC with Hadamard extension with QBPSK modulation

| Index | ELR Sequence |
|---|---|
| 1 | −1, −1, −1, −1, 1, −1, −1, −1, −1, 1, 1, −1, 1, −1, 1, −1, −1, −1, 1, 1, −1, 1, 1, −1, −1, 1, −1, −1, 1, 1, 1, −1, 1, −1, 1, −1, −1, |
| | 1, 1, 1, 1, −1, 1, 1, 1, 1, 1, −1, −1, 1, 1, 1, 1, 1, −1, 1, 1, 1, 1, −1, −1, 1, −1, 1, −1, 1, 1, 1, −1, −1, 1, −1, −1, 1, 1, −1, |
| | 1, 1, −1, −1, −1, 1, −1, 1, −1, 1, 1, −1, −1, −1, −1, 1, −1, −1, −1, −1 |
| 2 | 1, −1, −1, −1, −1, 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, 1, −1, −1, −1, −1, −1, −1, −1, −1, −1, −1, 1, 1, 1, 1, 1, −1, 1, 1, 1, 1, −1, −1, 1, −1, 1, −1, 1, 1, 1, −1, −1, |
| | 1, −1, −1, 1, 1, −1, 1, 1, −1, −1, −1, 1, −1, 1, −1, 1, 1, −1, −1, −1, −1, 1 |
| 3 | −1, −1, −1, −1, 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, 1, −1, −1, −1, −1, 1, −1, −1, 1, −1, −1, −1, −1, 1, 1, 1, 1, 1, −1, 1, 1, 1, 1, −1, −1, 1, −1, 1, −1, 1, 1, 1, −1, −1, |
| | 1, −1, −1, 1, 1, −1, 1, 1, −1, −1, −1, 1, −1, 1, −1, 1, 1, −1, −1, −1, −1 |
| 4 | −1, −1, −1, 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, 1, −1, −1, −1, −1, 1, −1, −1, −1, −1, 1, −1, −1, −1, −1, 1, 1, 1, 1, 1, −1, 1, 1, 1, 1, −1, −1, 1, −1, 1, −1, |
| | 1, 1, 1, −1, −1, 1, −1, −1, 1, 1, −1, 1, 1, −1, −1, −1, 1, −1, 1, −1, 1, 1, −1, −1, −1 |
| 5 | −1, −1, 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, 1, −1, −1, −1, −1, 1, −1, −1, −1, −1, −1, −1, 1, −1, −1, −1, −1, 1, 1, 1, 1, 1, −1, 1, 1, 1, 1, −1, −1, 1, −1, 1, −1, |
| | 1, 1, 1, −1, −1, 1, −1, −1, 1, 1, −1, 1, 1, −1, −1, −1, 1, −1, 1, −1, 1, 1, −1, −1 |
| 6 | −1, 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, 1, −1, −1, −1, −1, 1, −1, −1, −1, −1, −1, −1, −1, −1, 1, −1, −1, −1, −1, 1, 1, 1, 1, 1, −1, 1, 1, 1, 1, −1, −1, 1, −1, |
| | 1, −1, 1, 1, 1, −1, −1, 1, −1, −1, 1, 1, −1, 1, 1, −1, −1, −1, 1, −1, 1, −1, 1, 1, −1 |
| 7 | 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, |
| | 1, −1, −1, −1, −1, 1, −1, −1, −1, −1, −1, −1, −1, −1, −1, −1, 1, −1, −1, −1, −1, 1, 1, 1, 1, 1, −1, 1, 1, 1, 1, −1, −1, 1, −1, 1, −1, |
| | 1, 1, 1, −1, −1, 1, −1, −1, 1, 1, −1, 1, 1, −1, −1, −1, 1, −1, 1, −1, 1, 1 |
| 8 | 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, |
| | 1, −1, −1, −1, −1, 1, −1, −1, −1, −1, 1, −1, −1, 1, −1, −1, −1, −1, 1, −1, −1, −1, −1, 1, 1, 1, 1, 1, −1, 1, 1, 1, 1, −1, −1, 1, −1, |
| | 1, −1, 1, 1, 1, −1, −1, 1, −1, −1, 1, 1, −1, 1, 1, −1, −1, −1, 1, −1, 1, −1, 1 |
| 9 | 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, −1, −1, −1, 1, 1, −1, −1, −1, −1, 1, −1, −1, −1, −1, 1, 1, 1, 1, 1, −1, 1, 1, 1, 1, −1, −1, 1, −1, |
| | 1, −1, 1, 1, 1, −1, −1, 1, −1, −1, 1, 1, −1, 1, 1, −1, −1, −1, 1, −1, 1 |
| 10 | −1, 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, −1, 1, −1, 1, 1, −1, −1, −1, −1, 1, −1, −1, −1, −1, 1, 1, 1, 1, 1, −1, 1, 1, 1, 1, −1, −1, |
| | 1, −1, 1, −1, 1, 1, 1, −1, −1, 1, −1, −1, 1, 1, −1, 1, 1, −1, −1, −1, 1, −1 |
| 11 | 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, −1, −1, −1, 1, −1, 1, 1, −1, −1, −1, −1, 1, −1, −1, −1, −1, 1, 1, 1, 1, 1, −1, 1, 1, 1, 1, −1, −1, |
| | 1, −1, 1, −1, 1, 1, 1, −1, −1, 1, −1, −1, 1, 1, −1, 1, 1, −1, −1, −1, 1 |
| 12 | −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, 1, −1, −1, 1, −1, 1, −1, 1, 1, −1, −1, −1, −1, 1, −1, −1, −1, −1, 1, 1, 1, 1, 1, −1, 1, 1, 1, |
| | 1, −1, −1, 1, −1, 1, −1, 1, 1, 1, −1, −1, 1, −1, −1, 1, 1, −1, 1, 1, −1, −1, −1 |
| 13 | −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, 1, −1, −1, −1, −1, 1, −1, 1, −1, 1, 1, −1, −1, −1, −1, 1, −1, −1, −1, −1, 1, 1, 1, 1, 1, −1, |
| | 1, 1, 1, 1, −1, −1, 1, −1, 1, −1, 1, 1, 1, −1, −1, 1, −1, −1, 1, 1, −1, 1, 1, −1, −1 |
| 14 | −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, 1, −1, −1, −1, −1, −1, −1, 1, −1, 1, −1, 1, 1, −1, −1, −1, −1, 1, −1, −1, −1, −1, 1, 1, 1, 1, 1, −1, |
| | 1, 1, 1, 1, −1, −1, 1, −1, 1, −1, 1, 1, 1, −1, −1, 1, −1, −1, 1, 1, −1, 1, 1, −1 |
| 15 | 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, |
| | 1, 1, −1, 1, −1, 1, −1, −1, −1, −1, −1, −1, −1, −1, 1, −1, 1, −1, 1, 1, −1, −1, −1, −1, 1, −1, −1, −1, −1, 1, 1, 1, 1, |
| | 1, −1, 1, 1, 1, 1, −1, −1, 1, −1, 1, −1, 1, 1, 1, −1, −1, 1, −1, −1, 1, 1, −1, 1, 1 |
| 16 | −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, |
| | 1, 1, −1, 1, −1, 1, −1, −1, −1, 1, 1, −1, −1, 1, 1, −1, −1, −1, 1, −1, 1, −1, 1, 1, −1, −1, −1, 1, −1, −1, −1, −1, |
| | 1, 1, 1, 1, 1, −1, 1, 1, 1, 1, −1, −1, 1, −1, 1, −1, 1, 1, 1, −1, −1, 1, −1, −1, 1, 1, −1 |
| 17 | −1, −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, |
| | 1, −1, −1, −1, 1, 1, −1, 1, 1, −1, −1, 1, 1, −1, 1, 1, −1, −1, −1, 1, −1, 1, −1, 1, 1, −1, −1, −1, −1, 1, −1, −1, −1, −1, |
| | 1, 1, 1, 1, 1, −1, 1, 1, 1, 1, −1, −1, 1, −1, 1, −1, 1, 1, 1, −1, −1, 1, −1, −1 |
| 18 | −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, |
| | 1, −1, −1, −1, 1, 1, −1, 1, 1, −1, −1, −1, −1, 1, 1, −1, 1, 1, −1, −1, −1, 1, −1, 1, −1, 1, 1, −1, −1, −1, −1, 1, −1, −1, −1, −1, |
| | 1, 1, 1, 1, 1, −1, 1, 1, 1, 1, −1, −1, 1, −1, 1, −1, 1, 1, 1, −1, −1, 1, −1 |
| 19 | 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, |
| | 1, −1, −1, −1, 1, 1, −1, 1, 1, −1, −1, −1, −1, −1, −1, 1, 1, −1, 1, 1, −1, −1, −1, 1, −1, 1, −1, 1, 1, −1, −1, −1, −1, 1, −1, −1, −1, −1, |
| | 1, 1, 1, 1, 1, −1, 1, 1, 1, 1, −1, −1, 1, −1, 1, −1, 1, 1, 1, −1, −1, 1 |
| 20 | −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, |
| | 1, 1, −1, 1, 1, −1, −1, 1, −1, −1, 1, −1, −1, 1, 1, −1, 1, 1, −1, −1, −1, 1, −1, 1, −1, 1, 1, −1, −1, −1, −1, 1, −1, −1, −1, −1, |
| | 1, 1, 1, 1, 1, −1, 1, 1, 1, 1, −1, −1, 1, −1, 1, −1, 1, 1, 1, −1, −1 |
| 21 | −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, |
| | 1, 1, −1, 1, 1, −1, −1, 1, −1, −1, −1, −1, 1, −1, −1, 1, 1, −1, 1, 1, −1, −1, −1, 1, −1, 1, −1, 1, 1, −1, −1, −1, −1, |
| | 1, −1, −1, −1, −1, 1, 1, 1, 1, 1, −1, 1, 1, 1, 1, −1, −1, 1, −1, 1, −1, 1, 1, 1, −1 |
| 22 | 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, |
| | 1, 1, −1, 1, 1, −1, −1, 1, −1, −1, −1, −1, −1, −1, 1, −1, −1, 1, 1, −1, 1, 1, −1, −1, −1, 1, −1, 1, −1, 1, 1, −1, −1, −1, −1, |
| | 1, −1, −1, −1, −1, 1, 1, 1, 1, 1, −1, 1, 1, 1, 1, −1, −1, 1, −1, 1, −1, 1, 1, 1 |
| 23 | 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, |
| | 1, 1, −1, 1, 1, −1, −1, 1, −1, −1, 1, −1, −1, 1, −1, −1, 1, −1, −1, 1, 1, −1, 1, 1, −1, −1, −1, 1, −1, 1, −1, 1, 1, −1, −1, −1, −1, |
| | 1, −1, −1, −1, −1, 1, 1, 1, 1, 1, −1, 1, 1, 1, 1, −1, −1, 1, −1, 1, −1, 1, 1 |
| 24 | 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, |
| | 1, 1, −1, −1, 1, −1, −1, 1, 1, −1, −1, 1, 1, −1, −1, 1, −1, −1, 1, 1, −1, 1, 1, −1, −1, −1, 1, −1, 1, −1, 1, 1, −1, −1, −1, −1, |
| | 1, −1, −1, −1, −1, 1, 1, 1, 1, 1, −1, 1, 1, 1, 1, −1, −1, 1, −1, 1, −1, 1 |
| 25 | −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, |
| | 1, 1, −1, −1, 1, −1, −1, 1, 1, 1, −1, −1, 1, 1, 1, −1, −1, 1, −1, −1, 1, 1, −1, 1, 1, −1, −1, −1, 1, −1, 1, −1, 1, 1, −1, −1, −1, −1, |
| | 1, −1, −1, −1, −1, 1, 1, 1, 1, 1, −1, 1, 1, 1, 1, −1, −1, 1, −1, 1, −1 |
| 26 | 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, |
| | 1, 1, −1, −1, 1, −1, −1, 1, 1, 1, −1, −1, −1, −1, 1, 1, 1, −1, −1, 1, −1, −1, 1, 1, −1, 1, 1, −1, −1, −1, 1, −1, 1, −1, 1, |
| | 1, −1, −1, −1, −1, 1, −1, −1, −1, −1, 1, 1, 1, 1, 1, −1, 1, 1, 1, 1, −1, −1, 1, −1, 1 |
| 27 | −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, |
| | 1, −1, −1, 1, 1, 1, −1, 1, −1, 1, −1, −1, 1, −1, 1, −1, 1, 1, 1, −1, −1, 1, −1, −1, 1, 1, −1, 1, 1, −1, −1, −1, 1, −1, 1, −1, |
| | 1, 1, −1, −1, −1, −1, 1, −1, −1, −1, −1, 1, 1, 1, 1, 1, −1, 1, 1, 1, 1, −1, −1 |
| 28 | −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, |
| | 1, −1, −1, 1, 1, 1, −1, 1, −1, 1, −1, −1, −1, −1, 1, −1, 1, −1, 1, 1, 1, −1, −1, 1, −1, −1, 1, 1, −1, 1, 1, −1, −1, −1, 1, −1, 1, −1, |
| | 1, 1, −1, −1, −1, −1, 1, −1, −1, −1, −1, 1, 1, 1, 1, 1, −1, 1, 1, 1, 1, −1 |
| 29 | 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, 1, −1, −1, |
| | 1, 1, 1, −1, 1, −1, 1, −1, −1, −1, −1, −1, −1, 1, −1, 1, −1, 1, 1, 1, −1, −1, 1, −1, −1, 1, 1, −1, 1, 1, −1, −1, −1, 1, −1, 1, −1, |
| | 1, 1, −1, −1, −1, −1, 1, −1, −1, −1, −1, 1, 1, 1, 1, 1, −1, 1, 1, 1, 1 |
| 30 | 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, 1, −1, −1, |
| | 1, 1, 1, −1, 1, −1, 1, −1, −1, 1, −1, −1, 1, −1, −1, 1, −1, 1, −1, 1, 1, 1, −1, −1, 1, −1, −1, 1, 1, −1, 1, 1, −1, −1, −1, 1, −1, |
| | 1, −1, 1, 1, −1, −1, −1, −1, 1, −1, −1, −1, −1, 1, 1, 1, 1, 1, −1, 1, 1, 1 |
| 31 | 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, 1, −1, −1, |
| | 1, 1, 1, −1, 1, −1, 1, −1, −1, 1, 1, 1, −1, −1, 1, 1, 1, −1, −1, 1, −1, 1, −1, 1, 1, 1, −1, −1, 1, −1, −1, 1, 1, −1, 1, |
| | 1, −1, −1, −1, 1, −1, 1, −1, 1, 1, −1, −1, −1, −1, 1, −1, −1, −1, −1, 1, 1, 1, 1, 1, −1, 1 |
| 32 | 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, 1, −1, −1, 1, 1, 1, −1, |
| | 1, −1, 1, −1, −1, 1, 1, 1, 1, −1, −1, −1, −1, 1, 1, 1, 1, −1, −1, 1, −1, 1, −1, 1, 1, 1, −1, −1, 1, −1, −1, 1, 1, −1, 1, |
| | 1, −1, −1, −1, 1, −1, 1, −1, 1, 1, −1, −1, −1, −1, 1, −1, −1, −1, −1, 1, 1, 1, 1, 1 |
| 33 | −1, −1, −1, −1, 1, −1, −1, −1, −1, 1, 1, −1, 1, −1, 1, −1, −1, −1, 1, 1, −1, 1, 1, −1, −1, 1, −1, −1, 1, 1, 1, −1, 1, −1, 1, −1, −1, |
| | 1, 1, 1, 1, −1, 1, 1, 1, 1, 1, −1, 1, −1, −1, −1, −1, −1, 1, −1, −1, −1, −1, 1, 1, −1, 1, −1, 1, −1, −1, −1, 1, 1, −1, 1, |
| | 1, −1, −1, 1, −1, −1, 1, 1, 1, −1, 1, −1, 1, −1, −1, 1, 1, 1, 1, −1, 1, 1, 1, 1 |
| 34 | 1, −1, −1, −1, −1, 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, 1, −1, −1, −1, −1, −1, 1, 1, 1, 1, 1, −1, −1, −1, −1, −1, 1, −1, −1, −1, −1, 1, 1, −1, 1, −1, 1, −1, −1, −1, 1, 1, −1, |
| | 1, 1, −1, −1, 1, −1, −1, 1, 1, 1, −1, 1, −1, 1, −1, −1, 1, 1, 1, 1, −1 |
| 35 | −1, −1, −1, −1, 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, 1, −1, −1, −1, −1, 1, −1, 1, −1, 1, 1, 1, 1, −1, −1, −1, −1, −1, 1, −1, −1, −1, −1, 1, 1, −1, 1, −1, 1, −1, −1, −1, |
| | 1, 1, −1, 1, 1, −1, −1, 1, −1, −1, 1, 1, 1, −1, 1, −1, 1, −1, −1, 1, 1, 1, 1 |
| 36 | −1, −1, −1, 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, 1, −1, −1, −1, −1, 1, −1, −1, 1, 1, −1, 1, 1, 1, 1, −1, −1, −1, −1, −1, 1, −1, −1, −1, −1, 1, 1, −1, 1, −1, |
| | 1, −1, −1, −1, 1, 1, −1, 1, 1, −1, −1, 1, −1, −1, 1, 1, 1, −1, 1, −1, 1, −1, −1, 1, 1, 1 |
| 37 | −1, −1, 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, 1, −1, −1, −1, −1, 1, −1, −1, −1, 1, 1, 1, −1, 1, 1, 1, 1, −1, −1, −1, −1, −1, 1, −1, −1, −1, −1, 1, 1, −1, 1, −1, |
| | 1, −1, −1, −1, 1, 1, −1, 1, 1, −1, −1, 1, −1, −1, 1, 1, 1, −1, 1, −1, 1, −1, −1, 1, 1 |
| 38 | −1, 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, 1, −1, −1, −1, −1, 1, −1, −1, −1, −1, 1, 1, 1, 1, −1, 1, 1, 1, 1, −1, −1, −1, −1, −1, 1, −1, −1, −1, −1, 1, 1, −1, |
| | 1, −1, 1, −1, −1, −1, 1, 1, −1, 1, 1, −1, −1, 1, −1, −1, 1, 1, 1, −1, 1, −1, 1, −1, −1, 1 |
| 39 | 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, |
| | 1, −1, −1, −1, −1, 1, −1, −1, −1, −1, −1, 1, 1, 1, 1, 1, −1, 1, 1, 1, 1, −1, −1, −1, −1, −1, 1, −1, −1, −1, −1, 1, 1, −1, 1, −1, |
| | 1, −1, −1, −1, 1, 1, −1, 1, 1, −1, −1, 1, −1, −1, 1, 1, 1, −1, 1, −1, 1, −1, −1 |
| 40 | 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, |
| | 1, −1, −1, −1, −1, 1, −1, −1, −1, −1, 1, −1, 1, −1, 1, 1, 1, 1, −1, 1, 1, 1, 1, −1, −1, −1, −1, −1, 1, −1, −1, −1, −1, 1, 1, −1, 1, −1, |
| | 1, −1, −1, −1, 1, 1, −1, 1, 1, −1, −1, 1, −1, −1, 1, 1, 1, −1, 1, −1, 1, −1 |
| 41 | 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, −1, 1, 1, −1, −1, 1, 1, 1, 1, −1, 1, 1, 1, 1, −1, −1, −1, −1, −1, 1, −1, −1, −1, −1, 1, 1, −1, 1, −1, |
| | 1, −1, −1, −1, 1, 1, −1, 1, 1, −1, −1, 1, −1, −1, 1, 1, 1, −1, 1, −1 |
| 42 | −1, 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, 1, −1, 1, −1, −1, 1, 1, 1, 1, −1, 1, 1, 1, 1, −1, −1, −1, −1, −1, 1, −1, −1, −1, −1, 1, 1, −1, |
| | 1, −1, 1, −1, −1, −1, 1, 1, −1, 1, 1, −1, −1, 1, −1, −1, 1, 1, 1, −1, 1 |
| 43 | 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, −1, 1, 1, −1, 1, −1, −1, 1, 1, 1, 1, −1, 1, 1, 1, 1, −1, −1, −1, −1, −1, 1, −1, −1, −1, −1, 1, 1, −1, |
| | 1, −1, 1, −1, −1, −1, 1, 1, −1, 1, 1, −1, −1, 1, −1, −1, 1, 1, 1, −1 |
| 44 | −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, 1, −1, 1, −1, 1, −1, 1, −1, −1, 1, 1, 1, 1, −1, 1, 1, 1, 1, −1, −1, −1, −1, −1, 1, −1, −1, −1, −1, |
| | 1, 1, −1, 1, −1, 1, −1, −1, −1, 1, 1, −1, 1, 1, −1, −1, 1, −1, −1, 1, 1, 1 |
| 45 | −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, 1, −1, −1, 1, 1, −1, 1, −1, 1, −1, −1, 1, 1, 1, 1, −1, 1, 1, 1, 1, −1, −1, −1, −1, −1, 1, −1, −1, −1, −1, |
| | 1, 1, −1, 1, −1, 1, −1, −1, −1, 1, 1, −1, 1, 1, −1, −1, 1, −1, −1, 1, 1 |
| 46 | −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, |
| | 1, 1, −1, 1, −1, 1, −1, −1, −1, 1, 1, 1, −1, 1, −1, 1, −1, −1, 1, 1, 1, 1, −1, 1, 1, 1, 1, −1, −1, −1, −1, −1, 1, −1, −1, −1, −1, |
| | 1, 1, −1, 1, −1, 1, −1, −1, −1, 1, 1, −1, 1, 1, −1, −1, 1, −1, −1, 1 |
| 47 | 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, |
| | 1, 1, −1, 1, −1, 1, −1, −1, −1, −1, 1, 1, 1, 1, −1, 1, −1, 1, −1, −1, 1, 1, 1, 1, −1, 1, 1, 1, 1, −1, −1, −1, −1, −1, |
| | 1, −1, −1, −1, −1, 1, 1, −1, 1, −1, 1, −1, −1, −1, 1, 1, −1, 1, 1, −1, −1, 1, −1, −1 |
| 48 | −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, |
| | 1, 1, −1, 1, −1, 1, −1, −1, −1, 1, 1, −1, 1, −1, −1, 1, 1, 1, −1, 1, −1, 1, −1, −1, 1, 1, 1, 1, −1, 1, 1, 1, 1, −1, −1, −1, −1, −1, |
| | 1, −1, −1, −1, −1, 1, 1, −1, 1, −1, 1, −1, −1, −1, 1, 1, −1, 1, 1, −1, −1, 1 |
| 49 | −1, −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, |
| | 1, −1, −1, −1, 1, 1, −1, 1, 1, −1, 1, −1, −1, 1, −1, −1, 1, 1, 1, −1, 1, −1, 1, −1, −1, 1, 1, 1, 1, −1, 1, 1, 1, 1, −1, −1, −1, −1, −1, |
| | 1, −1, −1, −1, −1, 1, 1, −1, 1, −1, 1, −1, −1, −1, 1, 1, −1, 1, 1 |
| 50 | −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, |
| | 1, −1, −1, −1, 1, 1, −1, 1, 1, −1, −1, 1, 1, −1, −1, 1, −1, −1, 1, 1, 1, −1, 1, −1, 1, −1, −1, 1, 1, 1, 1, −1, 1, 1, 1, |
| | 1, −1, −1, −1, −1, −1, 1, −1, −1, −1, −1, 1, 1, −1, 1, −1, 1, −1, −1, −1, 1, 1, −1, 1 |
| 51 | 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, |
| | 1, −1, −1, −1, 1, 1, −1, 1, 1, −1, −1, 1, 1, −1, −1, 1, −1, −1, 1, 1, 1, −1, 1, −1, 1, −1, −1, 1, 1, 1, 1, −1, 1, 1, 1, |
| | 1, −1, −1, −1, −1, −1, 1, −1, −1, −1, −1, 1, 1, −1, 1, −1, 1, −1, −1, −1, 1, 1, −1 |
| 52 | −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, |
| | 1, −1, −1, −1, 1, 1, −1, 1, 1, −1, −1, 1, −1, 1, −1, 1, 1, −1, −1, 1, −1, −1, 1, 1, 1, −1, 1, −1, 1, −1, −1, 1, 1, 1, 1, −1, 1, 1, 1, |
| | 1, −1, −1, −1, −1, −1, 1, −1, −1, −1, −1, 1, 1, −1, 1, −1, 1, −1, −1, −1, 1, 1 |
| 53 | −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, |
| | 1, 1, −1, 1, 1, −1, −1, 1, −1, −1, 1, 1, −1, 1, 1, −1, −1, 1, −1, −1, 1, 1, 1, −1, 1, −1, 1, −1, −1, 1, 1, 1, 1, −1, 1, 1, 1, |
| | 1, −1, −1, −1, −1, −1, 1, −1, −1, −1, −1, 1, 1, −1, 1, −1, 1, −1, −1, −1, 1 |
| 54 | 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, |
| | 1, 1, −1, 1, 1, −1, −1, 1, −1, −1, −1, 1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, −1, −1, −1, −1, −1, 1, −1, −1, −1, −1, 1, 1, −1, 1, −1, 1, −1, −1, −1 |
| 55 | 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, |
| | 1, 1, −1, 1, 1, −1, −1, 1, −1, −1, 1, −1, 1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, −1, −1, −1, −1, −1, 1, −1, −1, −1, −1, 1, 1, −1, 1, −1, 1, −1, −1 |
| 56 | 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, |
| | 1, −1, 1, 1, −1, −1, 1, −1, −1, 1, 1, −1, 1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, −1, −1, −1, −1, −1, 1, −1, −1, −1, −1, 1, 1, −1, 1, −1, 1, −1 |
| 57 | −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, |
| | 1, 1, −1, −1, 1, −1, −1, 1, 1, 1, −1, 1, −1, −1, −1, 1, 1, −1, 1, 1, −1, −1, 1, −1, −1, 1, 1, 1, −1, 1, −1, 1, −1, −1, |
| | 1, 1, 1, 1, −1, 1, 1, 1, 1, −1, −1, −1, −1, −1, 1, −1, −1, −1, −1, 1, 1, −1, 1, −1, 1 |
| 58 | 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, |
| | 1, 1, −1, −1, 1, −1, −1, 1, 1, 1, −1, −1, 1, 1, −1, −1, −1, 1, 1, −1, 1, 1, −1, −1, 1, −1, −1, 1, 1, 1, −1, 1, −1, 1, −1, −1, |
| | 1, 1, 1, 1, −1, 1, 1, 1, 1, −1, −1, −1, −1, −1, 1, −1, −1, −1, −1, 1, 1, −1, 1, −1 |
| 59 | −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, |
| | 1, −1, −1, 1, 1, 1, −1, 1, −1, 1, −1, 1, −1, 1, −1, 1, −1, −1, −1, 1, 1, −1, 1, 1, −1, −1, 1, −1, −1, 1, 1, 1, −1, 1, −1, |
| | 1, −1, −1, 1, 1, 1, 1, −1, 1, 1, 1, 1, −1, −1, −1, −1, −1, 1, −1, −1, −1, −1, 1, 1 |
| 60 | −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, |
| | 1, −1, −1, 1, 1, 1, −1, 1, −1, 1, −1, −1, 1, 1, −1, 1, −1, 1, −1, −1, −1, 1, 1, −1, 1, 1, −1, −1, 1, −1, −1, 1, 1, 1, −1, 1, −1, |
| | 1, −1, −1, 1, 1, 1, 1, −1, 1, 1, 1, 1, −1, −1, −1, −1, −1, 1, −1, −1, −1, −1, 1 |
| 61 | 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, 1, −1, −1, |
| | 1, 1, 1, −1, 1, −1, 1, −1, −1, −1, 1, 1, 1, −1, 1, −1, 1, −1, −1, −1, 1, 1, −1, 1, 1, −1, −1, 1, −1, −1, 1, 1, 1, −1, 1, −1, |
| | 1, −1, −1, 1, 1, 1, 1, −1, 1, 1, 1, 1, −1, −1, −1, −1, −1, 1, −1, −1, −1, −1 |
| 62 | 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, 1, −1, −1, |
| | 1, 1, 1, −1, 1, −1, 1, −1, −1, 1, −1, 1, −1, 1, 1, −1, 1, −1, 1, −1, −1, −1, 1, 1, −1, 1, 1, −1, −1, 1, −1, −1, 1, 1, 1, −1, 1, −1, |
| | 1, −1, −1, 1, 1, 1, 1, −1, 1, 1, 1, 1, −1, −1, −1, −1, −1, 1, −1, −1, −1 |
| 63 | 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, 1, −1, −1, |
| | 1, 1, 1, −1, 1, −1, 1, −1, −1, 1, 1, 1, −1, 1, −1, −1, −1, 1, 1, −1, 1, −1, 1, −1, −1, −1, 1, 1, −1, 1, 1, −1, −1, 1, −1, −1, |
| | 1, 1, 1, −1, 1, −1, 1, −1, −1, 1, 1, 1, 1, −1, 1, 1, 1, 1, −1, −1, −1, −1, −1, 1, −1 |
| 64 | 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, 1, −1, −1, 1, 1, 1, −1, |
| | 1, −1, 1, −1, −1, 1, 1, 1, 1, −1, −1, 1, 1, −1, −1, −1, −1, 1, 1, −1, 1, −1, 1, −1, −1, −1, 1, 1, −1, 1, 1, −1, −1, 1, −1, −1, |
| | 1, 1, 1, −1, 1, −1, 1, −1, −1, 1, 1, 1, 1, −1, 1, 1, 1, 1, −1, −1, −1, −1, −1 |

TABLE 4
ELR-mark Sequences of Length 64 sequences based on PC with Hadamard extension with QBPSK modulation

| Index | ELR Sequence |
|---|---|
| 1 | 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, 1, −1, −1, 1, 1, 1, −1, |
| | 1, −1, 1, −1, −1, 1, 1, 1, 1, −1, −1, 1, 1, 1, 1, 1, −1, −1, −1, −1, 1, −1, −1, −1, −1, 1, 1, −1, 1, −1, 1, −1, −1, −1, 1, 1, −1, |
| | 1, 1, −1, −1, 1, −1, −1, 1, 1, 1, −1, 1, −1, 1, −1, −1, 1, 1, 1, 1, −1, −1 |
| 2 | 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, 1, −1, −1, |
| | 1, 1, 1, −1, 1, −1, 1, −1, −1, 1, 1, 1, −1, 1, −1, 1, 1, 1, 1, 1, −1, −1, −1, −1, 1, −1, −1, −1, −1, 1, 1, −1, 1, −1, |
| | 1, −1, −1, −1, 1, 1, −1, 1, 1, −1, −1, 1, −1, −1, 1, 1, 1, −1, 1, −1, 1, −1, −1, 1, 1, 1, −1 |
| 3 | 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, 1, −1, −1, |
| | 1, 1, 1, −1, 1, −1, 1, −1, −1, 1, −1, 1, 1, 1, −1, 1, 1, 1, 1, 1, −1, −1, −1, −1, 1, −1, −1, −1, −1, 1, 1, −1, 1, −1, |
| | 1, −1, −1, −1, 1, 1, −1, 1, 1, −1, −1, 1, −1, −1, 1, 1, 1, −1, 1, −1, 1, −1, −1, 1, −1 |
| 4 | 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, 1, −1, −1, |
| | 1, 1, 1, −1, 1, −1, 1, −1, −1, −1, 1, 1, 1, 1, −1, 1, 1, 1, 1, 1, −1, −1, −1, −1, 1, −1, −1, −1, −1, 1, 1, −1, 1, −1, |
| | 1, −1, −1, −1, 1, 1, −1, 1, 1, −1, −1, 1, −1, −1, 1, 1, 1, −1, 1, −1, 1, −1, −1, −1 |
| 5 | −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, |
| | 1, −1, −1, 1, 1, 1, −1, 1, −1, 1, −1, −1, −1, 1, 1, 1, 1, −1, 1, 1, 1, 1, 1, −1, −1, −1, −1, 1, −1, −1, −1, −1, 1, 1, −1, 1, −1, |
| | 1, −1, −1, −1, 1, 1, −1, 1, 1, −1, −1, 1, −1, −1, 1, 1, 1, −1, 1, −1, 1, −1, −1 |
| 6 | −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, |
| | 1, −1, −1, 1, 1, 1, −1, 1, −1, 1, −1, −1, −1, 1, 1, 1, 1, −1, 1, 1, 1, 1, 1, −1, −1, −1, −1, 1, −1, −1, −1, −1, 1, 1, −1, 1, −1, |
| | 1, −1, −1, −1, 1, 1, −1, 1, 1, −1, −1, 1, −1, −1, 1, 1, 1, −1, 1, −1, 1, −1 |
| 7 | −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, |
| | 1, −1, −1, 1, −1, −1, 1, 1, 1, −1, 1, −1, −1, 1, −1, −1, 1, 1, 1, 1, −1, 1, 1, 1, 1, 1, −1, −1, −1, −1, 1, −1, −1, −1, −1, 1, 1, −1, |
| | 1, −1, 1, −1, −1, −1, 1, 1, −1, 1, 1, −1, −1, 1, −1, −1, 1, 1, 1, −1, 1, −1 |
| 8 | −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, |
| | 1, 1, −1, −1, 1, −1, −1, 1, 1, 1, −1, −1, 1, −1, 1, −1, −1, 1, 1, 1, 1, −1, 1, 1, 1, 1, 1, −1, −1, −1, −1, 1, −1, −1, −1, −1, |
| | 1, 1, −1, 1, −1, 1, −1, −1, −1, 1, 1, −1, 1, 1, −1, −1, 1, −1, −1, 1, 1, 1, −1 |
| 9 | 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, 1, 1, −1, |
| | 1, 1, −1, −1, 1, −1, −1, 1, 1, −1, 1, −1, 1, −1, 1, −1, −1, 1, 1, 1, 1, −1, 1, 1, 1, 1, 1, −1, −1, −1, −1, 1, −1, −1, −1, −1, |
| | 1, 1, −1, 1, −1, 1, −1, −1, −1, 1, 1, −1, 1, 1, −1, −1, 1, −1, −1, 1, 1, 1, −1 |
| 10 | 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, |
| | 1, 1, −1, 1, 1, −1, −1, 1, −1, −1, 1, −1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, 1, −1, −1, −1, 1, 1, −1, 1, 1, −1, −1, 1, −1, −1, 1, −1 |
| 11 | 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, |
| | 1, 1, −1, 1, 1, −1, −1, 1, −1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, 1, −1, −1, −1, 1, 1, −1, 1, 1, −1, −1, 1, −1, −1, −1 |
| 12 | −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, |
| | 1, 1, −1, 1, 1, −1, −1, 1, −1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, 1, −1, −1, −1, 1, 1, −1, 1, 1, −1, −1, 1, −1, −1 |
| 13 | −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, |
| | 1, −1, −1, −1, 1, 1, −1, 1, 1, −1, −1, 1, −1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, 1, −1, −1, −1, 1, 1, −1, 1, 1, −1, −1, 1, −1 |
| 14 | 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, |
| | 1, −1, −1, −1, 1, 1, −1, 1, 1, −1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, 1, −1, −1, −1, 1, 1, −1, 1, 1, −1, −1, −1 |
| 15 | −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, |
| | 1, −1, −1, −1, 1, 1, −1, 1, 1, −1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, 1, −1, −1, −1, 1, 1, −1, 1, 1, −1, −1 |
| 16 | −1, −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, |
| | 1, −1, −1, −1, 1, 1, −1, 1, 1, −1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, 1, −1, −1, −1, 1, 1, −1, 1, 1, −1 |
| 17 | 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, |
| | 1, −1, 1, −1, −1, −1, 1, 1, −1, −1, 1, 1, −1, −1, 1, −1, −1, 1, 1, 1, −1, 1, −1, 1, −1, −1, 1, 1, 1, 1, −1, 1, 1, 1, 1, |
| | 1, −1, −1, −1, −1, 1, −1, −1, −1, −1, 1, 1, −1, 1, −1, 1, −1, −1, −1, 1, 1, −1, −1 |
| 18 | −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, |
| | 1, 1, −1, 1, −1, 1, −1, −1, −1, 1, 1, −1, −1, 1, 1, −1, −1, 1, −1, −1, 1, 1, 1, −1, 1, −1, 1, −1, −1, 1, 1, 1, 1, −1, |
| | 1, 1, 1, 1, 1, −1, −1, −1, −1, 1, −1, −1, −1, −1, 1, 1, −1, 1, −1, 1, −1, −1, −1, 1, 1, −1 |
| 19 | 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, |
| | 1, 1, −1, 1, −1, 1, −1, −1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, 1, −1, −1, −1, −1, 1, −1, −1, −1, −1, 1, 1, −1, 1, −1, 1, −1, −1, −1, −1 |
| 20 | −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, 1, −1, −1, −1, −1, 1, 1, −1, 1, 1, −1, −1, 1, −1, −1, 1, 1, 1, −1, 1, −1, 1, −1, −1, 1, 1, 1, |
| | 1, −1, 1, 1, 1, 1, 1, −1, −1, −1, −1, 1, −1, −1, −1, −1, 1, 1, −1, 1, −1, 1, −1, −1, −1 |
| 21 | −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, 1, −1, −1, −1, −1, 1, 1, −1, 1, 1, −1, −1, 1, −1, −1, 1, 1, 1, −1, 1, −1, 1, −1, −1, 1, 1, 1, |
| | 1, −1, 1, 1, 1, 1, 1, −1, −1, −1, −1, 1, −1, −1, −1, −1, 1, 1, −1, 1, −1, 1, −1, −1 |
| 22 | −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, 1, −1, −1, −1, −1, 1, 1, −1, 1, 1, −1, −1, 1, −1, −1, 1, 1, 1, −1, 1, −1, 1, −1, −1, 1, 1, 1, |
| | 1, −1, 1, 1, 1, 1, 1, −1, −1, −1, −1, 1, −1, −1, −1, −1, 1, 1, −1, 1, −1, 1, −1 |
| 23 | 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, −1, 1, −1, −1, −1, 1, 1, −1, 1, 1, −1, −1, 1, −1, −1, 1, 1, 1, −1, 1, −1, 1, −1, −1, 1, 1, 1, |
| | 1, −1, 1, 1, 1, 1, 1, −1, −1, −1, −1, 1, −1, −1, −1, −1, 1, 1, −1, 1, −1, −1 |
| 24 | −1, 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, −1, 1, −1, −1, −1, 1, 1, −1, 1, 1, −1, −1, 1, −1, −1, 1, 1, 1, −1, 1, −1, 1, −1, −1, |
| | 1, 1, 1, 1, −1, 1, 1, 1, 1, 1, −1, −1, −1, −1, 1, −1, −1, −1, −1, 1, 1, −1, 1, −1 |
| 25 | 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, −1, 1, −1, 1, −1, −1, −1, 1, 1, −1, 1, 1, −1, −1, 1, −1, −1, 1, 1, 1, −1, 1, −1, 1, −1, −1, |
| | 1, 1, 1, 1, −1, 1, 1, 1, 1, 1, −1, −1, −1, −1, 1, −1, −1, −1, −1, 1, 1, −1, −1 |
| 26 | 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, |
| | 1, −1, −1, −1, −1, 1, −1, −1, −1, −1, 1, −1, 1, −1, 1, −1, 1, −1, −1, −1, 1, 1, −1, 1, 1, −1, −1, 1, −1, −1, 1, 1, 1, −1, 1, −1, |
| | 1, −1, −1, 1, 1, 1, 1, −1, 1, 1, 1, 1, 1, −1, −1, −1, −1, 1, −1, −1, −1, −1, 1, −1 |
| 27 | 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, |
| | 1, −1, −1, −1, −1, 1, −1, −1, −1, −1, −1, 1, 1, −1, 1, −1, 1, −1, −1, −1, 1, 1, −1, 1, 1, −1, −1, 1, −1, −1, 1, 1, 1, −1, 1, −1, |
| | 1, −1, −1, 1, 1, 1, 1, −1, 1, 1, 1, 1, 1, −1, −1, −1, −1, 1, −1, −1, −1, −1, −1 |
| 28 | −1, 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, 1, −1, −1, −1, −1, 1, −1, −1, −1, −1, −1, 1, 1, −1, 1, −1, 1, −1, −1, −1, 1, 1, −1, 1, 1, −1, −1, 1, −1, −1, |
| | 1, 1, 1, −1, 1, −1, 1, −1, −1, 1, 1, 1, 1, −1, 1, 1, 1, 1, 1, −1, −1, −1, −1, 1, −1, −1, −1, −1 |
| 29 | −1, −1, 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, 1, −1, −1, −1, −1, 1, −1, −1, −1, −1, −1, 1, 1, −1, 1, −1, 1, −1, −1, −1, 1, 1, −1, 1, 1, −1, −1, 1, −1, −1, |
| | 1, 1, 1, −1, 1, −1, 1, −1, −1, 1, 1, 1, 1, −1, 1, 1, 1, 1, 1, −1, −1, −1, −1, 1, −1, −1, −1 |
| 30 | −1, −1, −1, 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, 1, −1, −1, −1, −1, 1, −1, −1, −1, −1, −1, 1, 1, −1, 1, −1, 1, −1, −1, −1, 1, 1, −1, 1, 1, −1, −1, 1, −1, −1, |
| | 1, 1, 1, −1, 1, −1, 1, −1, −1, 1, 1, 1, 1, −1, 1, 1, 1, 1, 1, −1, −1, −1, −1, 1, −1, −1 |
| 31 | −1, −1, −1, −1, 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, 1, −1, −1, −1, −1, 1, −1, −1, −1, −1, −1, 1, 1, −1, 1, −1, 1, −1, −1, −1, 1, 1, −1, 1, 1, −1, −1, 1, −1, −1, |
| | 1, 1, 1, −1, 1, −1, 1, −1, −1, 1, 1, 1, 1, −1, 1, 1, 1, 1, 1, −1, −1, −1, −1, 1, −1 |
| 32 | −1, 1, −1, −1, −1, −1, 1, 1, −1, 1, −1, 1, −1, −1, −1, 1, 1, −1, 1, 1, −1, −1, 1, −1, −1, 1, 1, 1, −1, 1, 1, 1, −1, 1, −1, −1, |
| | 1, 1, 1, 1, −1, 1, 1, 1, 1, 1, −1, −1, −1, −1, −1, 1, −1, −1, −1, −1, 1, 1, −1, 1, −1, 1, −1, −1, −1, 1, 1, −1, 1, 1, −1, −1, |
| | 1, −1, −1, 1, 1, 1, −1, 1, −1, 1, −1, −1, 1, 1, 1, 1, −1, 1, 1, 1, 1, 1, −1, −1, −1, −1 |
| 33 | 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, 1, −1, −1, 1, 1, 1, −1, |
| | 1, −1, 1, −1, −1, 1, 1, 1, 1, −1, −1, −1, −1, −1, −1, −1, 1, 1, 1, 1, −1, 1, 1, 1, 1, −1, −1, 1, −1, 1, −1, 1, 1, 1, −1, −1, |
| | 1, −1, −1, 1, 1, −1, 1, 1, −1, −1, −1, 1, −1, 1, −1, 1, 1, −1, −1, −1, 1, 1 |
| 34 | 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, 1, −1, −1, |
| | 1, 1, 1, −1, 1, −1, 1, −1, −1, 1, 1, 1, −1, −1, 1, −1, −1, −1, −1, −1, 1, 1, 1, 1, −1, 1, 1, 1, 1, −1, −1, 1, −1, |
| | 1, −1, 1, 1, 1, −1, −1, 1, −1, −1, 1, 1, −1, 1, 1, −1, −1, −1, 1, −1, 1, −1, 1, 1, −1, −1, −1, 1 |
| 35 | 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, 1, −1, −1, |
| | 1, 1, 1, −1, 1, −1, 1, −1, −1, 1, −1, −1, −1, −1, 1, −1, −1, −1, −1, −1, 1, 1, 1, 1, −1, 1, 1, 1, 1, −1, −1, 1, −1, 1, −1, |
| | 1, 1, 1, −1, −1, 1, −1, −1, 1, 1, −1, 1, 1, −1, −1, −1, 1, −1, 1, −1, 1, 1, −1, 1 |
| 36 | 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, 1, −1, −1, |
| | 1, 1, 1, −1, 1, −1, 1, −1, −1, −1, −1, −1, −1, −1, 1, −1, −1, −1, −1, −1, 1, 1, 1, 1, −1, 1, 1, 1, 1, −1, −1, 1, −1, 1, −1, |
| | 1, 1, 1, −1, −1, 1, −1, −1, 1, 1, −1, 1, 1, −1, −1, −1, 1, −1, 1, −1, 1, 1, 1 |
| 37 | −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, |
| | 1, −1, −1, 1, 1, 1, −1, 1, −1, 1, −1, −1, 1, −1, −1, −1, −1, 1, −1, −1, −1, −1, −1, 1, 1, 1, 1, −1, 1, 1, 1, 1, −1, −1, 1, −1, 1, −1, |
| | 1, 1, 1, −1, −1, 1, −1, −1, 1, 1, −1, 1, 1, −1, −1, −1, 1, −1, 1, −1, 1, 1 |
| 38 | −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, 1, −1, −1, |
| | 1, −1, −1, 1, 1, 1, −1, 1, −1, 1, −1, 1, 1, −1, −1, −1, −1, 1, −1, −1, −1, −1, −1, 1, 1, 1, 1, −1, 1, 1, 1, 1, −1, −1, 1, −1, |
| | 1, −1, 1, 1, 1, −1, −1, 1, −1, −1, 1, 1, −1, 1, 1, −1, −1, −1, 1, −1, 1, −1, 1 |
| 39 | −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, 1, |
| | 1, −1, −1, 1, −1, −1, 1, 1, 1, −1, 1, −1, 1, −1, 1, 1, −1, −1, −1, −1, 1, −1, −1, −1, −1, −1, 1, 1, 1, 1, −1, 1, 1, 1, 1, −1, −1, 1, −1, |
| | 1, −1, 1, 1, 1, −1, −1, 1, −1, −1, 1, 1, −1, 1, 1, −1, −1, −1, 1, −1, 1 |
| 40 | −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, |
| | 1, 1, −1, −1, 1, −1, −1, 1, 1, 1, −1, 1, −1, 1, −1, 1, 1, −1, −1, −1, −1, 1, −1, −1, −1, −1, −1, 1, 1, 1, 1, −1, 1, 1, 1, |
| | 1, −1, −1, 1, −1, 1, −1, 1, 1, 1, −1, −1, 1, −1, −1, 1, 1, −1, 1, 1, −1, −1, −1, 1 |
| 41 | 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, 1, 1, −1, |
| | 1, 1, −1, −1, 1, −1, −1, 1, 1, −1, −1, 1, −1, 1, −1, 1, 1, −1, −1, −1, −1, 1, −1, −1, −1, −1, −1, 1, 1, 1, 1, −1, 1, 1, 1, |
| | 1, −1, −1, 1, −1, 1, −1, 1, 1, 1, −1, −1, 1, −1, −1, 1, 1, −1, 1, 1, −1, −1, 1 |
| 42 | 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, |
| | 1, 1, −1, 1, 1, −1, −1, 1, −1, −1, 1, −1, −1, −1, 1, −1, 1, −1, 1, 1, −1, −1, −1, −1, 1, −1, −1, −1, −1, −1, 1, 1, 1, 1, −1, |
| | 1, 1, 1, 1, −1, −1, 1, −1, 1, −1, 1, 1, 1, −1, −1, 1, −1, −1, 1, 1, −1, 1, 1, −1, 1 |
| 43 | 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, |
| | 1, 1, −1, 1, 1, −1, −1, 1, −1, −1, −1, −1, −1, −1, 1, −1, 1, −1, 1, 1, −1, −1, −1, −1, 1, −1, −1, −1, −1, −1, 1, 1, 1, 1, −1, |
| | 1, 1, 1, 1, −1, −1, 1, −1, 1, −1, 1, 1, 1, −1, −1, 1, −1, −1, 1, 1, −1, 1, 1, 1 |
| 44 | −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, 1, −1, −1, −1, |
| | 1, 1, −1, 1, 1, −1, −1, 1, −1, −1, 1, −1, −1, −1, 1, −1, 1, −1, 1, 1, −1, −1, −1, −1, 1, −1, −1, −1, −1, −1, 1, 1, 1, 1, −1, |
| | 1, 1, 1, 1, −1, −1, 1, −1, 1, −1, 1, 1, 1, −1, −1, 1, −1, −1, 1, 1, −1, 1, 1 |
| 45 | −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, |
| | 1, −1, −1, −1, 1, 1, −1, 1, 1, −1, −1, 1, −1, 1, 1, −1, −1, −1, 1, −1, 1, −1, 1, 1, −1, −1, −1, −1, 1, −1, −1, −1, −1, −1, 1, 1, 1, 1, −1, |
| | 1, 1, 1, 1, −1, −1, 1, −1, 1, −1, 1, 1, 1, −1, −1, 1, −1, −1, 1, 1, −1, 1 |
| 46 | 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, |
| | 1, −1, −1, −1, 1, 1, −1, 1, 1, −1, −1, −1, −1, 1, 1, −1, −1, −1, 1, −1, 1, −1, 1, 1, −1, −1, −1, −1, 1, −1, −1, −1, −1, −1, |
| | 1, 1, 1, 1, −1, 1, 1, 1, 1, −1, −1, 1, −1, 1, −1, 1, 1, 1, −1, −1, 1, −1, −1, 1, 1, 1 |
| 47 | −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, |
| | 1, −1, −1, −1, 1, 1, −1, 1, 1, −1, −1, 1, −1, 1, 1, −1, −1, −1, 1, −1, 1, −1, 1, 1, −1, −1, −1, −1, 1, −1, −1, −1, −1, −1, |
| | 1, 1, 1, 1, −1, 1, 1, 1, 1, −1, −1, 1, −1, 1, −1, 1, 1, 1, −1, −1, 1, −1, −1, 1, 1 |
| 48 | −1, −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, 1, −1, |
| | 1, −1, −1, −1, 1, 1, −1, 1, 1, −1, 1, 1, −1, 1, 1, −1, −1, −1, 1, −1, 1, −1, 1, 1, −1, −1, −1, −1, 1, −1, −1, −1, −1, −1, |
| | 1, 1, 1, 1, −1, 1, 1, 1, 1, −1, −1, 1, −1, 1, −1, 1, 1, 1, −1, −1, 1, −1, −1, 1 |
| 49 | 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, 1, 1, −1, |
| | 1, −1, 1, −1, −1, −1, 1, 1, −1, −1, −1, −1, 1, 1, −1, 1, 1, −1, −1, −1, 1, −1, 1, −1, 1, 1, −1, −1, −1, −1, 1, −1, −1, −1, −1, −1, |
| | 1, 1, 1, 1, −1, 1, 1, 1, 1, −1, −1, 1, −1, 1, −1, 1, 1, 1, −1, −1, 1, 1 |
| 50 | −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, |
| | 1, 1, −1, 1, −1, 1, −1, −1, −1, 1, 1, −1, 1, −1, −1, 1, 1, −1, 1, 1, −1, −1, −1, 1, −1, 1, −1, 1, 1, −1, −1, −1, −1, |
| | 1, −1, −1, −1, −1, −1, 1, 1, 1, 1, −1, 1, 1, 1, 1, −1, −1, 1, −1, 1, −1, 1, 1, 1, −1, −1, 1 |
| 51 | 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, |
| | 1, 1, −1, 1, −1, 1, −1, −1, −1, −1, −1, −1, 1, −1, −1, 1, 1, −1, 1, 1, −1, −1, −1, 1, −1, 1, −1, 1, 1, −1, −1, −1, −1, |
| | 1, −1, −1, −1, −1, −1, 1, 1, 1, 1, −1, 1, 1, 1, 1, −1, −1, 1, −1, 1, −1, 1, 1, 1, 1 |
| 52 | −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, 1, −1, −1, −1, −1, |
| | 1, 1, −1, 1, −1, 1, −1, −1, −1, 1, −1, −1, 1, −1, −1, 1, 1, −1, 1, 1, −1, −1, −1, 1, −1, 1, −1, 1, 1, −1, −1, −1, −1, |
| | 1, −1, −1, −1, −1, −1, 1, 1, 1, 1, −1, 1, 1, 1, 1, −1, −1, 1, −1, 1, −1, 1, 1, 1 |
| 53 | −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, 1, −1, −1, 1, 1, −1, −1, 1, −1, −1, 1, 1, −1, 1, 1, −1, −1, −1, 1, −1, 1, −1, 1, 1, −1, −1, −1, −1, |
| | 1, −1, −1, −1, −1, −1, 1, 1, 1, 1, −1, 1, 1, 1, 1, −1, −1, 1, −1, 1, −1, 1, 1 |
| 54 | −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, 1, −1, 1, 1, 1, −1, −1, 1, −1, −1, 1, 1, −1, 1, 1, −1, −1, −1, 1, −1, 1, −1, 1, 1, −1, −1, −1, −1, |
| | 1, −1, −1, −1, −1, −1, 1, 1, 1, 1, −1, 1, 1, 1, 1, −1, −1, 1, −1, 1, −1, 1 |
| 55 | 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, −1, −1, 1, 1, 1, −1, −1, 1, −1, −1, 1, 1, −1, 1, 1, −1, −1, −1, 1, −1, 1, −1, 1, 1, −1, −1, −1, −1, |
| | 1, −1, −1, −1, −1, −1, 1, 1, 1, 1, −1, 1, 1, 1, 1, −1, −1, 1, −1, 1, 1 |
| 56 | −1, 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, 1, −1, 1, −1, 1, 1, 1, −1, −1, 1, −1, −1, 1, 1, −1, 1, 1, −1, −1, −1, 1, −1, 1, −1, 1, |
| | 1, −1, −1, −1, −1, 1, −1, −1, −1, −1, −1, 1, 1, 1, 1, −1, 1, 1, 1, 1, −1, −1, 1, −1, 1 |
| 57 | 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, 1, −1, −1, −1, −1, |
| | 1, −1, −1, −1, −1, 1, 1, −1, −1, −1, 1, −1, 1, 1, 1, −1, −1, 1, −1, −1, 1, 1, −1, 1, 1, −1, −1, −1, 1, −1, 1, −1, 1, |
| | 1, −1, −1, −1, −1, 1, −1, −1, −1, −1, −1, 1, 1, 1, 1, −1, 1, 1, 1, 1, −1, −1, 1, 1 |
| 58 | 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, |
| | 1, −1, −1, −1, −1, 1, −1, −1, −1, −1, 1, −1, −1, 1, −1, 1, −1, 1, 1, 1, −1, −1, 1, −1, −1, 1, 1, −1, 1, 1, −1, −1, −1, 1, −1, 1, −1, |
| | 1, 1, −1, −1, −1, −1, 1, −1, −1, −1, −1, −1, 1, 1, 1, 1, −1, 1, 1, 1, 1, −1, 1 |
| 59 | 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, 1, 1, 1, 1, |
| | 1, −1, −1, −1, −1, 1, −1, −1, −1, −1, −1, −1, −1, 1, −1, 1, −1, 1, 1, 1, −1, −1, 1, −1, −1, 1, 1, −1, 1, 1, −1, −1, −1, 1, −1, 1, −1, |
| | 1, 1, −1, −1, −1, −1, 1, −1, −1, −1, −1, −1, 1, 1, 1, 1, −1, 1, 1, 1, 1, 1 |
| 60 | −1, 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, 1, −1, −1, −1, −1, 1, −1, −1, −1, −1, 1, −1, −1, 1, −1, 1, −1, 1, 1, 1, −1, −1, 1, −1, −1, 1, 1, −1, 1, 1, −1, −1, −1, |
| | 1, −1, 1, −1, 1, 1, −1, −1, −1, −1, 1, −1, −1, −1, −1, −1, 1, 1, 1, 1, −1, 1, 1, 1, 1 |
| 61 | −1, −1, 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, 1, −1, −1, −1, −1, 1, −1, −1, −1, 1, 1, −1, −1, 1, −1, 1, −1, 1, 1, 1, −1, −1, 1, −1, −1, 1, 1, −1, 1, 1, −1, −1, −1, |
| | 1, −1, 1, −1, 1, 1, −1, −1, −1, −1, 1, −1, −1, −1, −1, −1, 1, 1, 1, 1, −1, 1, 1, 1 |
| 62 | −1, −1, −1, 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, 1, −1, −1, −1, −1, 1, −1, −1, 1, 1, 1, −1, −1, 1, −1, 1, −1, 1, 1, 1, −1, −1, 1, −1, −1, 1, 1, −1, 1, 1, −1, −1, −1, |
| | 1, −1, 1, −1, 1, 1, −1, −1, −1, −1, 1, −1, −1, −1, −1, −1, 1, 1, 1, 1, −1, 1, 1 |
| 63 | −1, −1, −1, −1, 1, 1, −1, 1, −1, 1, −1, −1, −1, 1, 1, −1, 1, 1, −1, −1, 1, −1, −1, 1, 1, 1, −1, 1, −1, 1, −1, −1, 1, 1, 1, 1, −1, |
| | 1, 1, 1, 1, 1, −1, −1, −1, −1, 1, −1, 1, 1, 1, 1, −1, −1, 1, −1, 1, −1, 1, 1, 1, −1, −1, 1, −1, −1, 1, 1, −1, 1, 1, −1, −1, −1, |
| | 1, −1, 1, −1, 1, 1, −1, −1, −1, −1, 1, −1, −1, −1, −1, −1, 1, 1, 1, 1, −1, 1 |
| 64 | −1, 1, −1, −1, −1, −1, 1, 1, −1, 1, −1, 1, −1, −1, −1, 1, 1, −1, 1, 1, −1, −1, 1, −1, −1, 1, 1, 1, −1, 1, −1, 1, −1, −1, |
| | 1, 1, 1, 1, −1, 1, 1, 1, 1, 1, −1, −1, −1, −1, 1, −1, 1, 1, 1, 1, −1, −1, 1, −1, 1, −1, 1, 1, 1, −1, −1, 1, −1, −1, 1, 1, −1, |
| | 1, 1, −1, −1, −1, 1, −1, 1, −1, 1, 1, −1, −1, −1, −1, 1, −1, −1, −1, −1, −1, 1, 1, 1, 1 |

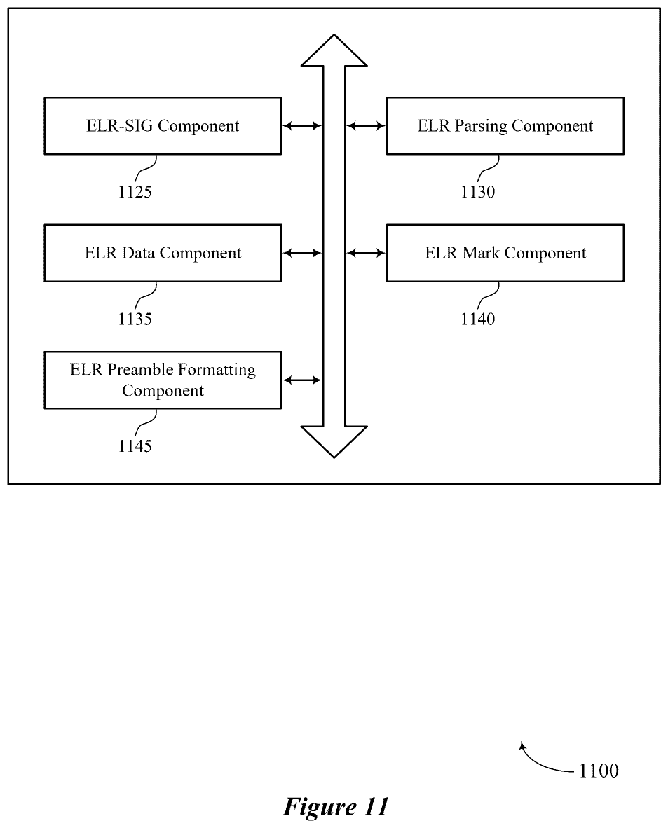

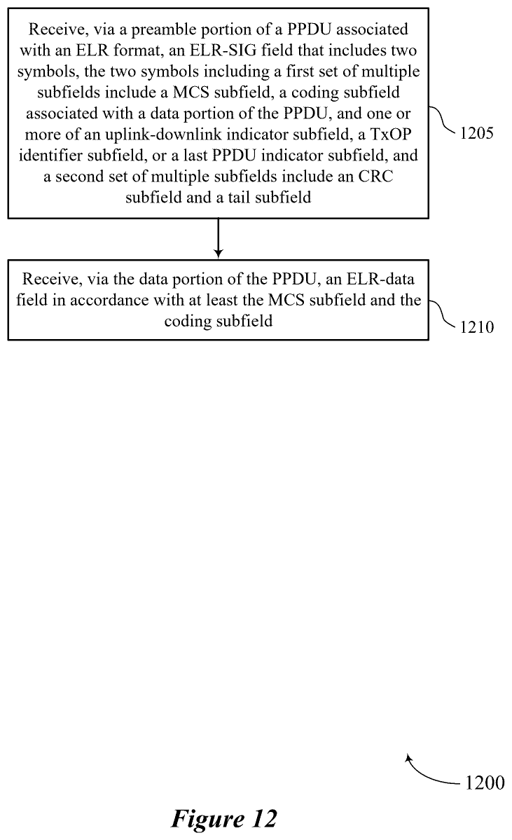

FIG. 11 shows a block diagram of an example wireless communication device 1100 that supports signaling designs for ELR transmissions. In some examples, the wireless communication device 1100 is configured to perform the processes 1200, 1300, 1400, and 1500 described with reference to FIGS. 12, 13, 14, and 15, respectively. The wireless communication device 1100 may include one or more chips, SoCs, chipsets, packages, components or devices that individually or collectively constitute or include a processing system. The processing system may interface with other components of the wireless communication device 1100, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1100 may transmit the information output from the chip. In such an example, the second interface may refer to an interface between the processing system of the chip and a reception component, such that the wireless communication device 1100 may receive information that is then passed to the processing system. In some such examples, the first interface also may obtain information, such as from the transmission component, and the second interface also may output information, such as to the reception component.

The processing system of the wireless communication device 1100 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1100 can be configurable or configured for use in an AP or STA, such as the AP 102 or the STA 104 described with reference to FIG. 1. In some other examples, the wireless communication device 1100 can be an AP or STA that includes such a processing system and other components including multiple antennas. The wireless communication device 1100 is capable of transmitting and receiving wireless communications in the form of, for example, wireless packets. For example, the wireless communication device 1100 can be configurable or configured to transmit and receive packets in the form of physical layer PPDUs and MPDUs conforming to one or more of the IEEE 802.11 family of wireless communication protocol standards. In some other examples, the wireless communication device 1100 can be configurable or configured to transmit and receive signals and communications conforming to one or more 3GPP specifications including those for 5G NR or 6G. In some examples, the wireless communication device 1100 also includes or can be coupled with one or more application processors which may be further coupled with one or more other memories. In some examples, the wireless communication device 1100 further includes a user interface (UI) (such as a touchscreen or keypad) and a display, which may be integrated with the UI to form a touchscreen display that is coupled with the processing system. In some examples, the wireless communication device 1100 may further include one or more sensors such as, for example, one or more inertial sensors, accelerometers, temperature sensors, pressure sensors, or altitude sensors, that are coupled with the processing system. In some examples, the wireless communication device 1100 further includes at least one external network interface coupled with the processing system that enables communication with a core network or backhaul network that enables the wireless communication device 1100 to gain access to external networks including the Internet.

The wireless communication device 1100 includes an ELR-SIG component 1125, an ELR parsing component 1130, an ELR data component 1135, an ELR mark component 1140, and an ELR preamble formatting component 1145. Portions of one or more of the ELR-SIG component 1125, the ELR parsing component 1130, the ELR data component 1135, the ELR mark component 1140, and the ELR preamble formatting component 1145 may be implemented at least in part in hardware or firmware. For example, one or more of the ELR-SIG component 1125, the ELR parsing component 1130, the ELR data component 1135, the ELR mark component 1140, and the ELR preamble formatting component 1145 may be implemented at least in part by at least a processor or a modem. In some examples, portions of one or more of the ELR-SIG component 1125, the ELR parsing component 1130, the ELR data component 1135, the ELR mark component 1140, and the ELR preamble formatting component 1145 may be implemented at least in part by a processor and software in the form of processor-executable code stored in memory.

The wireless communication device 1100 may support wireless communications in accordance with examples as disclosed herein. The ELR-SIG component 1125 is configurable or configured to receive, via a preamble portion of a PPDU associated with an ELR format, an ELR-SIG field that includes two symbols. The two symbols may include a first set of multiple subfields and a second set of multiple subfields, and the ELR parsing component 1130 is configurable or configured to parse the first set of multiple subfields that includes a MCS subfield, a coding subfield associated with a data portion of the PPDU, and one or more of an uplink-downlink indicator subfield, a TxOP identifier subfield, or a last PPDU indicator subfield. In some examples, the ELR parsing component 1130 is configurable or configured to parse the second set of multiple subfields that includes a CRC subfield and a tail subfield. The ELR data component 1135 is configurable or configured to receive, via the data portion of the PPDU, an ELR-data field in accordance with at least the MCS subfield and the coding subfield.

In some examples, the two symbols of the ELR-SIG field are separately encoded, and where each symbol includes an associated tail subfield, and at least one of the two symbols includes the CRC subfield. In some examples, the CRC subfield includes a CRC value, and where the CRC value is based on the first set of multiple subfields which include a BSS color subfield, or is based on the first set of multiple subfields and an implicit indication of a BSS color value when an indication of BSS color is not included in the first set of multiple subfields.

In some examples, the first set of multiple subfields further includes a version number subfield, a station identification subfield, a length subfield that indicates a quantity of symbols in the PPDU, and a BSS color subfield.

In some examples, each symbol of the two symbols of the ELR-SIG field includes an associated tail subfield. In some examples, each symbol of the two symbols of the ELR-SIG field includes an associated CRC subfield, or a single joint CRC subfield associated with both of the two symbols of the ELR-SIG field is included in one of the two symbols.

In some examples, a first symbol of the two symbols of the ELR-SIG field includes the MCS subfield, the coding subfield, a length subfield, and one or more of the uplink-downlink indicator subfield, the TxOP identifier subfield, or the last PPDU indicator subfield. In some examples, a second symbol of the two symbols of the ELR-SIG field includes a station identifier subfield. In some examples, the first set of multiple subfields further include a length subfield that indicates a quantity of symbols in the PPDU, and where the quantity of symbols is indicated to a one-symbol resolution or a two-symbol resolution based on a total quantity of data symbols in the PPDU.

In some examples, the two symbols of the ELR-SIG field include a first symbol and a second symbol and the first symbol is decoded prior to the second symbol, and where the second symbol includes a BSS color subfield. In some examples, the two symbols of the ELR-SIG field include a first symbol and a second symbol and the first symbol is decoded prior to the second symbol, and where a length subfield that indicates a quantity of symbols in the PPDU and a BSS color subfield are included in the first symbol, and a station identification subfield is included in the second symbol.

In some examples, the first set of multiple subfields further include one or more of a version number subfield, a station identification subfield, a length subfield, a LDPC extra symbol segment subfield, a pre-FEC padding factor subfield, a BSS color subfield, or a transmission opportunity identifier subfield. In some examples, one or more subfields of the first set of multiple subfields are included in the ELR-SIG field based on presence of associated information. In some examples, the two symbols of the ELR-SIG field are jointly encoded, and where a single tail subfield and a single CRC subfield are included in the second set of multiple subfields.

In some examples, the ELR-data field is encoded across frequency resources in a set of multiple RUs including a first RU, a second RU, a third RU, and a fourth RU. In some examples, the first RU and the second RU are located on a first side of a center tone of the frequency resources and are separated by at least one tone, the second RU located closer to the center tone than the first RU. In some examples, the third RU and the fourth RU are located on a second side of the center tone and are separated by at least one tone, the third RU located closer to the center tone than the fourth RU. In some examples, at least five tones separate the second RU and the third RU. In some examples, coded bits on each of the RUs are duplicated to each other and an eight-segment mask of [1 1 1 1 −1 1 1 −1] is applied to each of the RUs with each segment value applied to half of a set of data tones in one RU, starting with the first RU. In some examples, the first RU, the second RU, third RU, and the fourth RU include a LTF that is populated on even tone indices of each RU in one or more symbols, and where a Golay complementary pair is used to fill in odd tone indices of each RU in the one or more symbols that include the LTF.

In some examples, the ELR-SIG component 1125 is configurable or configured to maintain a channel busy indication for a wireless channel used for transmission of the PPDU based on a BSS color indicated by the PPDU matching a BSS color of the wireless device and a mismatch between a device identification of the wireless device and a device identification provided by the PPDU, where the channel busy indication is provided for a duration of time that corresponds to a length indication provided in the first set of multiple subfields. In some examples, the preamble portion of the PPDU includes a L-STF and LTF that are power boosted by +3 dB relative to other fields of the preamble portion.

Additionally, or alternatively, the wireless communication device 1100 may support wireless communications in accordance with examples as disclosed herein. In some examples, the ELR-SIG component 1125 is configurable or configured to receive, via a pair of ELR symbols within a preamble portion of a PPDU, an ELR sequence from a set of multiple ELR sequences, the ELR sequence spanning a first ELR symbol of the pair of ELR symbols and a second ELR symbol of the pair of ELR symbols. The ELR sequence may be indicative of BSS information such as a BSS color value, BSS ID, BSS address, or some value specified by an AP, and the ELR mark component 1140 is configurable or configured to determine the BSS information value from a set of multiple BSS information values based on a mapping between the set of multiple ELR sequences and associated BSS color values, BSS IDs, BSS addresses, or other values specified by the AP. In some examples, a quantity of the set of multiple ELR sequence corresponds to a quantity of the set of multiple BSS color values and a length of each ELR sequence of the set of multiple ELR sequences is associated with a quantity of tones within the first ELR symbol and the second ELR symbol. In some examples, the ELR data component 1135 is configurable or configured to selectively receive at least a portion of a remainder of the PPDU after the pair of ELR symbols in accordance with the BSS information value indicated by the ELR sequence.

In some examples, to support selectively receiving at least the portion of the remainder of the PPDU after the set of multiple ELR symbols, the ELR mark component 1140 is configurable or configured to receive at least the portion of the remainder of the PPDU in accordance with a BSS associated with the wireless communication device corresponding to the BSS color value indicated by the ELR sequence. In some examples, to support selectively receiving at least the portion of the remainder of the PPDU after the set of multiple ELR symbols, the ELR mark component 1140 is configurable or configured to refrain from receiving the remainder of the PPDU in accordance with the BSS associated with the wireless communication device corresponding to a different BSS color value than the BSS color value indicated by the ELR sequence.

In some examples, the ELR sequence is a length-96 ELR sequence. In some examples, the first ELR symbol is associated with a first half of the length-96 ELR sequence and the second ELR symbol is associated with a second half of the length-96 ELR sequence. In some examples, the set of multiple ELR sequences are based on values from a set of multiple rows of a Hadamard extension of a Hadamard matrix that is generated according to a Paley construction from a 48-by-48 conference matrix based on a 47-by-47 Q matrix, in which each sequence is associated with a row of the Hadamard extension and each row has a different sequence.

In some examples, the set of multiple ELR sequences are further based on a mask that is applied to the values from the set of multiple rows of the Hadamard extension, where the mask reduces a PAPR for transmission of the set of multiple ELR sequences. In some examples, the set of multiple ELR sequences are further based on a cyclic shift that is applied to one or more rows of the Hadamard extension of the matrix. In some examples, the set of multiple ELR sequences are further based on a QBPSK modulation that is applied to the first ELR symbol and the second ELR symbol.

In some examples, the set of multiple ELR sequences include a first set of ELR sequences that are based on values from a first subset of rows of a Hadamard matrix that are modulated using binary phase shift keying (BPSK) modulation applied to the first ELR symbol and the second ELR symbol and each row of the first subset of rows has a different sequence and is selected from a set of rows of the Hadamard matrix based at least on part on one or more of a PAPR of a transmission of the corresponding sequence or a likelihood of an incorrect BSS color value detection of the corresponding sequence. In some examples, the set of multiple ELR sequences include a second set of ELR sequences that are based on the values from the first subset of rows of the Hadamard matrix that are modulated using QBPSK modulation applied to the first ELR symbol and the second ELR symbol. In some examples, the first ELR symbol includes a first set of dedicated pilot tones located at tone indices of [−21, −7, 7, 21] within the first ELR symbol, the first set of dedicated pilot tones having values equal to (−1)*[1, 1, 1, −1]. In some examples, the second ELR symbol includes a second set of dedicated pilot tones located at tone indices of [−21, −7, 7, 21] within the second ELR symbol, the second set of dedicated pilot tones having values equal to (−1)*[1, 1, 1, −1]. In some examples, where the mapping between the set of multiple ELR sequences and the associated BSS color values excludes the first set of dedicated pilot tones and the second set of dedicated pilot tones.

In some examples, the PPDU is an uplink ELR PPDU that uses the BSS color value, and where uplink ELR PPDUs are prohibited from using a BSS color value of zero. In some examples, the BSS color is indicated in a beacon from an access point associated with the BSS, and is included in one or more uplink ELR PPDUs of one or more transmitting devices of the BSS.

Additionally, or alternatively, the wireless communication device 1100 may support wireless communications in accordance with examples as disclosed herein. In some examples, the ELR-SIG component 1125 is configurable or configured to transmit, via a preamble portion of a PPDU associated with an ELR format, an ELR-SIG field that includes two symbols, the two symbols including. The ELR preamble formatting component 1145 is configurable or configured to format a first set of multiple subfields include a MCS subfield, a coding subfield associated with a data portion of the PPDU, and one or more of an uplink-downlink indicator subfield, a TxOP identifier subfield, or a last PPDU indicator subfield. In some examples, the ELR preamble formatting component 1145 is configurable or configured to format a second set of multiple subfields include a CRC subfield and a tail subfield. In some examples, the ELR data component 1135 is configurable or configured to transmit via the data portion of the PPDU, an ELR-data field in accordance with at least the MCS subfield and the coding subfield.

In some examples, the two symbols of the ELR-SIG field are separately encoded, and where each symbol includes an associated tail subfield, and at least one of the two symbols includes the CRC subfield. In some examples, the first set of multiple subfields further includes a version number subfield, a station identification subfield, a length subfield that indicates a quantity of symbols in the PPDU, and a BSS color subfield. In some examples, each symbol of the two symbols of the ELR-SIG field includes an associated tail subfield. In some examples, each symbol of the two symbols of the ELR-SIG field includes an associated CRC subfield, or a single joint CRC subfield associated with both of the two symbols of the ELR-SIG field is included in one of the two symbols.

In some examples, a first symbol of the two symbols of the ELR-SIG field includes the MCS subfield, the coding subfield, a length subfield, and one or more of the uplink-downlink indicator subfield, the TxOP identifier subfield, or the last PPDU indicator subfield. In some examples, a second symbol of the two symbols of the ELR-SIG field includes a station identifier subfield. In some examples, the first set of multiple subfields further include a length subfield that indicates a quantity of symbols in the PPDU, and where the quantity of symbols is indicated to a one-symbol resolution or a two-symbol resolution based on a total quantity of data symbols in the PPDU.

In some examples, the two symbols of the ELR-SIG field include a first symbol and a second symbol and the first symbol is decoded prior to the second symbol, and where the second symbol includes a BSS color subfield. In some examples, the two symbols of the ELR-SIG field include a first symbol and a second symbol and the first symbol is decoded prior to the second symbol, and where a length subfield that indicates a quantity of symbols in the PPDU and a BSS color subfield are included in the first symbol, and a station identification subfield is included in the second symbol. In some examples, the two symbols of the ELR-SIG field are jointly encoded, and where a single tail subfield and a single CRC subfield are included in the second set of multiple subfields.

In some examples, the first set of multiple subfields further include one or more of a version number subfield, a station identification subfield, a length subfield, a LDPC extra symbol segment subfield, a pre-FEC padding factor subfield, a BSS color subfield, or a transmission opportunity identifier subfield. In some examples, one or more subfields of the first set of multiple subfields are included in the ELR-SIG field based on presence of associated information.

In some examples, the ELR-data field is encoded across frequency resources in a set of multiple RUs including a first RU, a second RU, a third RU, and a fourth RU. In some examples, the first RU and the second RU are located on a first side of a center tone of the frequency resources and are separated by at least one tone, the second RU located closer to the center tone than the first RU. In some examples, the third RU and the fourth RU are located on a second side of the center tone and are separated by at least one tone, the third RU located closer to the center tone than the fourth RU. In some examples, at least five tones separate the second RU and the third RU.

In some examples, the preamble portion of the PPDU includes a L-STF and LTF that are power boosted by 3 dB relative to other fields of the preamble portion.

Additionally, or alternatively, the wireless communication device 1100 may support wireless communications in accordance with examples as disclosed herein. In some examples, the ELR-SIG component 1125 is configurable or configured to transmit, via a pair of ELR symbols within a preamble portion of a PPDU, an ELR sequence from a set of multiple ELR sequences, the ELR sequence spanning a first ELR symbol of the pair of ELR symbols and a second ELR symbol of the pair of ELR symbols. In some examples, the ELR sequence is indicative of a BSS information value from a set of multiple BSS information values, and the ELR mark component 1140 is configurable or configured to determine from the the ELR sequence the set of multiple BSS information values based on a mapping between the set of multiple ELR sequences and associated BSS information values such as BSS color values, BSS IDs, BSS addresses, or other values specified by the AP. In some examples, a quantity of the set of multiple ELR sequence corresponds to a quantity of the set of multiple BSS color values, BSS IDs, BSS addresses, or other values specified by the AP, and a length of each ELR sequence of the set of multiple ELR sequences is associated with a quantity of tones within the first ELR symbol and the second ELR symbol. In some examples, the ELR data component 1135 is configurable or configured to transmit, via a set of multiple ELR data symbols within a data portion of the PPDU, a data payload associated with the BSS color value.

In some examples, the ELR sequence is a length-96 ELR sequence. In some examples, the first ELR symbol is associated with a first half of the length-96 ELR sequence and the second ELR symbol is associated with a second half of the length-96 ELR sequence. In some examples, the set of multiple ELR sequences are based on values from a set of multiple rows of a Hadamard extension of a Hadamard matrix that is generated according to a Paley construction from a 48-by-48 conference matrix based on a 47-by-47 Q matrix, in which each sequence is associated with a row of the Hadamard extension and each row has a different sequence. In some examples, the set of multiple ELR sequences are further based on a mask that is applied to the values from the set of multiple rows of the Hadamard extension, where the mask reduces a PAPR for transmission of the set of multiple ELR sequences. In some examples, the set of multiple ELR sequences are further based on a cyclic shift that is applied to one or more rows of the Hadamard extension of the matrix.

In some examples, the set of multiple ELR sequences are further based on a QBPSK modulation that is applied to the first ELR symbol and the second ELR symbol.

In some examples, the first ELR symbol includes a first set of dedicated pilot tones located at tone indices of [−21, −7, 7, 21] within the first ELR symbol, the first set of dedicated pilot tones having values equal to (−1)*[1, 1, 1, −1]. In some examples, the second ELR symbol includes a second set of dedicated pilot tones located at tone indices of [−21, −7, 7, 21] within the second ELR symbol, the second set of dedicated pilot tones having values equal to (−1)*[1, 1, 1, −1]. In some examples, where the mapping between the set of multiple ELR sequences and the associated BSS color values excludes the first set of dedicated pilot tones and the second set of dedicated pilot tones.

In some examples, the PPDU is an uplink ELR PPDU that uses the BSS color value, and where uplink ELR PPDUs are prohibited from using a BSS color value of zero. In some examples, the BSS color is indicated in a beacon from an access point associated with the BSS, and is included in one or more uplink ELR PPDUs of one or more transmitting devices of the BSS.

FIG. 12 shows a flowchart illustrating an example process 1200 performable by or at a wireless device that supports signaling designs for ELR transmissions. The operations of the process 1200 may be implemented by a wireless device or its components as described herein. For example, the process 1200 may be performed by a wireless communication device, such as the wireless communication device 1100 described with reference to FIG. 11, operating as or within a wireless AP or a wireless STA. In some examples, the process 1200 may be performed by a wireless AP or a wireless STA, such as one of the APs 102 or the STAs 104 described with reference to FIG. 1.

In some examples, in 1205, the wireless device may receive, via a preamble portion of a PPDU associated with an ELR format, an ELR-SIG field that includes two symbols, the two symbols including a first set of multiple subfields include a MCS subfield, a coding subfield associated with a data portion of the PPDU, and one or more of an uplink-downlink indicator subfield, a TxOP identifier subfield, or a last PPDU indicator subfield, and a second set of multiple subfields include an CRC subfield and a tail subfield. The operations of 1205 may be performed in accordance with examples as disclosed herein. In some implementations, aspects of the operations of 1205 for receiving the preamble portion of the PPDU may be performed by an ELR-SIG component 1125 as described with reference to FIG. 11, and aspects related to parsing the subfields of the ELR-SIG field may be performed by an ELR parsing component 1130 as described with reference to FIG. 11.

In some examples, in 1210, the wireless device may receive, via the data portion of the PPDU, an ELR-data field in accordance with at least the MCS subfield and the coding subfield. The operations of 1210 may be performed in accordance with examples as disclosed herein. In some implementations, aspects of the operations of 1210 may be performed by an ELR data component 1135 as described with reference to FIG. 11.

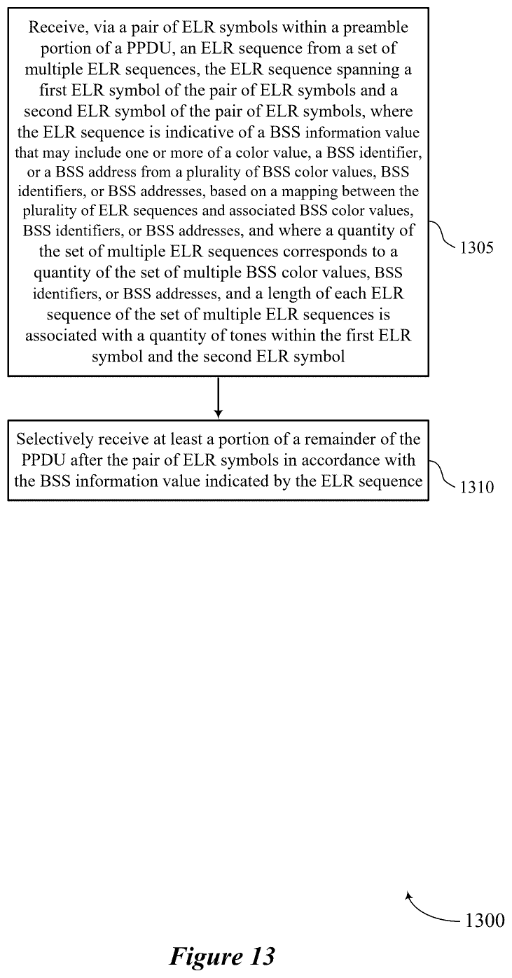

FIG. 13 shows a flowchart illustrating an example process 1300 performable by or at a wireless device that supports signaling designs for ELR transmissions. The operations of the process 1300 may be implemented by a wireless device or its components as described herein. For example, the process 1300 may be performed by a wireless communication device, such as the wireless communication device 1100 described with reference to FIG. 11, operating as or within a wireless AP or a wireless STA. In some examples, the process 1300 may be performed by a wireless AP or a wireless STA, such as one of the APs 102 or the STAs 104 described with reference to FIG. 1.

In some examples, in 1305, the wireless device may receive, via a pair of ELR symbols within a preamble portion of a PPDU, an ELR sequence from a set of multiple ELR sequences, the ELR sequence spanning a first ELR symbol of the pair of ELR symbols and a second ELR symbol of the pair of ELR symbols, where the ELR sequence is indicative of a BSS information value that may include one or more of a color value, a BSS identifier, a BSS address, or some value specified by an AP, from a plurality of BSS color values, BSS identifiers, BSS addresses, or other values specified by the AP, based on a mapping between the plurality of ELR sequences and associated BSS color values, BSS identifiers, BSS addresses, or other values specified by the AP, and where a quantity of the set of multiple ELR sequences corresponds to a quantity of the set of multiple BSS color values, BSS identifiers, BSS addresses, or other values, and a length of each ELR sequence of the set of multiple ELR sequences is associated with a quantity of tones within the first ELR symbol and the second ELR symbol. The operations of 1305 may be performed in accordance with examples as disclosed herein. In some implementations, aspects of the operations of 1305 for receiving the ELR sequence may be performed by an ELR-SIG component 1125 as described with reference to FIG. 11, and aspects related to BSS color values in the ELR sequence may be performed by an ELR mark component 1140 as described with reference to FIG. 11.

In some examples, in 1310, the wireless device may selectively receive at least a portion of a remainder of the PPDU after the pair of ELR symbols in accordance with the BSS color value indicated by the ELR sequence. The operations of 1310 may be performed in accordance with examples as disclosed herein. In some implementations, aspects of the operations of 1310 may be performed by an ELR data component 1135 as described with reference to FIG. 11.

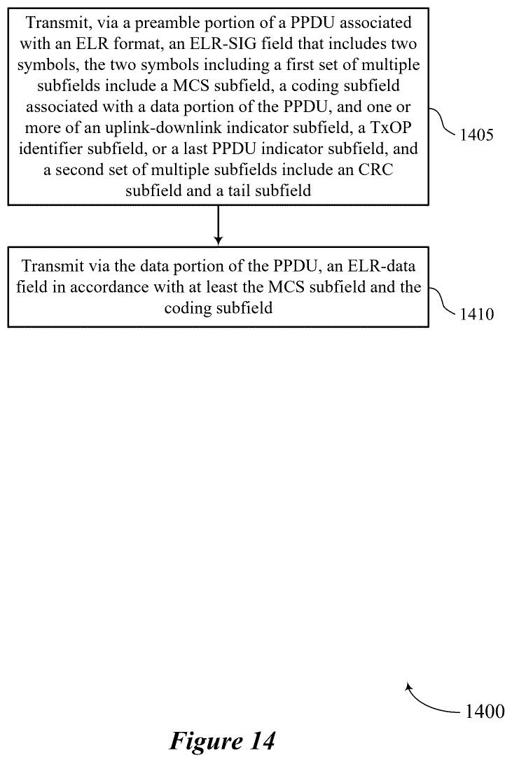

FIG. 14 shows a flowchart illustrating an example process 1400 performable by or at a wireless device that supports signaling designs for ELR transmissions. The operations of the process 1400 may be implemented by a wireless device or its components as described herein. For example, the process 1400 may be performed by a wireless communication device, such as the wireless communication device 1100 described with reference to FIG. 11, operating as or within a wireless AP or a wireless STA. In some examples, the process 1400 may be performed by a wireless AP or a wireless STA, such as one of the APs 102 or the STAs 104 described with reference to FIG. 1.

In some examples, in 1405, the wireless device may transmit, via a preamble portion of a PPDU associated with an ELR format, an ELR-SIG field that includes two symbols, the two symbols including a first set of multiple subfields include a MCS subfield, a coding subfield associated with a data portion of the PPDU, and one or more of an uplink-downlink indicator subfield, a TxOP identifier subfield, or a last PPDU indicator subfield, and. The operations of 1405 may be performed in accordance with examples as disclosed herein. In some implementations, aspects of the operations of 1405 for transmitting the preamble portion of the PPDU may be performed by an ELR-SIG component 1125 as described with reference to FIG. 11, and aspects related to formatting the subfields of the ELR-SIG field may be performed by ELR preamble formatting component 1145 as described with reference to FIG. 11.

In some examples, in 1420, the wireless device may transmit via the data portion of the PPDU, an ELR-data field in accordance with at least the MCS subfield and the coding subfield. The operations of 1420 may be performed in accordance with examples as disclosed herein. In some implementations, aspects of the operations of 1420 may be performed by an ELR data component 1135 as described with reference to FIG. 11.

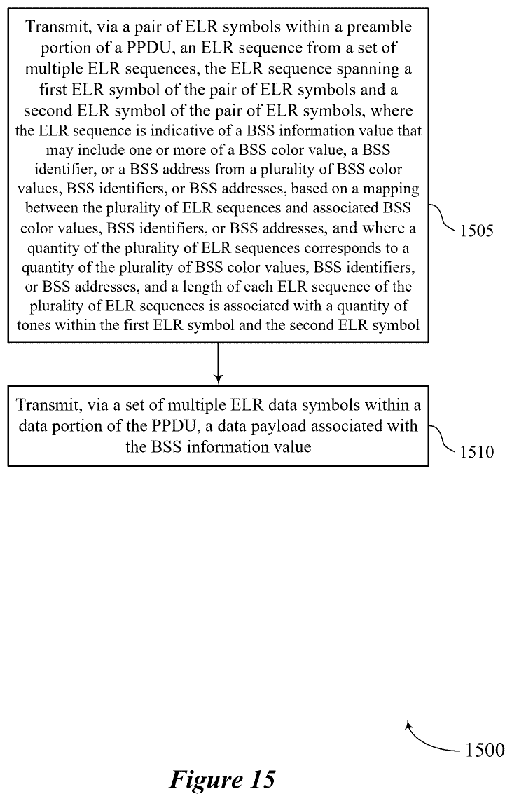

FIG. 15 shows a flowchart illustrating an example process 1500 performable by or at a wireless device that supports signaling designs for ELR transmissions. The operations of the process 1500 may be implemented by a wireless device or its components as described herein. For example, the process 1500 may be performed by a wireless communication device, such as the wireless communication device 1100 described with reference to FIG. 11, operating as or within a wireless AP or a wireless STA. In some examples, the process 1500 may be performed by a wireless AP or a wireless STA, such as one of the APs 102 or the STAs 104 described with reference to FIG. 1.

In some examples, in 1505, the wireless device may transmit, via a pair of ELR symbols within a preamble portion of a PPDU, an ELR sequence from a set of multiple ELR sequences, the ELR sequence spanning a first ELR symbol of the pair of ELR symbols and a second ELR symbol of the pair of ELR symbols, where the ELR sequence be of a BSS information value that may include one or more of a color value, a BSS identifier, or a BSS address from a plurality of BSS color values, BSS identifiers, or BSS addresses, based on a mapping between the plurality of ELR sequences and associated BSS color values, BSS identifiers, or BSS addresses, and where a quantity of the set of multiple ELR sequence corresponds to a quantity of the set of multiple BSS color values, BSS identifiers, or BSS addresses and a length of each ELR sequence of the set of multiple ELR sequences is associated with a quantity of tones within the first ELR symbol and the second ELR symbol. The operations of 1505 may be performed in accordance with examples as disclosed herein. In some implementations, aspects of the operations of 1505 for transmitting the ELR sequence may be performed by an ELR-SIG component 1125 as described with reference to FIG. 11, and aspects related to BSS color values in the ELR sequence may be performed by an ELR mark component 1140 as described with reference to FIG. 11.

In some examples, in 1510, the wireless device may transmit, via a set of multiple ELR data symbols within a data portion of the PPDU, a data payload associated with the BSS information value. The operations of 1510 may be performed in accordance with examples as disclosed herein. In some implementations, aspects of the operations of 1510 may be performed by an ELR data component 1135 as described with reference to FIG. 11.

Implementation examples are described in the following numbered clauses:

Clause 1: A method for wireless communications at a wireless device, comprising: receiving, via a preamble portion of a PPDU associated with an ELR format, an ELR-SIG field that comprises two symbols, the two symbols comprising: a first plurality of subfields comprising a MCS subfield, a coding subfield associated with a data portion of the PPDU, and one or more of an uplink-downlink indicator subfield, a TxOP identifier subfield, or a last PPDU indicator subfield, and a second plurality of subfields comprising an CRC subfield and a tail subfield; and receiving, via the data portion of the PPDU, an ELR-data field in accordance with at least the MCS subfield and the coding subfield.

Clause 2: The method of clause 1, wherein the two symbols of the ELR-SIG field are separately encoded, and wherein each symbol comprises an associated tail subfield, and at least one of the two symbols comprises the CRC subfield.

Clause 3: The method of any of clauses 1 through 2, wherein the CRC subfield includes a CRC value, and wherein the CRC value is based on the first plurality of subfields which include a BSS color subfield, or is based on the first plurality of subfields and an implicit indication of a BSS color value when an indication of BSS color is not included in the first plurality of subfields.

Clause 4: The method of any of clauses 1 through 3, wherein the first plurality of subfields further comprises a version number subfield, a station identification subfield, a length subfield that indicates a quantity of symbols in the PPDU, and a BSS color subfield.

Clause 5: The method of any of clauses 1 through 4, wherein each symbol of the two symbols of the ELR-SIG field includes an associated tail subfield, and each symbol of the two symbols of the ELR-SIG field includes an associated CRC subfield, or a single joint CRC subfield associated with both of the two symbols of the ELR-SIG field is included in one of the two symbols.

Clause 6: The method of any of clauses 1 through 5, wherein a first symbol of the two symbols of the ELR-SIG field includes the MCS subfield, the coding subfield, a length subfield, and one or more of the uplink-downlink indicator subfield, the TxOP identifier subfield, or the last PPDU indicator subfield, and a second symbol of the two symbols of the ELR-SIG field includes a station identifier subfield.

Clause 7: The method of any of clauses 1 through 6, wherein the first plurality of subfields further comprise a length subfield that indicates a quantity of symbols in the PPDU, and wherein the quantity of symbols is indicated to a one-symbol resolution or a two-symbol resolution based on a total quantity of data symbols in the PPDU.

Clause 8: The method of any of clauses 1 through 7, wherein the two symbols of the ELR-SIG field include a first symbol and a second symbol and the first symbol is decoded prior to the second symbol, and wherein the second symbol includes a basic service set (BSS) color subfield.

Clause 9: The method of any of clauses 1 through 8, wherein the two symbols of the ELR-SIG field include a first symbol and a second symbol and the first symbol is decoded prior to the second symbol, and wherein a length subfield that indicates a quantity of symbols in the PPDU and a basic service set (BSS) color subfield are included in the first symbol, and a station identification subfield is included in the second symbol.

Clause 10: The method of clause 9, wherein the first plurality of subfields further comprise one or more of a version number subfield, a station identification subfield, a length subfield, a LDPC extra symbol segment subfield, a pre-FEC padding factor subfield, a BSS color subfield, or a transmission opportunity identifier subfield.

Clause 11: The method of clause 10, wherein one or more subfields of the first plurality of subfields are included in the ELR-SIG field based at least in part on presence of associated information.

Clause 12: The method of any of clauses 1 through 11, wherein the two symbols of the ELR-SIG field are jointly encoded, and wherein a single tail subfield and a single CRC subfield are included in the second plurality of subfields.

Clause 13: The method of any of clauses 1 through 12, wherein the ELR-data field is encoded across frequency resources in a plurality of RUs including a first RU, a second RU, a third RU, and a fourth RU, the first RU and the second RU are located on a first side of a center tone of the frequency resources and are separated by at least one tone, the second RU located closer to the center tone than the first RU, the third RU and the fourth RU are located on a second side of the center tone and are separated by at least one tone, the third RU located closer to the center tone than the fourth RU, and at least five tones separate the second RU and the third RU.

Clause 14: The method of clause 13 wherein the first RU, the second RU, third RU, and the fourth RU include a LTF that is populated on even tone indices of each RU in one or more symbols, and wherein a Golay complementary pair is used to fill in odd tone indices of each RU in the one or more symbols that include the LTF.

Clause 15: The method of any of clauses 1 through 14, further comprising: maintaining a channel busy indication for a wireless channel used for transmission of the PPDU based on a BSS color indicated by the PPDU matching a BSS color of the wireless device and a mismatch between a device identification of the wireless device and a device identification provided by the PPDU, wherein the channel busy indication is provided for a duration of time that corresponds to a length indication provided in the first plurality of subfields.

Clause 16: The method of any of clauses 1 through 15, wherein the preamble portion of the PPDU includes a L-STF and LTF that are power boosted by 3 dB relative to other fields of the preamble portion.

Clause 17: A method for wireless communications at a wireless device, comprising: receiving, via a pair of ELR symbols within a preamble portion of a PPDU, an ELR sequence from a plurality of ELR sequences, the ELR sequence spanning a first ELR symbol of the pair of ELR symbols and a second ELR symbol of the pair of ELR symbols, wherein the ELR sequence is indicative of a BSS information value that may include one or more of a BSS color value, a BSS identifier, or a BSS address from a plurality of BSS color values, BSS identifiers, or BSS addresses, based on a mapping between the plurality of ELR sequences and associated BSS color values, BSS identifiers, or BSS addresses, and wherein a quantity of the plurality of ELR sequences corresponds to a quantity of the plurality of BSS color values, BSS identifiers, or BSS addresses, and a length of each ELR sequence of the plurality of ELR sequences is associated with a quantity of tones within the first ELR symbol and the second ELR symbol; and selectively receiving at least a portion of a remainder of the PPDU after the pair of ELR symbols in accordance with the BSS information value indicated by the ELR sequence.

Clause 18: The method of clause 17, wherein selectively receiving at least the portion of the remainder of the PPDU after the plurality of ELR symbols comprises: receiving at least the portion of the remainder of the PPDU in accordance with a BSS associated with the wireless communication device corresponding to the BSS color value indicated by the ELR sequence; or refraining from receiving the remainder of the PPDU in accordance with the BSS associated with the wireless communication device corresponding to a different BSS color value than the BSS color value indicated by the ELR sequence.

Clause 19: The method of any of clauses 17 through 18, wherein the ELR sequence is a length-96 ELR sequence; the first ELR symbol is associated with a first half of the length-96 ELR sequence and the second ELR symbol is associated with a second half of the length-96 ELR sequence; and the plurality of ELR sequences are based on values from a plurality of rows of a Hadamard extension of a Hadamard matrix that is generated according to a Paley construction from a 48-by-48 conference matrix based on a 47-by-47 Q matrix, in which each sequence is associated with a row of the Hadamard extension and each row has a different sequence.

Clause 20: The method of clause 19, wherein the plurality of ELR sequences are further based on a cyclic shift that is applied to one or more rows of the Hadamard extension of the matrix.

Clause 21: The method of any of clauses 19 through 20, wherein the plurality of ELR sequences are further based on a quadrature binary phase shift keying (QBPSK) modulation that is applied to the first ELR symbol and the second ELR symbol.

Clause 22: The method of any of clauses 17 through 21, wherein the plurality of ELR sequences include a first set of ELR sequences that are based on values from a first subset of rows of a Hadamard matrix that are modulated using BPSK modulation applied to the first ELR symbol and the second ELR symbol and each row of the first subset of rows has a different sequence and is selected from a set of rows of the Hadamard matrix based at least on part on one or more of a PAPR of a transmission of the corresponding sequence or a likelihood of an incorrect BSS color value detection of the corresponding sequence, and the plurality of ELR sequences include a second set of ELR sequences that are based on the values from the first subset of rows of the Hadamard matrix that are modulated using QBPSK modulation applied to the first ELR symbol and the second ELR symbol.

Clause 23: The method of any of clauses 17 through 22, wherein the first ELR symbol includes a first set of dedicated pilot tones located at tone indices of [−21, −7, 7, 21] within the first ELR symbol, the first set of dedicated pilot tones having values equal to (−1)*[1, 1, 1, −1]; and the second ELR symbol includes a second set of dedicated pilot tones located at tone indices of [−21, −7, 7, 21] within the second ELR symbol, the second set of dedicated pilot tones having values equal to (−1)*[1, 1, 1, −1].

Clause 24: The method of clause 23, wherein the mapping between the plurality of ELR sequences and the associated BSS color values excludes the first set of dedicated pilot tones and the second set of dedicated pilot tones.

Clause 25: The method of any of clauses 17 through 24, wherein the PPDU is an uplink ELR PPDU that uses the BSS color value, and wherein uplink ELR PPDUS are prohibited from using a BSS color value of zero.

Clause 26: The method of clause 25, wherein the BSS color is indicated in a beacon from an access point associated with the BSS, and is included in one or more uplink ELR PPDUs of one or more transmitting devices of the BSS.

Clause 27: A method for wireless communications at a wireless device, comprising: transmitting, via a preamble portion of a PPDU associated with an ELR format, an ELR-SIG field that comprises two symbols, the two symbols comprising: a first plurality of subfields comprising a MCS subfield, a coding subfield associated with a data portion of the PPDU, and one or more of an uplink-downlink indicator subfield, a TxOP identifier subfield, or a last PPDU indicator subfield, and a second plurality of subfields comprising an CRC subfield and a tail subfield; and transmitting via the data portion of the PPDU, an ELR-data field in accordance with at least the MCS subfield and the coding subfield.

Clause 28: The method of clause 27, wherein the two symbols of the ELR-SIG field are separately encoded, and wherein each symbol comprises an associated tail subfield, and at least one of the two symbols comprises the CRC subfield.

Clause 29: The method of any of clauses 27 through 28, wherein the first plurality of subfields further comprises a version number subfield, a station identification subfield, a length subfield that indicates a quantity of symbols in the PPDU, and a BSS color subfield.

Clause 30: The method of any of clauses 27 through 29, wherein each symbol of the two symbols of the ELR-SIG field includes an associated tail subfield, and each symbol of the two symbols of the ELR-SIG field includes an associated CRC subfield, or a single joint CRC subfield associated with both of the two symbols of the ELR-SIG field is included in one of the two symbols.

Clause 31: The method of any of clauses 27 through 30, wherein a first symbol of the two symbols of the ELR-SIG field includes the MCS subfield, the coding subfield, a length subfield, and one or more of the uplink-downlink indicator subfield, the TxOP identifier subfield, or the last PPDU indicator subfield, and a second symbol of the two symbols of the ELR-SIG field includes a station identifier subfield.

Clause 32: The method of any of clauses 27 through 31, wherein the first plurality of subfields further comprise a length subfield that indicates a quantity of symbols in the PPDU, and wherein the quantity of symbols is indicated to a one-symbol resolution or a two-symbol resolution based on a total quantity of data symbols in the PPDU.

Clause 33: The method of any of clauses 27 through 32, wherein the two symbols of the ELR-SIG field include a first symbol and a second symbol and the first symbol is decoded prior to the second symbol, and wherein the second symbol includes a basic service set (BSS) color subfield.

Clause 34: The method of any of clauses 27 through 33, wherein the two symbols of the ELR-SIG field include a first symbol and a second symbol and the first symbol is decoded prior to the second symbol, and wherein a length subfield that indicates a quantity of symbols in the PPDU and a BSS color subfield are included in the first symbol, and a station identification subfield is included in the second symbol.

Clause 35: The method of any of clauses 27 through 34, wherein the two symbols of the ELR-SIG field are jointly encoded, and wherein a single tail subfield and a single CRC subfield are included in the second plurality of subfields.

Clause 36: The method of clause 35, wherein the first plurality of subfields further comprise one or more of a version number subfield, a station identification subfield, a length subfield, a LDPC extra symbol segment subfield, a pre-FEC padding factor subfield, a basic service set (BSS) color subfield, or a transmission opportunity identifier subfield.

Clause 37: The method of clause 36, wherein one or more subfields of the first plurality of subfields are included in the ELR-SIG field based at least in part on presence of associated information.

Clause 38: The method of any of clauses 27 through 37, wherein the ELR-data field is encoded across frequency resources in a plurality of RUs including a first RU, a second RU, a third RU, and a fourth RU, the first RU and the second RU are located on a first side of a center tone of the frequency resources and are separated by at least one tone, the second RU located closer to the center tone than the first RU, the third RU and the fourth RU are located on a second side of the center tone and are separated by at least one tone, the third RU located closer to the center tone than the fourth RU, and at least five tones separate the second RU and the third RU.

Clause 39: The method of any of clauses 27 through 38, wherein the preamble portion of the PPDU includes a L-STF and LTF that are power boosted by 3 dB relative to other fields of the preamble portion.

Clause 40: A method for wireless communications at a wireless device, comprising: transmitting, via a pair of ELR symbols within a preamble portion of a PPDU, an ELR sequence from a plurality of ELR sequences, the ELR sequence spanning a first ELR symbol of the pair of ELR symbols and a second ELR symbol of the pair of ELR symbols, wherein the ELR sequence is indicative of a BSS color value from a plurality of BSS color values based on a mapping between the plurality of ELR sequences and associated BSS color values, and wherein a quantity of the plurality of ELR sequences corresponds to a quantity of the plurality of BSS color values and a length of each ELR sequence of the plurality of ELR sequences is associated with a quantity of tones within the first ELR symbol and the second ELR symbol; and transmitting, via a plurality of ELR data symbols within a data portion of the PPDU, a data payload associated with the BSS color value.

Clause 41: The method of clause 40, wherein the ELR sequence is a length-96 ELR sequence; the first ELR symbol is associated with a first half of the length-96 ELR sequence and the second ELR symbol is associated with a second half of the length-96 ELR sequence; and the plurality of ELR sequences are based on values from a plurality of rows of a Hadamard extension of a Hadamard matrix that is generated according to a Paley construction from a 48-by-48 conference matrix based on a 47-by-47 Q matrix, in which each sequence is associated with a row of the Hadamard extension and each row has a different sequence.

Clause 43: The method of any of clauses 41 through 42, wherein the plurality of ELR sequences are further based on a QBPSK modulation that is applied to the first ELR symbol and the second ELR symbol.

Clause 44: The method of any of clauses 40 through 43, wherein the first ELR symbol includes a first set of dedicated pilot tones located at tone indices of [−21, −7, 7, 21] within the first ELR symbol, the first set of dedicated pilot tones having values equal to (−1)*[1, 1, 1, −1]; and the second ELR symbol includes a second set of dedicated pilot tones located at tone indices of [−21, −7, 7, 21] within the second ELR symbol, the second set of dedicated pilot tones having values equal to (−1)*[1, 1, 1, −1].

Clause 45: The method of clause 44, wherein the mapping between the plurality of ELR sequences and the associated BSS color values excludes the first set of dedicated pilot tones and the second set of dedicated pilot tones.

Clause 46: The method of any of clauses 40 through 45, wherein the PPDU is an uplink ELR PPDU that uses the BSS color value, and wherein uplink ELR PPDUS are prohibited from using a BSS color value of zero.

Clause 47: The method of clause 46, wherein the BSS color is indicated in a beacon from an access point associated with the BSS, and is included in one or more uplink ELR PPDUs of one or more transmitting devices of the BSS.

Clause 48: A wireless device for wireless communications, comprising one or more memories storing processor-executable code, and one or more processors coupled with the one or more memories and individually or collectively operable to execute the code to cause the wireless device to perform a method of any of clauses 1 through 16.

Clause 49: A wireless device for wireless communications, comprising at least one means for performing a method of any of clauses 1 through 16.

Clause 50: A non-transitory computer-readable medium storing code for wireless communications, the code comprising instructions executable by one or more processors to perform a method of any of clauses 1 through 16.

Clause 51: A wireless device for wireless communications, comprising one or more memories storing processor-executable code, and one or more processors coupled with the one or more memories and individually or collectively operable to execute the code to cause the wireless device to perform a method of any of clauses 17 through 26.

Clause 52: A wireless device for wireless communications, comprising at least one means for performing a method of any of clauses 17 through 26.

Clause 53: A non-transitory computer-readable medium storing code for wireless communications, the code comprising instructions executable by one or more processors to perform a method of any of clauses 17 through 26.

Clause 54: A wireless device for wireless communications, comprising one or more memories storing processor-executable code, and one or more processors coupled with the one or more memories and individually or collectively operable to execute the code to cause the wireless device to perform a method of any of clauses 27 through 39.

Clause 55: A wireless device for wireless communications, comprising at least one means for performing a method of any of clauses 27 through 39.

Clause 56: A non-transitory computer-readable medium storing code for wireless communications, the code comprising instructions executable by one or more processors to perform a method of any of clauses 27 through 39.

Clause 57: A wireless device for wireless communications, comprising one or more memories storing processor-executable code, and one or more processors coupled with the one or more memories and individually or collectively operable to execute the code to cause the wireless device to perform a method of any of clauses 40 through 47.

Clause 58: A wireless device for wireless communications, comprising at least one means for performing a method of any of clauses 40 through 47.

Clause 59: A non-transitory computer-readable medium storing code for wireless communications, the code comprising instructions executable by one or more processors to perform a method of any of clauses 40 through 47.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A wireless device, comprising:
a processing system that includes processor circuitry and memory circuitry that stores code, the processing system configured to cause the wireless device to:
receive, via a preamble portion of a physical layer (PHY) protocol data unit (PPDU) associated with an enhanced long range (ELR) format, an ELR-signal (ELR-SIG) field that comprises two symbols, the two symbols comprising:
a first plurality of subfields comprise a modulation and coding scheme (MCS) subfield, a coding subfield associated with a data portion of the PPDU, and one or more of an uplink-downlink indicator subfield, a transmission opportunity (TxOP) identifier subfield, or a last PPDU indicator subfield, and
a second plurality of subfields comprise a cyclic redundancy check (CRC) subfield and a tail subfield; and
receive, via the data portion of the PPDU, an ELR-data field in accordance with at least the MCS subfield and the coding subfield.

2. The wireless device of claim 1, wherein the two symbols of the ELR-SIG field are separately encoded, and wherein each symbol comprises an associated tail subfield, and at least one of the two symbols comprises the CRC subfield.

3. The wireless device of claim 1, wherein the CRC subfield includes a CRC value, and wherein the CRC value is based on the first plurality of subfields which include a basic service set (BSS) color subfield, or is based on the first plurality of subfields and an implicit indication of a BSS color value when an indication of BSS color is not included in the first plurality of subfields.

4. The wireless device of claim 1, wherein the first plurality of subfields further comprises a version number subfield, a station identification subfield, a length subfield that indicates a quantity of symbols in the PPDU, and a basic service set (BSS) color subfield.

5. The wireless device of claim 1, wherein:
each symbol of the two symbols of the ELR-SIG field includes an associated tail subfield, and
each symbol of the two symbols of the ELR-SIG field includes an associated CRC subfield, or a single joint CRC subfield associated with both of the two symbols of the ELR-SIG field is included in one of the two symbols.

6. The wireless device of claim 1, wherein:
a first symbol of the two symbols of the ELR-SIG field includes the MCS subfield, the coding subfield, a length subfield, and one or more of the uplink-downlink indicator subfield, the TxOP identifier subfield, or the last PPDU indicator subfield, and
a second symbol of the two symbols of the ELR-SIG field includes a station identifier subfield.

7. The wireless device of claim 1, wherein the first plurality of subfields further comprise a length subfield that indicates a quantity of symbols in the PPDU, and wherein the quantity of symbols is indicated to a one-symbol resolution or a two-symbol resolution based on a total quantity of data symbols in the PPDU.

8. The wireless device of claim 1, wherein the two symbols of the ELR-SIG field include a first symbol and a second symbol and the first symbol is decoded prior to the second symbol, and wherein the second symbol includes a basic service set (BSS) color subfield.

9. The wireless device of claim 1, wherein the two symbols of the ELR-SIG field include a first symbol and a second symbol and the first symbol is decoded prior to the second symbol, and wherein a length subfield that indicates a quantity of symbols in the PPDU and a basic service set (BSS) color subfield are included in the first symbol, and a station identification subfield is included in the second symbol.

10. The wireless device of claim 9, wherein the first plurality of subfields further comprise one or more of a version number subfield, a station identification subfield, a length subfield, a low density parity check (LDPC) extra symbol segment subfield, a pre-forward error correction (FEC) padding factor subfield, a basic service set (BSS) color subfield, or a transmission opportunity identifier subfield.

11. The wireless device of claim 10, wherein one or more subfields of the first plurality of subfields are included in the ELR-SIG field based at least in part on presence of associated information.

12. The wireless device of claim 1, wherein the two symbols of the ELR-SIG field are jointly encoded, and wherein a single tail subfield and a single CRC subfield are included in the second plurality of subfields.

13. The wireless device of claim 1, wherein:
the ELR-data field is encoded across frequency resources in a plurality of resource units (RUs) including a first RU, a second RU, a third RU, and a fourth RU,
the first RU and the second RU are located on a first side of a center tone of the frequency resources and are separated by at least one tone, the second RU located closer to the center tone than the first RU,
the third RU and the fourth RU are located on a second side of the center tone and are separated by at least one tone, the third RU located closer to the center tone than the fourth RU, and
at least five tones separate the second RU and the third RU.

14. The wireless device of claim 13, wherein coded bits on each of the RUs are duplicated to each other and an eight-segment mask of [1 1 1 1 −1 1 1 −1] is applied to each of the RUs with each segment value applied to half of a set of data tones in one RU, starting with the first RU.

15. The wireless device of claim 13, wherein the first RU, the second RU, third RU, and the fourth RU include a long training field (LTF) that is populated on even tone indices of each RU in one or more symbols, and wherein a Golay complementary pair is used to fill in odd tone indices of each RU in the one or more symbols that include the LTF.

16. The wireless device of claim 1, wherein the processing system is further configured to cause the wireless device to:
maintain a channel busy indication for a wireless channel used for transmission of the PPDU based on a basic service set (BSS) color indicated by the PPDU matching a BSS color of the wireless device and a mismatch between a device identification of the wireless device and a device identification provided by the PPDU, wherein the channel busy indication is provided for a duration of time that corresponds to a length indication provided in the first plurality of subfields.

17. The wireless device of claim 1, wherein the preamble portion of the PPDU includes a legacy short training field (L-STF) and long training field (LTF) that are power boosted by 3 dB relative to other fields of the preamble portion.

18. A wireless device, comprising:
a processing system that includes processor circuitry and memory circuitry that stores code, the processing system configured to cause the wireless device to:
receive, via a pair of enhanced long range (ELR) symbols within a preamble portion of a physical layer (PHY) protocol data unit (PPDU), an ELR sequence from a plurality of ELR sequences, the ELR sequence spanning a first ELR symbol of the pair of ELR symbols and a second ELR symbol of the pair of ELR symbols,
wherein the ELR sequence is indicative of a basic service set (BSS) information value that may include one or more of a color value, a BSS identifier, or a BSS address from a plurality of BSS color values, BSS identifiers, or BSS addresses, based on a mapping between the plurality of ELR sequences and associated BSS color values, BSS identifier, or BSS address, and
wherein a quantity of the plurality of ELR sequence corresponds to a quantity of the plurality of BSS color values, BSS identifiers, or BSS addresses, and a length of each ELR sequence of the plurality of ELR sequences is associated with a quantity of tones within the first ELR symbol and the second ELR symbol; and
selectively receive at least a portion of a remainder of the PPDU after the pair of ELR symbols in accordance with the BSS information value indicated by the ELR sequence.

19. The wireless device of claim 18, wherein, to selectively receive at least the portion of the remainder of the PPDU after the plurality of ELR symbols, the processing system is configured to cause the wireless device to:
receive at least the portion of the remainder of the PPDU in accordance with a BSS associated with the wireless device corresponding to the BSS color value indicated by the ELR sequence; or
refrain from receiving the remainder of the PPDU in accordance with the BSS associated with the wireless communication device corresponding to a different BSS color value than the BSS color value indicated by the ELR sequence.

20. The wireless device of claim 18, wherein:
the ELR sequence is a length-96 ELR sequence;
the first ELR symbol is associated with a first half of the length-96 ELR sequence and the second ELR symbol is associated with a second half of the length-96 ELR sequence; and
the plurality of ELR sequences are based on values from a plurality of rows of a Hadamard extension of a Hadamard matrix that is generated according to a Paley construction from a 48-by-48 conference matrix based on a 47-by-47 Q matrix, in which each sequence is associated with a row of the Hadamard extension and each row has a different sequence.

21. The wireless device of claim 20, wherein the plurality of ELR sequences are further based on a mask that is applied to the values from the plurality of rows of the Hadamard extension, wherein the mask reduces a peak-to-average-power ratio (PAPR) for transmission of the plurality of ELR sequences.

22. The wireless device of claim 20, wherein the plurality of ELR sequences are further based on a cyclic shift that is applied to one or more rows of the Hadamard extension of the matrix.

23. The wireless device of claim 20, wherein the plurality of ELR sequences are further based on a quadrature binary phase shift keying (QBPSK) modulation that is applied to the first ELR symbol and the second ELR symbol.

24. The wireless device of claim 23, wherein:
QBPSK sequences, binary phase shift keying (BPSK) sequences, or both are separately applied to the first ELR symbol and the second ELR symbol.

25. A wireless device, comprising:
a processing system that includes processor circuitry and memory circuitry that stores code, the processing system configured to cause the wireless device to:
transmit, via a preamble portion of a physical layer (PHY) protocol data unit (PPDU) associated with an enhanced long range (ELR) format, an ELR-signal (ELR-SIG) field that comprises two symbols, the two symbols comprising:
a first plurality of subfields comprise a modulation and coding scheme (MCS) subfield, a coding subfield associated with a data portion of the PPDU, and one or more of an uplink-downlink indicator subfield, a transmission opportunity (TxOP) identifier subfield, or a last PPDU indicator subfield, and
a second plurality of subfields comprise a cyclic redundancy check (CRC) subfield and a tail subfield; and
transmit via the data portion of the PPDU, an ELR-data field in accordance with at least the MCS subfield and the coding subfield.

26. The wireless device of claim 25, wherein:
a first symbol of the two symbols of the ELR-SIG field includes the MCS subfield, the coding subfield, a length subfield, and one or more of the uplink-downlink indicator subfield, the TxOP identifier subfield, or the last PPDU indicator subfield, and
a second symbol of the two symbols of the ELR-SIG field includes a station identifier subfield.

27. The wireless device of claim 25, wherein the first plurality of subfields further comprise a length subfield that indicates a quantity of symbols in the PPDU, and wherein the quantity of symbols is indicated to a one-symbol resolution or a two-symbol resolution based on a total quantity of data symbols in the PPDU.

28. A wireless device, comprising:
a processing system that includes processor circuitry and memory circuitry that stores code, the processing system configured to cause the wireless device to:
transmit, via a pair of enhanced long range (ELR) symbols within a preamble portion of a physical layer (PHY) protocol data unit (PPDU), an ELR sequence from a plurality of ELR sequences, the ELR sequence spanning a first ELR symbol of the pair of ELR symbols and a second ELR symbol of the pair of ELR symbols,
wherein the ELR sequence is indicative of a basic service set (BSS) information value that may include one or more of a BSS color value, a BSS identifier, or a BSS address from a plurality of BSS color values, BSS identifiers, or BSS addresses, based on a mapping between the plurality of ELR sequences and associated BSS color values, BSS identifiers, or BSS addresses, and
wherein a quantity of the plurality of ELR sequences corresponds to a quantity of the plurality of BSS color values, BSS identifiers, or BSS addresses, and a length of each ELR sequence of the plurality of ELR sequences is associated with a quantity of tones within the first ELR symbol and the second ELR symbol; and
transmit, via a plurality of ELR data symbols within a data portion of the PPDU, a data payload associated with the BSS information value.

29. The wireless device of claim 28, wherein:
the ELR sequence is a length-96 ELR sequence;
the first ELR symbol is associated with a first half of the length-96 ELR sequence and the second ELR symbol is associated with a second half of the length-96 ELR sequence; and
the plurality of ELR sequences are based on values from a plurality of rows of a Hadamard extension of a Hadamard matrix that is generated according to a Paley construction from a 48-by-48 conference matrix based on a 47-by-47 Q matrix, in which each sequence is associated with a row of the Hadamard extension and each row has a different sequence.

30. The wireless device of claim 29, wherein the plurality of ELR sequences are further based on a quadrature binary phase shift keying (QBPSK) modulation that is applied to the first ELR symbol and the second ELR symbol.
